(19) United States
(12) Patent Application Publication
(10) Pub. No.: US 2012/0188521 A1
(43) Pub. Date: Jul. 26, 2012

(54) CLEANING METHOD, LIQUID IMMERSION MEMBER, IMMERSION EXPOSURE APPARATUS, DEVICE FABRICATING METHOD, PROGRAM AND STORAGE MEDIUM

(75) Inventor: Shinji SATO, Fakaya-shi (JP)

(73) Assignee: NIKON CORPORATION, Tokyo (JP)

(21) Appl. No.: 13/335,006

(22) Filed: Dec. 22, 2011

Related U.S. Application Data
(60) Provisional application No. 61/427,292, filed on Dec. 27, 2010.

(51) Int. Cl. G03B 27/52

(52) U.S. Cl. 355/30

(57) ABSTRACT

A liquid immersion member includes: a first liquid immersion member, which is disposed at least partly around an optical path, that forms a first immersion space of a first liquid at an emergent surface side of an optical member such that the optical path of exposure light between the optical member and a substrate is filled with the first liquid; and a second liquid immersion member, which is disposed at the outer side of the first liquid immersion member, that forms a second immersion space of a second liquid partly around the first immersion space and adjacent to a first guide space. A cleaning method includes: supplying a cleaning liquid such that it contacts at least part of the first liquid immersion member; and recovering at least some of the cleaning liquid from the first liquid immersion member via an opening belonging to the second liquid immersion member.

### CROSS-REFERENCE TO RELATED APPLICATION

This application is a non-provisional application claiming priority to and the benefit of U.S. provisional application No. 61/427,292, filed on Dec. 27, 2010. The entire contents of which are incorporated herein by reference.

### BACKGROUND

1. Field of the Invention

The present invention relates to a cleaning method, a liquid immersion member, an immersion exposure apparatus, a device fabricating method, a program, and a storage medium.

2. Description of Related Art

In the process of fabricating microdevices, such as semiconductor devices and electronic devices, an exposure apparatus, which exposes a substrate with exposure light, is used. If a member inside the exposure apparatus is contaminated, then exposure failures, such as defects in the pattern formed in the substrate, might occur and, as a result, defective devices might be produced. Consequently, a technology for cleaning a member inside an exposure apparatus has been proposed, as disclosed in, for example, U.S. Pat. No. 6,496,257 and U.S. Patent Application Publication No. 2006/0023185.

### SUMMARY

To prevent, for example, exposure failures from occurring, it is effective to clean a member inside the exposure apparatus.

An object of aspects of the present invention is to provide a cleaning method that can prevent exposure failures from occurring. Another object of aspects of the present invention is to provide both a liquid immersion member and an immersion exposure apparatus that can prevent exposure failures from occurring. Yet another object of aspects of the present invention is to provide a device fabricating method, a program, and a storage medium that can prevent defective devices from being produced.

A first aspect of the present invention provides a method of cleaning a liquid immersion member inside an immersion exposure apparatus that exposes a substrate with exposure light through a first liquid, the liquid immersion member being disposed at least partly around an optical member and an optical, path of the exposure light, which passes through the first liquid between the optical member and the substrate, wherein the liquid immersion member comprises: a first liquid immersion member, which is disposed at least partly around the optical path, that forms a first immersion space of the first liquid at an emergent surface side of the optical member such that the optical path of the exposure light between the optical member and the substrate is filled with the first liquid during an exposure of the substrate; a guide part, which guides at least some of the first liquid in the first immersion space to a first guide space, which extends partly around the optical path; and a second liquid immersion member, which is disposed at the outer side of the first liquid immersion member with respect to the optical path, that forms a second immersion space of a second liquid partly around the first immersion space and adjacent to the first guide space; and that comprises the steps of supplying a cleaning liquid such that it contacts at least part of the first liquid immersion member; and recovering at least some of the cleaning liquid from the first liquid immersion member via an opening belonging to the second liquid immersion member.

A second aspect of the present invention provides a device fabricating method that comprises the steps of: cleaning at least some of the liquid immersion member using a cleaning method according to the first aspect of the present invention; exposing the substrate through the exposure liquid; and developing the exposed substrate.

A third aspect of the present invention provides a liquid immersion member inside an immersion exposure apparatus that exposes a substrate with exposure light through a first liquid, the liquid immersion member being disposed at least partly around an, optical member and an optical path of the exposure light, which passes through the first liquid between the optical member and the substrate, and that comprises: a first liquid immersion member, which is disposed at least partly around the optical path, that forms a first immersion space of the first liquid at an emergent surface side of the optical member such that the optical path of the exposure light between the optical member and the substrate is filled with the first liquid during an exposure of the substrate; a guide part, which guides at least some of the first liquid in the first immersion space to a first guide space, which extends partly around the optical path; a second liquid immersion member, which is disposed at the outer side of the first liquid immersion member with respect to the optical path, that forms a second immersion space of a second liquid partly around the first immersion space and adjacent to the first guide space; a supply port that supplies a cleaning liquid such that it contacts at least part of the first liquid immersion member during cleaning; and a recovery port, which is disposed in the second liquid immersion member, that recovers at least some of the cleaning liquid from the first liquid immersion member.

A fourth aspect of the present invention provides an immersion exposure apparatus that exposes a substrate with exposure light through a first liquid, and that comprises: a liquid immersion, member according to the third aspect of the present invention.

A fifth aspect of the present invention provides a device fabricating method that comprises the steps of: exposing a substrate using an immersion exposure apparatus according to the fourth aspect of the present invention; and developing the exposed substrate.

A sixth aspect of the present invention provides a program that causes a computer to control an immersion exposure apparatus, which exposes a substrate with exposure light through a first liquid filled in an optical path of the exposure light between the substrate and an optical member wherefrom the exposure light can emerge, wherein the immersion exposure apparatus comprises a liquid immersion member, which is disposed at least partly around the optical member and the optical path of the exposure light that passes through the first liquid between the optical member and the substrate; and the liquid immersion member comprises: a first liquid immersion member, which is disposed at least partly around the optical path, that forms a first immersion space of the first liquid at an emergent surface side of the optical member such that the optical path of the exposure light between the optical member and the substrate is filled with the first liquid during an exposure of the substrate; a guide part, which guides at least some of the first liquid in the first immersion space to a first guide space, which extends partly around the optical path; and a second liquid immersion member, which is disposed at the outer side of the first liquid immersion member with respect to the optical path, that forms a second immersion space of a second liquid that extends partly around the first immersion space and is adjacent to the first guide space; and that comprises the steps of: supplying the cleaning liquid such that it contacts at least some of the first liquid immersion member; and recovering at least some of the cleaning liquid from the first liquid immersion member via an opening belonging to the second liquid immersion member.

A seventh aspect of the present invention provides a computer readable storage medium whereon a program according to the sixth aspect of the present invention is stored.

According to aspects of the present invention, it is possible to prevent exposure failures from occurring. In addition, according to aspects of the present invention, it is possible to prevent defective devices from being produced.

### BRIEF DESCRIPTION OF THE DRAWINGS

FIG. 1 is a schematic block diagram that shows one example of an exposure apparatus according to a first embodiment.

FIG. 2 is a side cross sectional view that shows one example of a liquid immersion member according to the first embodiment.

FIG. 3 is a side cross sectional view that shows one example of the liquid immersion member according to the first embodiment.

FIG. 4 shows the liquid immersion member according to the first embodiment, viewed from below.

FIG. 5 is a partial enlarged view of FIG. 2.

FIG. 6 is a partial enlarged view of FIG. 3.

FIG. 7 is a schematic drawing for explaining one example of the operation of the exposure apparatus according to the first embodiment.

FIG. 8 is a schematic drawing for explaining one example of the operation of the exposure apparatus according to the first embodiment.

FIG. 9 is a diagram for explaining one example of a guide part according to the first embodiment.

FIG. 10 is a diagram for explaining one example of the guide part according to the first embodiment.

FIG. 11 is a diagram for explaining one example of the liquid immersion member according to the first embodiment.

FIG. 12 is a diagram for explaining one example of a cleaning method according to the first embodiment.

FIG. 13 is a diagram for explaining one example of the cleaning method according to the first embodiment.

FIG. 14 is a diagram for explaining one example of the liquid immersion member according to the first embodiment.

FIG. 15 is a diagram for explaining one example of the liquid immersion member according to a second embodiment.

FIG. 16 is a diagram for explaining one example of the liquid immersion member according to a third embodiment.

FIG. 17 is a diagram for explaining one example of the liquid immersion member according to the third embodiment.

FIG. 18 is a diagram for explaining one example of the liquid immersion member according to the third embodiment.

FIG. 19 is a side cross sectional view that shows one example of the liquid immersion member according to a fourth embodiment.

FIG. 20 is diagram of the liquid immersion member according to the fourth embodiment, viewed from below.

FIG. 21 is a partial enlarged view of FIG. 19.

FIG. 22 is a diagram for explaining one example of the state of a liquid according to the fourth embodiment.

FIG. 23 is a diagram for explaining one example of the state of the liquid according to the fourth embodiment.

FIG. 24 is a diagram for explaining an example of a liquid immersion member.

FIG. 25 is a diagram for explaining an exposure apparatus.

FIG. 26 is a flow chart for explaining one example of a microdevice fabricating process.

### DESCRIPTION OF EMBODIMENTS

The embodiments of the present invention will now be explained, referencing the drawings; however, the present invention is not limited thereto. The explanation below defines an XYZ orthogonal coordinate system, and the positional relationships among parts are explained referencing this system. Prescribed directions within the horizontal plane are the X axial directions, directions orthogonal to the X axial directions in the horizontal plane are the Y axial directions, and directions orthogonal to the X axial directions and the Y axial directions (i.e., the vertical directions) are the Z axial directions. In addition, the rotational directions (i.e., the tilting directions) around the X, Y, and Z axes are the θX, θY, and θZ directions, respectively.

### First Embodiment

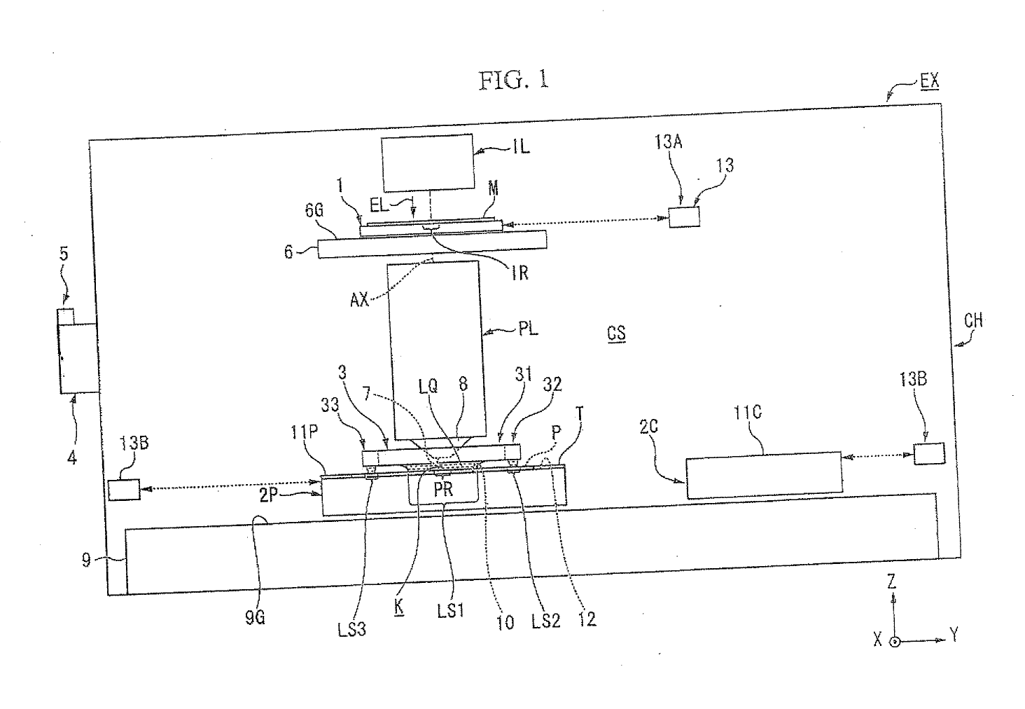

A first embodiment will now be explained. FIG. 1 is a schematic block diagram that shows one example of an exposure apparatus EX according to a first embodiment. The exposure apparatus EX of the present embodiment is an immersion exposure apparatus that exposes a substrate P with exposure light EL that transits a liquid LQ. In the present embodiment, a first immersion space LS1 is formed such that an optical path K of the exposure light EL radiated to the substrate P is filled with the liquid LQ. An immersion space refers to a portion (i.e., a space or an area) that is filled with liquid. The substrate P is exposed with the exposure light EL, which transits the liquid LQ in the first immersion space LS1. In the present embodiment, water (i.e., pure water) is used as the liquid LQ.

In addition, the exposure apparatus EX of the present embodiment comprises a substrate stage and a measurement stage as disclosed in for example, U.S. Pat. No. 6,897,963 and European Patent Application Publication. No. 1713113.

In FIG. 1, the exposure apparatus EX comprises: a movable mask stage 1 that holds a mask M; a movable substrate stage 2P that holds the substrate P; a movable measurement stage 2C that does not hold the substrate P and whereon a measuring member and a measuring instrument that measure the exposure light EL are mounted; an illumination system IL that illuminates the mask M with the exposure light EL; a projection optical system PL that projects an image of a pattern of the mask M, which is illuminated by the exposure light EL, to the substrate P; a liquid immersion member 3, which forms the immersion space; a control apparatus 4, which controls the operation of the entire exposure apparatus EX; and a storage apparatus 5, which is connected to the control apparatus 4 and stores various exposure-related information. The storage apparatus 5 comprises a storage medium such as memory (e.g., RAM), a hard disk, a CD-ROM, and the like. In the storage apparatus 5, an operating system (OS) that controls a computer system is installed and a program for controlling the exposure apparatus EX is stored.

In the present embodiment, the first immersion space LS1, a second immersion space LS2, and a third immersion space LS3 are formed by the liquid immersion member 3. The first immersion space LS1 is formed such that the optical path K of the exposure light EL is filled with the liquid LQ. The second immersion space LS2 is disposed partly around the first immersion space LS1. The third immersion space LS3 is disposed partly around the first immersion space LS1. In the present embodiment, the liquid immersion member 3 includes a first liquid immersion member 31, which forms the first immersion space LS1, a second liquid immersion member 32, which forms the second immersion space LS2, and a third liquid immersion member 33, which forms the third immersion space LS3.

In addition, the exposure apparatus EX comprises a chamber apparatus CH, which forms an internal space CS wherein at least the projection optical system PL, the liquid immersion member 3, the substrate stage 2P, and the measurement stage 2C are disposed. The chamber apparatus CH comprises en environmental control apparatus, which controls the environment (i.e., the temperature, the humidity, the pressure, and the cleanliness level) of the internal space CS.

The mask M may be a reticle on which a device pattern to be projected to the substrate P is formed. The mask M may be a transmissive mask comprising a transparent plate, such as a glass plate, and the pattern, which is formed on the transparent plate using a shielding material, such as chrome. Furthermore, a reflective mask can also be used as the mask M.

The substrate P is a substrate for fabricating devices. The substrate P comprises, for example, a base material, such as a semiconductor wafer, and a photosensitive film, which is formed on the base material. The photosensitive film comprises a photosensitive material (e.g., photoresist). In addition to the photosensitive film, the substrate P may comprise a separate film. For example, the substrate P may comprise an antireflection film or a protective film (i.e., a topcoat film) that protects the photosensitive film.

The illumination system IL radiates the exposure light EL to a prescribed illumination area IR. The illumination area IR, includes a position whereto the exposure light EL that emerges from the illumination system IL can be radiated. The illumination system IL illuminates at least part of the mask M disposed in the illumination area IR with the exposure light EL, which has a uniform luminous flux intensity distribution. Examples of light that can be used as the exposure light EL that emerges from the illumination system IL include: deep ultraviolet (DUV) light, such as a bright line (i.e., g-line, h-line, or i-line) light emitted from, for example, a mercury lamp, and KrF excimer laser light (with a wavelength of 248 nm); and vacuum ultraviolet (VUV) light, such as ArF excimer laser light (with a wavelength of 193 nm) and F₂ laser light (with a wavelength of 157 nm). In the present embodiment, ArF excimer laser light, which is ultraviolet light (e.g., vacuum ultraviolet light), is used as the exposure light EL.

In the state wherein it holds the mask M, the mask stage 1 is capable of moving on a guide surface 60 of a base member 6 that includes the illumination area IR. The mask stage 1 moves by the operation of a drive system, which comprises a planar motor as disclosed in, for example, U.S. Pat. No. 6,452,292. The planar motor comprises a slider, which is disposed on the mask stage 1, and a stator, which is disposed on the base member 6. In the present embodiment, the mask stage 1 is capable of moving in six directions on the guide surface 6G, namely, the X axial, Y axial, Z axial, θX, θY, and θZ directions, by the operation of the drive system.

The projection optical system PL radiates the exposure light EL to a prescribed projection area PR. The projection area PR includes a position whereto the exposure light EL that emerges from the projection optical system PL can be radiated. The projection optical system PL projects with a prescribed projection magnification an image of the pattern of the mask M to at least part of the substrate P, which is disposed in the projection area PR. The projection optical system PL of the present embodiment is a reduction system that has a projection magnification of for example, ¼, ⅕, or ⅛. Furthermore, the projection optical system PL may be a unity magnification system or an enlargement system. In the present embodiment, an optical axis AX of the projection optical system PL is parallel to the Z axis. In addition, the projection optical system PL may be a dioptric system that does not include catoptric elements, a catoptric system that does not include dioptric elements, or a catadioptric system that includes both catoptric and dioptric elements. In addition, the projection optical system PL may, form either an inverted or an erect image.

The projection optical system PL has an emergent surface 7 wherefrom the exposure light EL emerges and travels toward an image plane of the projection optical system PL. The emergent surface 7 belongs to a last optical element 8, which is the optical element of the plurality of optical elements of the projection optical system PL that is closest to the image plane of the projection optical system PL. The projection area PR includes a position whereto the exposure light EL that emerges from the emergent surface 7 can be radiated. In addition, in the present embodiment, the projection area PR includes a position that opposes the emergent surface 7, in the present embodiment, the emergent surface 7 faces the −Z direction and is parallel to the XY plane. Furthermore, the emergent surface 7, which faces the −Z direction, may be a convex or a concave surface. The optical axis of the last optical element 8 is parallel to the Z axis. In the present embodiment, the exposure light EL that emerges from the emergent surface 7 proceeds in the −Z direction.

In the state wherein it holds the substrate P, the substrate stage 2P is capable of moving on, a guide surface 9G of a base member 9, which includes the projection area PR. The substrate stage 2P moves by the operation of a drive system, which comprises a planar motor as disclosed in, for example, U.S. Pat. No. 6,452,292. The planar motor comprises a slider, which is disposed on the substrate stage 2P, and a stator, which is disposed on the base member 9. In the present embodiment, the substrate stage 2P is capable of moving in six directions on the guide surface 9G, namely, the X axial, Y axial, Z axial, θX, θY, and θZ directions, by the operation of the drive system. Furthermore, the drive system that moves the substrate stage 2P does not have to comprise a planar motor. For example, the drive system may comprise a linear motor.

The substrate stage 2P comprises a substrate holding part 10, which releasably holds the substrate P. The substrate holding part 10 holds the substrate P such that the front surface of the substrate P faces the +Z direction. In the present embodiment, the front surface of the substrate P held by the substrate holding part 10 and an upper surface 11P of the substrate stage 2P disposed around the substrate P are disposed within the same plane (i.e., they are flush with one another). The upper surface 11P is flat. In the present embodiment, the front surface of the substrate which is held by the substrate holding part 10, and the upper surface 11P of the substrate stage 2P are substantially parallel to the XY plane.

Furthermore, the upper surface 11P of the substrate stage 2P and the front surface of the substrate P held by the substrate holding part 10 do not have to be disposed within the same plane; furthermore, the front surface of the substrate P or the upper surface 11P, or both, may be nonparallel to the XY plane. In addition, the upper surface 11P does not have to be flat. For example, the upper surface 11P may include a curved surface.

In addition, in the present embodiment, the substrate stage 2P comprises a cover member holding part 12, which releasably holds a cover member T, as disclosed in, for example, U.S. Patent Application Publication No. 2007/0177125 and U.S. Patent Application Publication No. 2008/0049209. In the present embodiment, the upper surface 11P of the substrate stage 2P includes an upper surface of the cover member T held by the cover member holding part 12.

Furthermore, the cover member T does not have to be releasable. In such a case, the cover member holding part 12 could be omitted. In addition, the upper surface 11P of the substrate stage 2P may include the front surface of any sensor, measuring member, or the like installed on the substrate stage 2P.

In the state wherein the measuring member and the measuring instrument, which measure the exposure light EL, are mounted thereon, the measurement stage 2C is capable of moving on the guide surface 9G of the base member 9, which includes the projection area PR. The measurement stage 2C moves by the operation of a drive system, which comprises a planar motor as disclosed in, for example, U.S. Pat. No. 6,452,292. The planar motor comprises a slider, which is disposed on the measurement stage 2C, and a stator, which is disposed on the base member 9. In the present embodiment, the measurement stage 2C is capable of moving in six directions on the guide surface 9G, namely, the X axial, Y axial, Z axial, θX, θY, and θZ directions, by the operation of the drive system. Furthermore, the drive system that moves the measurement stage 2C does not have to comprise a planar motor. For example, the drive system may comprise a linear motor.

In the present embodiment, an upper surface 11C of the measurement stage 2C is substantially parallel to the XY plane.

In the present embodiment, an interferometer system 13, which comprises laser interferometer units 13A, 13B, measures the positions of the mask stage 1, the substrate stage 2F, and the measurement stage 2C. The laser interferometer unit 13A is capable of measuring the position of the mask stage 1 using measurement mirrors that are disposed on the mask stage 1. The laser interferometer unit 13B is capable of measuring the positions of the substrate stage 2P and the measurement stage 2C using measurement mirrors disposed on the substrate stage 2P and measurement mirrors disposed on the measurement stage 2C. When an exposing process or a prescribed measurement process is performed on the substrate F, the control apparatus 4 controls, based on the measurement results of the interferometer system 13, the positions of the mask stage 1 (i.e., the mask M), the substrate stage 2P (i.e., the substrate P), and the measurement stage 2C (i.e., the measuring member.

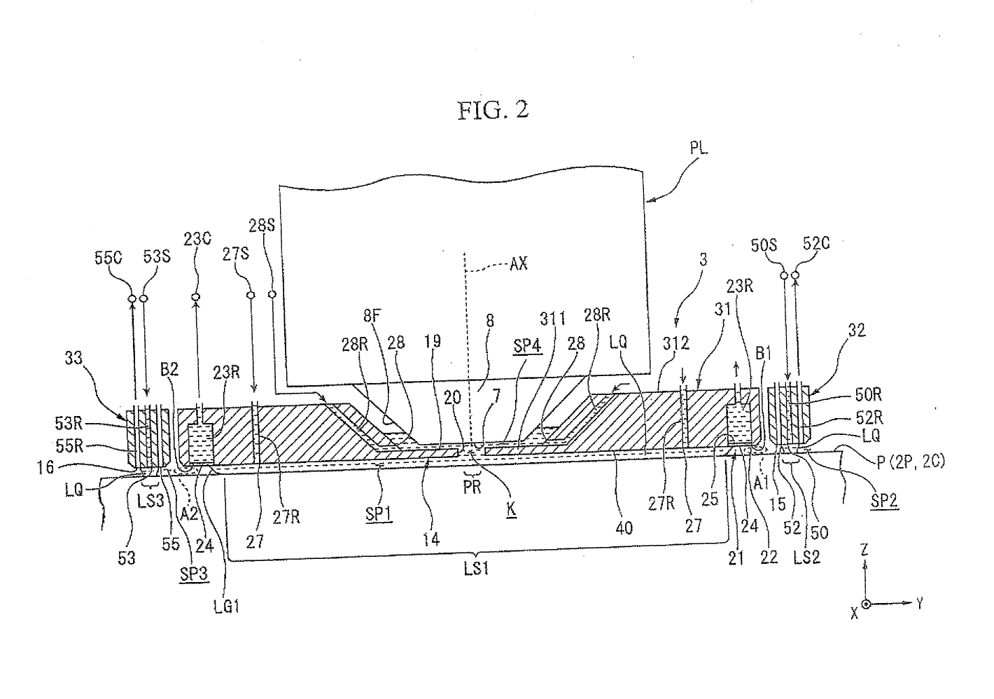

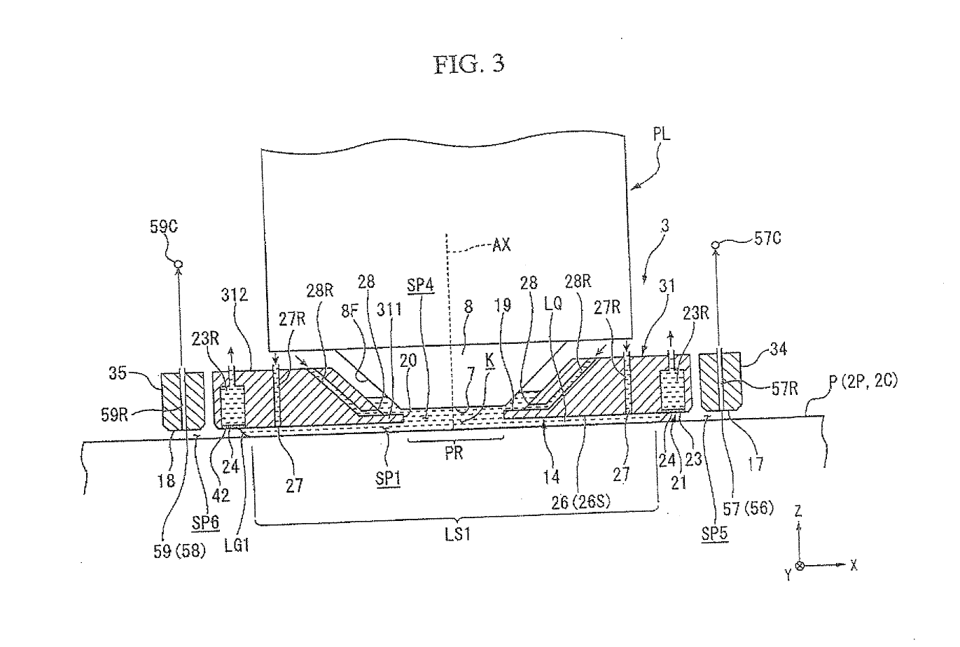

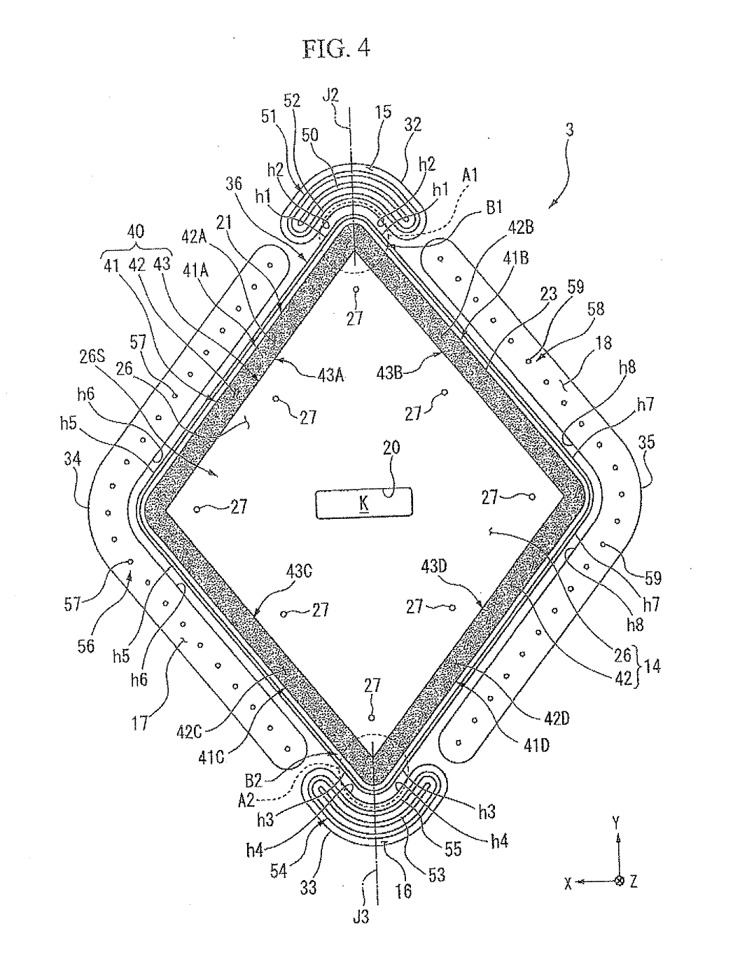

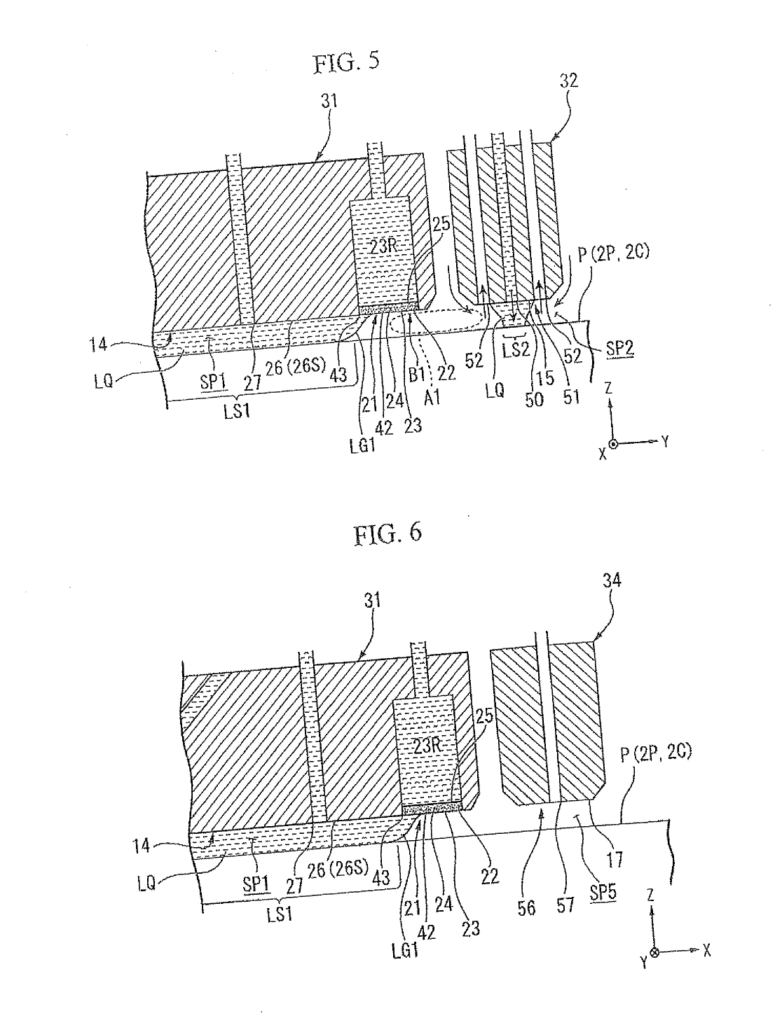

Next, the liquid immersion member 3 according to the present embodiment will be explained. FIG. 2 is a side cross sectional view that is parallel to the YZ plane and shows one example of the liquid immersion member 3 according to the present embodiment; FIG. 3 is a side cross sectional view that is parallel to the XZ plane and shows one example of the liquid immersion member 3 according to the present embodiment; FIG. 4 is a diagram of the liquid immersion, member 3, viewed from the lower side (i.e., the −Z side); FIG. 5 is a partial enlarged view of FIG. 2; and FIG. 6 is a partial enlarged view of FIG. 3.

The liquid immersion member 3 is disposed at least partly around the last optical element 8 and the optical path K of the exposure light EL wherethrough the liquid LQ between the last optical element 8 and the object disposed in the projection area FR passes.

In the present embodiment, the abject that is capable of being disposed in the projection area PR includes at least one of the following: the substrate stage 2P (i.e., the cover member 1), the substrate P, which is held by the substrate stage 2P (i.e., the substrate holding part 10), and the measurement stage 2C. In an exposure of the substrate P, the first immersion space LS1 is formed such that the optical path K of the exposure light EL radiated to the substrate P is filled with the liquid LQ. When the substrate P is being irradiated with the exposure light EL, the first immersion, space LS1 is already formed such that only part of the area of the front surface of the substrate P, which includes the projection area PR, is covered with the liquid LQ.

In the present embodiment, the liquid immersion member 3 comprises: the fast liquid immersion member 31, which is disposed at least partly around the optical path K of the exposure light EL wherethrough the liquid LQ between the last optical element 8 and the object disposed in the projection area PR passes, that forms the first immersion space LS1 of the liquid LQ at the emergent surface 7 side of the last optical element such that the optical path K of the exposure light EL between the last optical element 8 and the object is filled with the liquid LQ; a guide part 40, which guides at least some of the liquid LQ in the first immersion space LS1 to a first guide space A1, which extends partly around the optical path K; and the second liquid immersion member 32, which is disposed at the outer side of the first liquid immersion member 31 with respect to the optical path K, that forms the second immersion space LS2 of the liquid LQ partly around the first immersion space LS1 and adjacent to the first guide space A1.

In the present embodiment, the guide part 40 guides at least some of the liquid LQ in the first immersion space LS1 to a second guide space A2, which extends partly around the optical path K and is different from the first guide space A1.

Furthermore, in the present embodiment, “around the optical path K” includes a space (i.e., an area) that extends in the peripheral directions of the optical path K. In other words, “around the optical path K” includes a ring shaped space (i.e., an area) that surrounds the optical path K. In the present embodiment, a space that extends partly around the optical path K is referred to as “part of the ring shaped space surrounding the optical path. K.” Furthermore, a space that extends around the optical path K can also be referred to as “a space around the optical axis AX of the projection optical system PL.” A space that extends partly around the optical path K can also be referred to as “part of the ring shaped space that extends in the peripheral directions of the optical axis AX.”

In addition, in the present embodiment, the liquid immersion member 3 comprises the third liquid immersion member 33, which is disposed at the outer side of the first liquid immersion member 31 with respect to the optical path K, that forms the third immersion space LS3 of the liquid LQ, which is different from the second immersion space LS2, partly around the first immersion space LS1 and adjacent to the second guide space A2.

In the present embodiment, the first liquid immersion member 31 and the second liquid immersion member 32 are different members and are spaced apart. The first liquid immersion member 31 and the third liquid immersion member 33 are different members and are spaced apart. The second liquid immersion member 32 and the third liquid immersion member 33 are different members and are spaced apart.

In the present embodiment, the exposure apparatus EX comprises a support member (not shown), which supports the first liquid immersion member 31, the second liquid immersion member 32, and the third liquid immersion member 33. In the present embodiment, the first liquid immersion member 31, the second liquid immersion member 32, and the third liquid immersion member 33 are supported by one support member (i.e., a frame member). Furthermore, the support member may be connected to a support mechanism that supports the projection optical system PL, or may be spaced apart from the support mechanism. Furthermore, the support member that supports the first liquid immersion member 31 and the support member that supports the second liquid immersion member 32 may be different members. The support member that supports the second liquid immersion member 32 and the support member that supports the third liquid immersion member 33 may be different members.

In addition, in the present embodiment, the liquid immersion member 3 comprises a first recovery member 34 and a second recovery member 35, which are disposed at the outer side of the first liquid immersion member 31 with respect to the optical path K and are capable of recovering a fluid.

The first liquid immersion member 31 has a lower surface 14, which the object (e.g., a substrate) disposed in the projection area PR is capable of opposing. The second liquid immersion member 32 has a lower surface 15, which the object (e.g., a substrate) disposed in the projection area PR is capable of opposing. The third liquid immersion member 33 has a lower surface 16, which the object (e.g., a substrate) disposed in the projection area PR is capable of opposing. The first recovery member 34 has a lower surface 17, which the object (e.g., a substrate) disposed in the projection area PR is capable of opposing. The second recovery member 35 has a lower surface 18, which the object (e.g., a substrate) disposed in the projection area PR is capable of opposing.

In the present embodiment, the first liquid immersion member 31 is annular. In the present embodiment, part of the first liquid immersion member 31 is disposed around the last optical element 8. In addition, in the present embodiment, part of the first liquid immersion member 31 is disposed around the optical path K of the exposure light EL between the last optical element 8 and the object. The first immersion space LS1 is formed such that the optical path K of the exposure light EL between the last optical element 8 and the object (e.g., a substrate) disposed in the projection area PR is filled with the liquid LQ.

Furthermore, the first immersion member 31 does not have to be annular. For example, the first immersion member 31 may be disposed partly around the last optical element 8 and the optical path K. In addition, the first liquid immersion member 31 does not have to be disposed at least partly around the last optical element 8. For example, the first liquid immersion member 31 may be disposed at least partly around the optical path K between the emergent surface 7 and the object and not around the last optical element 8. In addition, the first liquid immersion member 31 does not have to be disposed at least partly around the optical path K between the emergent surface 7 and the object. For example, the first liquid immersion member 31 may be disposed at least partly around the last optical element 8 and not around the optical path K between the emergent surface 7 and the object.

In the present embodiment, the first liquid immersion member 31 comprises a plate part 311, at least part of which is disposed such that it opposes the emergent surface 7, and a main body part 312, at least part of which is disposed such that it opposes a side surface SF of the last optical element 8. Furthermore, the side surface 8F is disposed around the emergent surface 7. In the present embodiment, the side surface 8F is inclined upward toward the outer side in radial directions with respect to the optical path K. Furthermore, the radial directions with respect to the optical path K include the radial directions with respect to the optical axis AX of the projection optical system PL as well as the directions perpendicular to the Z axis.

In the present embodiment, the first liquid immersion member 31 has an upper surface 19, at least part of which opposes the emergent surface 7. The upper surface 19 is disposed in the plate part 311. In addition, the first liquid immersion member 31 has a hole 20 (i.e., an opening) that the emergent surface 7 faces. The exposure light EL that emerges from the emergent surface 7 can be radiated through the hole 20 to the substrate P. The upper surface 19 is disposed around an upper end of the hole 20. The lower surface 14 is disposed around a lower end of the hole 20. The hole 20 is formed such that it connects the upper surface 19 and the lower surface 14. Alternatively, in the embodiment, the upper surface 19 can be substantially perpendicular to the optical axis AX, or can be inclined with respect to a surface perpendicular to the optical axis AX. In one example, the upper surface 19 can be upwardly inclined toward the outer side in a radial direction with respect to the optical axis AX.

The first liquid immersion member 31 is capable of holding the liquid LQ between the lower surface 14 and the object. The first liquid immersion member 31 holds the liquid LQ between itself and the object and thereby forms the first immersion space LS1 at the emergent surface 7 side such that the optical path K is filled with the liquid LQ. In the present embodiment, seine of the liquid LQ in the first immersion space LS1 is held between the last optical element 8 and the object (e.g., the substrate P) disposed such that it opposes the emergent surface 7 of the last optical element 8. In addition, some of the liquid LQ in the first immersion space LS1 is held between the first liquid immersion member 31 and the object disposed such that it opposes the lower surface 14 of the first liquid immersion member 31. Holding the liquid LQ between the emergent surface 7 and the lower surface 14 on one side and the front surface (i.e., the upper surface) of the object on the other side forms the first immersion space LS1 such that the optical path K of the exposure light EL between the last optical element 8 and the object is filled with the liquid LQ.

For example, in an exposure of the substrate P, the first liquid immersion member 31 forms the first immersion space LS1 of the liquid LQ at the emergent surface 7 side of the last optical element 8 by holding the liquid LQ between the first liquid immersion member 31 and the substrate P such that the optical path K of the exposure light EL between the last optical element 8 and the substrate P is filled with the liquid LQ. When the substrate P is being irradiated with the exposure light EL, the first immersion space LS1 is already formed such that part of the area of the front surface of the substrate P, which includes the projection area PR, is covered with the liquid LQ.

In the present embodiment, at least part of an interface LG1 (i.e., a meniscus or an edge) of the liquid LQ of the fast immersion space LS1 is formed between the lower surface 14 and the front surface of the object (i.e., the substrate P). Namely, the exposure apparatus EX of the present embodiment adopts a local liquid immersion system. The outer side of the first immersion space LS1 (i.e., the outer side of the interface LG1) is a gas space.

The second liquid immersion member 32 is disposed at the outer side of the first liquid immersion member 31 with respect to the optical path K. The second liquid immersion member 32 is disposed partly around the first liquid immersion member 31. The second liquid immersion member 32 is disposed such that it opposes an outer surface of the first liquid immersion member 31. Namely, the second liquid immersion member 32 is disposed in the part of the ring shaped space that the outer surface of the first liquid immersion member 31 faces. In other words, the second liquid immersion member 32 is disposed in part of the space around the optical path K (i.e., the first liquid immersion member 31) such that it opposes the outer surface of the first liquid immersion member 31.

The second liquid immersion member 32 is capable of holding the liquid LQ between the lower surface 15 and the object. The second liquid immersion member 32 forms the second immersion space LS2 partly around the first immersion space LS1 by holding the liquid LQ between itself and the object. The second immersion space LS2 is formed in part of the ring shaped space that the interface LG1 of the first immersion space LS1 faces. In other words, the second immersion space LS2 is formed in part of the space around the optical path K (i.e., the first immersion space LS1) such that it opposes the interface LG1 of the first immersion space LS1.

The third liquid immersion member 33 is disposed at the outer side of the first liquid immersion member 31 with respect to the optical path K. The third liquid immersion member 33 is disposed partly around the first liquid immersion member 31. The third liquid immersion member 33 is disposed such that it opposes the outer surface of the first liquid immersion member 31. Namely, the third liquid immersion member 33 is disposed in part of the ring shaped space that the outer surface of the first liquid immersion member 31 faces. In other words, the third liquid immersion member 33 is disposed in part of the space around the optical path K (i.e., the first liquid immersion member 31) such that it opposes the outer surface of the first liquid immersion member 31.

The third liquid immersion member 33 is capable of holding the liquid LQ between the lower surface 16 and the object. The third liquid immersion member 33 forms the third immersion space LS3 partly around the first immersion space LS1 by holding the liquid LQ between itself and the object. The third immersion space LS3 is formed in part of the ring shaped space that the interface LG1 of the first immersion space LS1 faces. In other words, the third immersion space LS3 is formed in part of the space around the optical path K (i.e., the first immersion space LS1) such that it opposes the interface LG1 of the first immersion space LS1.

In the present embodiment, the second immersion space LS2 and the third immersion space LS3 are formed such that they are substantially spaced apart. In addition, in the present embodiment, the second immersion space LS2 is formed substantially spaced apart from the first immersion space LS1. In addition, in the present embodiment, the third immersion space L83 is formed substantially spaced apart from the first immersion space LS1. In one example, in a state wherein an object, which is opposing the liquid immersion member 3, is substantially stationary, the first immersion space LS1, the second immersion space LS2, and the third immersion space LS3 are formed substantially spaced apart from each other.

In the present embodiment, the second immersion space LS2 is smaller titan the first immersion space LS1. The third immersion space LS3 is smaller than, the first immersion space LS1. In the present embodiment, the sizes of the second immersion space LS2 and the third immersion space LS1 are substantially equal. Furthermore, the size of an immersion space can also mean the volume of the liquid that forms that immersion space. In addition, the size of an immersion space can also mean the weight of the liquid that forms that immersion space. In addition, the size of an immersion space can also mean the surface area of the immersion space within, for example, the plane (i.e., the XY plane) parallel to the front surface of the substrate P. In addition, the size of an immersion space cart also mean the dimensions of the immersion space in, for example, prescribed directions (e.g., the X axial directions or the Y axial directions) within the plane (i.e., the XY plane) parallel to the front surface of the substrate P. In the present embodiment, the second immersion space LS2 and the third immersion space LS3 are smaller than the first immersion space LS1 within the plane (i.e., the XY plane) parallel to the front surface of the substrate P. Furthermore, the second immersion space LS2 may be larger or smaller than the third immersion space LS3.

In the present embodiment, the third liquid immersion member 33 is disposed at the opposite side of the optical path K to the second liquid immersion member 32. In the present embodiment, the third immersion space LS3 is formed at the opposite side of the optical path K to the second, immersion space LS2.

In the present embodiment, the second liquid immersion member 32 is disposed at the +Y side of the first liquid immersion member 31. The third liquid immersion member 33 is disposed at the −Y side of the first liquid immersion member 31. In the present embodiment, the second immersion space LS2 is formed at the +Y side of the first immersion space LS1. The third immersion space LS3 is formed at the −Y side of the first immersion space LS1.

The first recovery member 34 is disposed at the outer side of the first liquid immersion member 31 with respect to the optical path K. The first recovery member 34 is disposed partly around the first liquid immersion member 31. The first recovery member 34 is disposed such that it opposes the outer surface of the first liquid immersion member 31. Namely, the first recovery member 34 is disposed in part of the ring shaped space that the outer surface of the first liquid immersion member 31 faces. In other words, the first recovery member 34 is disposed in part of the space around the optical path K (i.e., the first liquid immersion member 31) such that it opposes the outer surface of the first liquid immersion member 31.

The second recovery member 35 is disposed at the outer side of the first liquid immersion member 31 with respect to the optical path K. The second recovery member 35 is disposed partly around the first liquid immersion member 31. The second recovery member 35 is disposed such that it opposes the outer surface of the first liquid immersion member 31. Namely, the second recovery member 35 is disposed in part of the ring shaped space that the outer surface of the first liquid immersion member 31 faces. In other words, the second recovery member 35 is disposed in part of the space around the optical path K (i.e., the first liquid immersion member 31) such that it opposes the outer surface of the first liquid immersion member 31.

In the present embodiment, the second recovery member 35 is disposed at the opposite side of the optical path K to the first recovery member 34.

In the present embodiment, the first recovery member 34 is disposed at the +X side of the first liquid immersion member 31. The second recovery member 35 is disposed at the −X side of the first liquid immersion member 31.

The guide part 40 is capable of guiding at least some of the liquid LQ in the first immersion space LS1 to the first guide space A1. In addition, the guide part 40 is capable of guiding at least some of the liquid LQ in the first immersion space LS1 to the second guide space A2.

The first guide space A1 is part of the space around the optical path K. The second guide space A2 is part of the space around the optical path K. In the present embodiment, the first guide space A1 and the second guide space A2 are spaced apart.

In the present embodiment, the first guide space A1 includes part of a space SP (i.e., a portion) between the lower surface 14 of the first liquid immersion, member 31 and the front surface of the object. The lower surface 14 faces the space SP1. The second guide space A2 includes part of the space SP1 (i.e., a portion). Alternatively, in the embodiment, the first guide space A1 and/or the second guide space A2 can be that not having a part of the space SP1 (i.e., a portion) between the lower surface 14 of the first liquid immersion member 31 and the front surface of the object.

In the present embodiment, the first guide space A1 includes a space between a first portion B1 (i.e., a first area) of the lower surface 14 and the object. The second guide space A2 includes a space between a second portion B2 (i.e., a second area) of the lower surface 14 and the object. The first portion B1 and the second portion B2 are spaced apart. The first guide space A1 is adjacent to the first portion B1. The second guide space A2 is adjacent to the second portion B2.

In the present embodiment, the first guide space A1 includes a space between part of a peripheral edge part 36 of the first liquid immersion member 31 and the object. The second guide space A2 includes a space between part of the peripheral edge part 36 of the first liquid immersion member 31 and the object.

The peripheral edge part 36 of the first liquid immersion member 31 includes a peripheral edge part of the lower surface 14. The first guide space A1 includes a space between the object and the first portion B1, which is defined as part of the peripheral edge part 36 of the lower surface 14. The second guide space A2 includes a space between the object and the second portion 132, which is defined as part of the peripheral edge part 36 of the lower surface 14.

In the present embodiment, the second guide space A2 is disposed at tire opposite side of the optical path K to the first guide space A1. In the present embodiment, the first guide space A1 is the part of the space SP1 around the optical path K that is at the +Y side of the optical path K. The second guide space A2 is the part of the space SP1 around the optical path K that is at the −Y side of the optical path K.

Namely, in the present embodiment, the second portion 132 is disposed at the opposite side of the optical path K to the first portion B1. In the present embodiment, the first portion B1 is the part of the area of the lower surface 14 at the +Y side of the optical path. K. The second portion B2 is the part of the area of the lower surface 14 at the −Y side of the optical path K.

Furthermore, the first guide space A1 or the second guide space A2, or both, do not have to be a space between part of the peripheral edge part 36 of the lower surface 14 and the object. For example, the first guide space A1 or the second guide space A2, or both, may be a space between part of an area at the inner side of the peripheral edge part 36 of the lower surface 14 and the object. For example, the first guide space A1 or the second guide space A2, or both, may be a space between part of a center part of the lower surface 14 and the object. Namely, the first portion B1 and the second portion B2 of the lower surface 14, or both, may be defined as an area other than the peripheral edge part 36 of the lower surface 14. For example, the first portion B1 or the second portion B2, or both, may be defined as the inner side of the peripheral edge part 36, or as, for example, the center part of the lower surface 14.

In the present embodiment, the first guide space A1 is defined as the space between the second immersion space LS2, which is formed by the second liquid immersion member 32, and the optical path K. In the present embodiment, the second liquid immersion member 32 is disposed such that at least part thereof is adjacent to the first guide space A1. The second liquid immersion member 32 is disposed in the vicinity of the first guide space A1 such that it is adjacent to the first guide space A1 (i.e., the first portion B1) at the outer side of the first guide space A1 (i.e., the first portion B1) with respect to the optical path K. The first guide space A1 is formed such that it includes, for example, a virtual line that connects the optical path K and the second immersion space LS2 (i.e., the second liquid immersion member 32).

In the present embodiment, the second guide space A2 is defined as the space between the third immersion space LS3, which is formed by the third liquid immersion member 33, and the optical path K. In the present embodiment, the third liquid immersion member 33 is disposed such that at least part thereof is adjacent to the second guide space A2. The third liquid immersion member 33 is disposed in the vicinity of the second guide space A2 such that it is adjacent to the second guide space A2 (i.e., the second portion. B2) at the outer side of the second guide space A2 (i.e., the second portion B2) with respect to the optical path K. The second guide space A2 is formed such that it includes, for example, a virtual line that connects the optical path K and the third immersion space LS3 (i.e., the third liquid immersion member 33).

Furthermore, the first guide space A1 or the second guide space A2, or both, may include the space at the outer side of the space SP 1 between the lower surface 14 and the object. For example, the first guide space A1 may include at least part of a space 3P2 between the lower surface 15 of the second liquid immersion member 32 and the front surface of the object. In addition, the second guide space A2 may include at least part of a space SP3 between the lower surface 16 of the third liquid immersion member 33 and the front surface of the object. In addition, the first guide space A1 may include a space below a gap between the outer surface of the first liquid immersion member 31 and an inner surface of the second liquid immersion member 32. In addition, the second guide space A2 may include a space below a gap between the outer surface of the first liquid immersion member 31 and the inner surface of the third liquid immersion member 33.

In the present embodiment, at least part of the guide part 40 is disposed in the first liquid immersion member 31. In the present embodiment, at least part of the guide part 40 is disposed in the lower surface 14 of the first liquid immersion member 31, which the object is capable of opposing. The guide part 40 can guide at least some of the liquid LQ in the first immersion space LS1 between the lower surface 14 and the object to the first guide space A1 or the second guide space A2, or both.

In the present embodiment, the guide part 40 includes, for example, an edge 41 of the first liquid immersion member 31. The edge 41 of the first liquid immersion member 31 includes an edge of the peripheral edge part 36. In addition, the edge 41 of the first liquid immersion member 31 includes an edge of the lower surface 14. The edge 41 of the first liquid immersion member 31 is capable of guiding at least some of the liquid LQ in the first immersion space LS1 to the first guide space A1 or the second guide space A2, or both.

At least some of the liquid LQ in the first immersion space LS1 is guided to the edge 41 of the first liquid immersion member 31 and then flows toward the first guide space A1 or the second guide space A2, or both.

In the present embodiment, the first liquid immersion member 31 comprises a liquid recovery part 21, which is disposed such that the object opposes it and is capable of recovering the liquid LQ. During an exposure of the substrate P, the substrate P is disposed such that it opposes the liquid recovery part 21. The liquid recovery part 21 is capable of recovering the liquid LQ on the substrate P during an exposure of the substrate P. In the present embodiment, the guide part 40 includes at least part of the liquid recovery part 21.

In the present embodiment, the main body part 312 has an internal space 23R, at the lower end of which an opening 22 is formed. The first liquid immersion member 31 comprises a porous member 24, which is disposed in the opening 22. The opening 22 is formed such that it faces the space SP1. The porous member 24 is disposed such that it faces the space SP1. The porous member 24 has a plurality of holes (i.e., openings or pores) wherethrough the liquid. LQ is capable of circulating. A mesh filter, which is a porous member wherein numerous small holes are formed as a mesh, may be disposed in the opening 22.

The liquid recovery part 21 includes at least part of a lower surface 42 of the porous member 24, which is disposed such that the object opposes such. In the present embodiment, the porous member 24 is plate shaped. The porous member 24 has the lower surface 42, which faces the space SP1, an upper surface 25, which faces the internal space 23R, and a plurality of holes, which are formed such that they connect the upper surface 25 and the lower surface 42. The liquid recovery part 21 is capable of recovering the liquid LQ (i.e., the liquid LQ in the space SP1) on the object, which the lower surface 42 opposes, via the holes of the porous member 24. In the present embodiment, the holes of the porous member 24 function as a recovery port 23, which is capable of recovering the liquid LQ in the space SP1. The recovery port 23 is an opening that faces the space SP1. In the present embodiment, the liquid recovery part 21 includes the recovery port 23, which is capable of recovering the liquid LQ from the space SP1. The liquid LQ recovered via the recovery port 23 (i.e., the holes of the porous member 24) flows through the internal space 23R (i.e., the recovery passageway).

In the present embodiment, substantially only the liquid LQ is recovered via the porous member 24, and gas is not recovered. The control apparatus 4 adjusts the difference between the pressure on the lower surface 42 side of the porous member 24 (i.e., the pressure in the space SP1) and the pressure on the upper surface 25 side of the porous member 24 (i.e., the pressure in the recovery passageway 23R) such that the liquid LQ in the space SP1 passes through the holes of the porous member 24 and flows into the recovery passageway 23R, while the gas does not. Furthermore, one example of a technology that recovers only a liquid via a porous member is disclosed in, for example, U.S. Pat. No. 7,292,313.

Furthermore, both the liquid LQ and the gas may be recovered via the porous member 24.

In the present embodiment, the guide part 40 includes at least part of the lower surface 42 of the porous member 24. The lower surface 42 of the porous member 24 is capable of guiding at least some of the liquid LQ in the first immersion space LS1 to the first guide space A1 or the second guide space A2, or both.

At least some of the liquid LQ in the first immersion space LS1 is guided to the lower surface 42 of the porous member 24 and then flows toward the first guide space A1 or the second guide space A2, or both.

In addition, in the present embodiment, the first liquid immersion member 31 comprises a flat part 265, which adjoins the liquid recovery part 21 and is disposed such that the object opposes the flat part 26S. In the present embodiment, the guide part 40 includes a boundary 43 between the liquid recovery part 21 and the flat part 26S.

In the present embodiment, the flat part 26S includes a lower surface 26, which is disposed such that it adjoins the lower surface 42 of the porous member 24. At least part of the lower surface 26 is flat. The lower surface 26 is capable of holding the liquid LQ between itself and the object such that the liquid LQ cannot circulate. In the present embodiment, the lower surface 14 of the first liquid immersion member 31 includes the lower surface 42 of the porous member 24 and the lower surface 26. In the present embodiment, the boundary 43 includes a boundary between the lower surface 42 and the lower surface 26.

In the present embodiment, the state (i.e., the surface state) of the lower surface 42 and the state (i.e., the surface state) of the lower surface 26 are different. The lower surface 42 is disposed around the lower end of the holes of the porous member 24. The lower surface 42 is uneven. Furthermore, the contact angle of the liquid LQ with respect to the lower surface 42 and the contact angle of the liquid LQ with respect to the lower surface 26 may be different. For example, the contact angle of the liquid LQ with respect to the lower surface 42 may be smaller than the contact angle of the liquid LQ with respect to the lower surface 26. Furthermore, the contact angle of the liquid. LQ with respect to the lower surface 42 may be larger than the contact angle of the liquid LQ with respect to the lower surface 26. Furthermore, the contact angle of the liquid LQ with respect to the lower surface 42 may be equal to the contact angle of the liquid LQ with respect to the lower surface 26.

The boundary 43 is capable of guiding at least some of the liquid LQ in the first immersion space LS1 to the first guide space A1 or the second guide space A2, or both. Alternatively, the height of the lower surface 42 can be different from the height of the lower surface 26. In other words, the boundary 43 can include a step configuration.

At least some of the liquid LQ in the first immersion space LS1 is guided to the boundary 43 and then flows toward the first guide space A1 or the second guide space A2, or both.

In the present embodiment, the peripheral edge part 36 of the first liquid immersion member 31 comprises the liquid recovery part 21. In the present embodiment, the peripheral edge part 36 includes the lower surface 42 of the porous member 24. In the present embodiment, the edge 41 includes an edge of the lower surface 42 of the porous member 24. Furthermore, the edge 41 may include an edge of the main body part 312.

In the present embodiment, the lower surface 26 is disposed at a position that is closer to the optical path K than the lower surface 42 is. In the present embodiment, the lower surface 42 is disposed at least partly around the lower surface 26. In the present embodiment, the lower surface 26 is disposed around the lower end of the opening 20. The lower surface 42 is disposed around the lower surface 26.

In the present embodiment, the first guide space A1 includes a space between at least part of the liquid recovery part 21 and the object. In the present embodiment, the first portion B1 includes part of the area of the lower surface 42 of the porous member 24, and the first guide space A1 includes a space between at least part of the lower surface 42 of the porous member 24 and the object.

In the present embodiment, the second guide space A2 includes a space between at least part of the liquid recovery part 21 and the object. In the present embodiment, the second portion B2 includes part of the area of the lower surface 42 of the porous member 24, and the second guide space A2 includes a space between at least part of the lower surface 42 of the porous member 24 and the object.

In the present embodiment, the edge 41 includes a portion 41A and a portion 41B, which extend linearly toward the first guide space A1, and a portion 41C and a portion 41D, which extend linearly toward the second guide space A2.

In addition, in the present embodiment, the lower surface 42 of the porous member 24 includes a portion 42A and a portion 42B, which extend in strips toward the first guide space A1, and a portion 420 and a portion 421, which, extend in strips toward the second guide space A2.

In addition, in the present embodiment, the boundary 43 includes a portion 43A and a portion 43B, which extend linearly toward the first guide space A1, and a portion 43C and a portion 43D, which extend linearly toward the second guide space A2.

In the present embodiment, the portion 41A of the edge 41 is disposed such that it extends, within a plane the XY plane) that is substantially parallel to the front surface of the object, from the +X side of an axis J2, which passes through the space SP2, toward the first guide space A1. The portion 41B of the edge 41 is disposed such that it extends, within a plane (i.e., the XY plane) that is substantially parallel to the front surface of the object, from the −X side of the axis J2, which passes through the space SP2, toward the first guide space A1.

The axis J2 is a virtual axis (i.e., a virtual line) that passes through the space SP2. The axis J2 that passes through the space SP2 passes through the second immersion space LS2. The axis J2 connects, within the XY plane, the optical path K and the space SP2 (i.e., the second immersion space LS2). The axis J2 connects, for example, the optical path K and the center of the space SP2 (i.e., the second immersion space LS2) in the X axial directions. In the present embodiment, the axis J2 is substantially parallel to the Y axis.

In the present embodiment, within the plane (i.e., within the XY plane) that is substantially parallel to the object, a spacing between the portion 41A and the portion 41B in the directions (i.e., the X axial directions) perpendicular to the axis J2 becomes smaller as it approaches the first guide space A1.

In addition, in the present embodiment, the spacing between the portion 41A and the portion 41B becomes smaller as it becomes more spaced apart from the optical path K.

In the present embodiment, the portion 42A of the lower surface 42 is disposed such that it extends, within the plane (i.e., within the XY plane) that is substantially parallel to the front surface of the object, from the +X side of the axis J2 toward the first guide space A1. The portion 42B of the lower surface 42 is disposed such that it extends, within the plane within the XY plane) that is substantially parallel to the front surface of the object, from the −X side of the axis J2 toward the first guide space A1.

In the present embodiment, within the plane (i.e., within the XY plane) that is substantially parallel to the object, a spacing between the portion 42A and the portion 42B in the directions (i.e., the X axial directions) perpendicular to the axis J2 becomes smaller as it approaches the first guide space A1.

In addition, in the present embodiment, the spacing between the portion 42A and the portion 42B becomes smaller as it becomes more spaced apart from the optical path K.

In the present embodiment, the portion 43A of the boundary 43 is disposed such that it extends, within the plane (i.e., within the XY plane) that is substantially parallel to the front surface of the object, from the +X side of the axis J2 toward the first guide space A1. The portion 43B of the boundary 43 is disposed such that it extends, within the plane (i.e., within the XY plane) that is substantially parallel to the front surface of the object, from the −X side of the axis J2 toward the first guide space A1.

In the present embodiment, within the plane (i.e., within the XY plane) that is substantially parallel to the object, a spacing between the portion 43A and the portion 43B in the directions (i.e., the X axial directions) perpendicular to the axis J2 becomes smaller as it approaches the first guide space A1.

In addition, in the present embodiment, the spacing between the portion 43A and the portion 43B becomes smaller as it becomes more spaced apart from the optical path K.

In the present embodiment, the portion 41C of the edge 41 is disposed such that it extends, within the plane (i.e., within the XY plane) that is substantially parallel to the front surface of the object, from the +X side of an axis J3, which passes through the space SP3, toward the second guide space A2. The portion 41D of the edge 41 is disposed such that it extends, within the plane (i.e., within, the XY plane) that is substantially parallel to the front surface of the object, from the X side of the axis J3, which passes through the space SP3, toward the second guide space A2.

The axis J3 is a virtual axis (i.e., a virtual line) that passes through the space SP3. The axis J3, which passes through the space SP3, passes through the third immersion space LS3. The axis J3 connects, within the XY plane, the optical path K and the space SP3 (i.e., the third immersion space LS3). The axis J3 connects, for example, the optical path K and the center of the space SP3 (i.e., the third immersion space LS3) in the X axial directions. In the present embodiment, the axis J3 is substantially parallel to the Y axis.

In the present embodiment, within the plane (i.e., within the XY plane) that is substantially parallel to the object, the spacing between the portion 41C and the portion 41D in the directions (i.e., the X axial directions) perpendicular to the axis J3 becomes smaller as it approaches the second guide space A2.

In addition, in the present embodiment, the spacing between the portion 41C and the portion 410 becomes smaller as it becomes more spaced apart from the optical path K.

In the present embodiment, the portion 42C of the lower surface 42 is disposed such that it extends, within the plane (i.e., within the XY plane) that is substantially parallel to the front surface of the object, from the +X side of the axis J3 toward the second guide space A2. The portion 42D of the lower surface 42 is disposed such that it extends, within the plane (i.e., within the XY plane) that is substantially parallel to the front surface of the object, from the −X side of the axis J3 toward the second guide space A2.

In the present embodiment, within the plane (i.e., within the XY plane) that is substantially parallel to the object, the spacing between the portion 42C and the portion 42D in the directions (i.e., the X axial directions) perpendicular to the axis J3 becomes smaller as it approaches the second guide space A2.

In addition, in the present embodiment, the spacing between the portion 42C and the portion 42D becomes smaller as it becomes more spaced apart from the optical path K.

In the present embodiment, the portion 43C of the boundary 43 is disposed such that it extends, within the plane (i.e., within the XY plane) that is substantially parallel to the front surface of the object, from the +X side of the axis J3 toward the second guide space A2. The portion 43D of the boundary 43 is disposed such that it extends, within the plane (i.e., within the XY plane) that is substantially parallel to the front surface of the object, such that it extends from the −X side of the axis J3 toward the second guide space A2.

In the present embodiment, within the plane (i.e., within the XY plane) that is substantially parallel to the object, the spacing between the portion 43C and the portion 43D in the directions (i.e., the X axial directions) perpendicular to the axis J3 becomes smaller as it approaches the second guide space A2.

In addition, in the present embodiment, the spacing between the portion 43C and the portion 431) becomes smaller as it becomes more spaced apart from the optical path K.

In the present embodiment, the external shape of the lower surface 14 is substantially a quadrangle. Furthermore, as shown in FIG. 4 and the like, in the present embodiment, the angles (i.e., the vertices) of the lower surface 14, whose external shape is a quadrangle, are rounded. In the present embodiment, the angles of the lower surface 14 are disposed at the +Y side, the −Y side, the +X side, and the −X side of the optical path K. In the present embodiment, the first portion B1 includes the angle at the +Y side of the lower surface 14, and the second portion B2 includes the angle at the −Y side of the lower surface 14.

In the present embodiment, the first liquid immersion member 31 has supply ports 27, which are capable of supplying the liquid LQ and disposed such that the object opposes them. The supply ports 27 are openings that face the space SP1. The supply ports 27 are disposed in at least part of the lower surface 14 of the first liquid immersion member 31 such that they face the space SP1. In the present embodiment, the supply ports 27 are capable of supplying the liquid LQ to the space SP1. In the present embodiment, in an exposure of the substrate F, the liquid LQ is supplied via the supply ports 27.

In the present embodiment, the supply ports 27 are disposed in the lower surface 26. The lower surface 26 is disposed around the supply ports 27. In the present embodiment, a plurality of the supply ports 27 is disposed around the optical path K (i.e., the opening 20).

The liquid recovery part 21 is disposed at the outer side of the supply ports 27, in the radial directions with respect to the optical path K. In the present embodiment, the supply ports 27 are disposed at positions that are closer to the optical path K than the recovery port 23 is. In the present embodiment, the supply ports 27 are disposed adjacent to the liquid recovery part 21. The plurality of the supply ports 27 is disposed along the inner side edge of the lower surface 42 of the porous member 24.

In addition, the first liquid immersion member 31 has supply ports 28, which are capable of supplying the liquid LQ. The supply ports 28 are disposed in at least part of an inner side surface of the first liquid immersion member 31 such that they face a space SP4, which the emergent surface 7 faces. The space SP4 includes the space between the emergent surface 7 and the upper surface 19. The space SP4 includes the optical path K. In the present embodiment, the supply ports 28 are openings that face the optical path K of the exposure light EL emerging from, the emergent surface 7. In the present embodiment, the supply ports 28 are capable of supplying the liquid LQ to the space SP4. The liquid LQ is supplied via the supply ports 28 at least during an exposure of the substrate P. In the present embodiment, a plurality of the supply ports 28 is disposed around the optical path K (i.e., the space SP4). Furthermore, the supply ports 28 may be disposed such that they face (i.e., oppose) the side surface 8F of the last optical element 8.

The supply ports 28 are connected to a liquid supply apparatus 28S, which is capable of supplying the liquid LQ, via supply passageways 28R, which are formed inside the first liquid immersion member 31. The liquid supply apparatus 28S is capable of supplying the liquid LQ, which is clean and temperature adjusted. The supply ports 28 supply the liquid LQ from the liquid supply apparatus 28S to the space SP4. At least some of the liquid LQ supplied via the supply ports 28 to the space SP4 flows to the space SP1 via the opening 20.

The supply ports 27 are connected to a liquid supply apparatus 27S, which is capable of supplying the liquid LQ, via supply passageways 27R, which are formed inside the first liquid immersion member 31. The liquid supply apparatus 27S is capable of supplying the liquid LQ, which is clean and temperature adjusted. The supply ports 27 supply the liquid LQ from the liquid supply apparatus 27S to the space SP1.

At least some of the liquid LQ in the space SP1 is recovered via the holes of the porous member 24. As discussed above, in the present embodiment, the holes of the porous member 24 function as the recovery port 23, which is capable of recovering the liquid LQ from the space SP1. The recovery port 23 is connected to a liquid recovery apparatus 23C, which is capable of recovering (i.e., by suction) the liquid LQ via the recovery passageway 23R, which is formed inside the first liquid immersion member 31. The liquid recovery apparatus 23C comprises, for example, a vacuum system and is capable of recovering (i.e., by suction) the liquid LQ.

The liquid supply apparatus 27S, the liquid supply apparatus 28S, and the liquid recovery apparatus 23C are controlled by the control apparatus 4. In the present embodiment, the first immersion space LS1 is formed with the liquid LQ between the last optical element 8 and the first liquid immersion member 31 on one side and the object on the other side by recovering the liquid LQ via the recovery port 23 in parallel with supplying the liquid LQ via the supply ports 28. In addition, in the present embodiment, the supply of the liquid LQ via the supply ports 28, the recovery of the liquid LQ via the recovery port 23, and the supply of the liquid LQ via the supply ports 27 are performed in parallel. In the present embodiment, the first immersion space LS1 is formed with the liquid LQ, which is supplied via the supply ports 28. In addition, in the present embodiment, the first immersion space LS1 is formed with the liquid LQ supplied via the supply ports 27.

The second liquid immersion member 32 has a supply port 50, which is capable of supplying the liquid LQ. In the present embodiment, the object is capable of opposing the supply port 50. The supply port 50 is an opening that faces the space SP2. The supply port 50 is disposed in at least part of the lower surface 15 of the second liquid immersion member 32 such that it faces the space SP2. In the present embodiment, the supply port 50 is capable of supplying the liquid. LQ to the space S12. The supply port 50 supplies the liquid LQ in order to form the second immersion space LS2 in an exposure of the substrate P. In the present embodiment, the axis J2 passes through the supply port 50.

The second liquid immersion member 32 comprises a fluid recovery part 51, which is capable of recovering the fluid. The fluid includes the liquid or the gas, or both. In the present embodiment, the object is capable of opposing the fluid recovery part 51. The fluid recovery part 51 is disposed in at least part of the lower surface 15 of the second liquid immersion member 32 such that it faces the space SP2. In the present embodiment, the fluid recovery part 51 is capable of recovering the liquid LQ from the space SP2. In addition, the fluid recovery part 51 is capable of recovering the gas from the space SP2. In the present embodiment, the fluid recovery part 51 includes a recovery port 52, which is disposed in at least part of the lower surface 15 such that it faces the space SP2. The recovery port 52 is an opening that faces the space SP2. The recovery port 52 recovers the fluid during an exposure of the substrate P. The fluid includes the gas or the liquid LQ, or both. The recovery port 52 is capable of recovering at least some of the liquid LQ from the second immersion space LS2 during an exposure of the substrate P.

In the present embodiment, at least part of the fluid recovery part 51 (i.e., the recovery port 52) is disposed at the outer side of the first liquid immersion member 31 in the radial directions with respect to the optical path K. In the present embodiment, at least part of the fluid recovery part 51 (i.e., the recovery port 52) is disposed between the first liquid immersion member 31 and the supply port 50. In addition, in the present embodiment, at least part of the fluid recovery part 51 (i.e., the recovery port 52) is disposed at the outer side of the first portion B1 in the radial directions with respect to the optical path K.

In the present embodiment, at least part of the fluid recovery part 51 (i.e., the recovery port 52) is disposed at the outer side of the supply port 50 with respect to the first liquid immersion member 31. In the present embodiment, at least part of the fluid recovery part 51 (i.e., the recovery port 52) is disposed at the outer side of the supply port 50 in the radial directions with respect to the optical path K.

In the present embodiment, the axis J2 passes through the fluid recovery part 51 (i.e., the recovery port 52) between the first liquid immersion member 31 and the supply port 50. In the present embodiment, the axis J2 passes through the fluid recovery part 51 (i.e., the recovery port 52) at the outer side of the supply port 50 with respect to the first liquid immersion member 31.

In the present embodiment, the fluid recovery part 51 (i.e., the recovery port 52) is provided such that it surrounds the supply port 50.

The third liquid immersion member 33 has a supply port 53, which is capable of supplying the liquid LQ. In the present embodiment, the object is capable of opposing the supply port 53. The supply port 53 is an opening that faces the space SP3. The supply port 53 is disposed in at least part of the lower surface 16 of the third liquid immersion member 33 such that it faces the space SP3. In the present embodiment, the supply port 53 is capable of supplying the liquid LQ to the space SP3. The supply port 53 supplies the liquid LQ in order to form the third immersion space LS3 during an exposure of the substrate P. In the present embodiment, the axis J3 passes through the supply port 53.

The third liquid immersion member 33 comprises a fluid recovery part 54, which is capable of recovering the fluid. The fluid includes the liquid or the gas, or both. In the present embodiment, the object is capable of opposing the fluid recovery part 54. The fluid recovery part 54 is disposed in at least part of the lower surface 16 of the third liquid immersion member 33 such that it opposes the space SP3. In the present embodiment, the fluid recovery part 54 is capable of recovering the liquid LQ from the space SP3. In addition, the fluid recovery part 54 is capable of recovering the gas from the space SP3. In the present embodiment, the fluid recovery part 54 includes a recovery port 55, which is disposed in at least part of the lower surface 16 such that it faces the space SP3. The recovery port 55 is an opening that faces the space SP3. The recovery port 55 recovers the fluid in an exposure of the substrate P. The fluid includes the gas or the liquid LQ, or both. The recovery port 55 is capable of recovering at least some of the liquid LQ from the third immersion space LS3 during an exposure of the substrate P.

In the present embodiment, at least part of the fluid recovery part 54 (i.e., the recovery port 55) is disposed at the outer side of the fast liquid immersion member 31 in the radial directions with respect to the optical path K. In the present embodiment, at least part of the fluid recovery part 54 (i.e., the recovery port 55) is disposed between the first liquid immersion member 31 and the supply port 53. In addition, in the present embodiment, at least part of the fluid recovery part 54 (i.e., the recovery port 55) is disposed at the outer side of the second portion 32 in the radial directions with respect to the optical path K.

In the present embodiment, at least part of the fluid recovery part 54 (i.e., the recovery port 55) is disposed at the outer side of the supply port 53 with respect to the first liquid immersion member 31. In the present embodiment, at least part of the fluid recovery part 54 (i.e., the recovery port 55) is disposed at the outer side of the supply port 53 in the radial directions with respect to the optical path K.

In the present embodiment, the axis J3 passes through the fluid recovery part 54 (i.e., the recovery port 55) between the first liquid immersion member 31 and the supply port 53. In the present embodiment, the axis J3 passes through the fluid recovery part 54 (i.e., the recovery port 55) at the outer side of the supply port 53 with respect to the first liquid immersion member 31.

In the present embodiment, the fluid recovery part 54 (i.e., the recovery port 55) is provided such that it surrounds the supply port 53.

In the present embodiment, the lower surface 15 is disposed such that it surrounds part of the first portion B1. The lower surface 15 has an angle at the +Y side of the lower surface 14 and has two sides h1 and two sides b2, which are substantially parallel to the sides h1, that are connected at that angle. Namely, the lower surface 15 has an external shape that follows the angle at the +Y side of the lower surface 14. The supply port 50 is slit shaped and substantially parallel to the sides h1, h2. The part of the recovery port 52 between the first liquid immersion member 31 and the supply port 50 is slit shaped and substantially parallel to the supply port 50. The part of the recovery port 52 at the outer side of the supply port 50 with respect to the first liquid immersion member 31 is slit shaped and substantially parallel to the supply port 50.

In the present embodiment, the lower surface 16 is disposed such that it surrounds part of the second portion B2. The lower surface 16 has an angle at the −Y side of the lower surface 14 and has two sides h3 and two sides h4, which are substantially parallel to the sides h3, that are connected at that angle. Namely, the lower surface 16 has an external shape that follows the angle at the −Y side of the lower surface 14. The supply port 53 is slit shaped and substantially parallel to the sides h3, h4. The part of the recovery port 55 between the first liquid immersion member 31 and the supply port 53 is slit shaped and substantially parallel to the supply port 53. The part of the recovery port 55 at the outer side of the supply port 53 with respect to the first liquid immersion member 31 is slit shaped and substantially parallel to the supply port 53.

Furthermore, a plurality of the recovery ports 52 may be disposed around the supply port 50. Namely, the recovery ports 52 may be disposed such that they are distributed around the supply port 50. In addition, a plurality of the recovery ports 55 may be disposed around the supply port 53.

The supply port 50 is connected to a liquid supply apparatus 50S, which is capable of supplying the liquid LQ, via a supply passageway 50R, which is formed inside the second liquid immersion member 32. The liquid supply apparatus 50S is capable of supplying the liquid LQ, which is clean and temperature adjusted. The supply port 50 supplies the liquid LQ from the liquid supply apparatus 50S to the space SP2.

At least some of the liquid LQ is recovered from the space SP2 via the fluid recovery part 51 (i.e., the recovery port 52). The fluid recovery part 51 (i.e., the recovery port 52) of the second liquid immersion member 32 is capable of recovering the liquid LQ from the space SP1 between the first liquid immersion member 31 and the object.

The recovery port 52 is connected to a liquid recovery apparatus 52C, which is capable of recovering (i.e., by suction) the liquid LQ via a recovery passageway 52R, which is formed inside the second liquid immersion member 32. The liquid recovery apparatus 52C comprises, for example, a vacuum system and is capable of recovering (i.e., by suction) the liquid LQ. In addition, the recovery port 52 is also capable of recovering the gas from the space SP2.

The supply port 53 is connected to a liquid supply apparatus 53S, which is capable of supplying the liquid LQ, via a supply passageway 53R, which is formed inside the third liquid immersion member 33. The liquid supply apparatus 53S is capable of supplying the liquid LQ, which is clean and temperature adjusted. The supply port 53 supplies the liquid LQ from the liquid supply apparatus 53S to the space SP3.

At least some of the liquid LQ is recovered from the space SP3 via the fluid recovery part 54 (i.e., the recovery port 55). The fluid recovery part 54 the recovery port 55) of the third liquid immersion member 33 is capable of recovering the liquid LQ from the space SP1 between the first liquid immersion member 31 and the object.

The recovery port 55 is connected to a liquid recovery apparatus 55C, which is capable of recovering (i.e., by suction) the liquid LQ, via a recovery passageway 55R, which is formed inside the third liquid immersion member 33. The liquid recovery apparatus 55G comprises, for example, a vacuum system, and is capable of recovering (i.e., by suction) the liquid LQ. In addition, the recovery port 55 is also capable of recovering the gas from the space SP3.

In the present embodiment, the second immersion space LS2 is formed with the liquid LQ supplied via the supply port 50. In addition, in the present embodiment, the third immersion space LS3 is formed with the liquid LQ supplied via the supply port 53.

The first recovery member 34 comprises a fluid recovery part 56, which is disposed at least partly around the first liquid immersion member 31 and is capable of recovering the fluid. The fluid includes the liquid or the gas, or both. In the present embodiment, the object is capable of opposing the fluid recovery part 56. The fluid recovery part 56 is disposed in at least part of the lower surface 17 of the first recovery member 34 such that it faces a space SP5 between the lower surface 17 and the front surface of the object. In the present embodiment, the fluid recovery part 56 is capable of recovering the liquid LQ or the gas, or both, from the space SP5. In the present embodiment, the fluid recovery part 56 includes recovery ports 57, which are disposed in at least part of the lower surface 17 and such that they face the space SP5. The recovery ports 57 are openings that are disposed at least partly around the first liquid immersion member 31 and that face the space SP5. The recovery ports 57 recover the fluid during an exposure of the substrate P. The fluid includes the gas or the liquid LQ, or both. In the present embodiment, a plurality of the recovery ports 57 is disposed in the lower surface 17.

In the present embodiment, at least part of the fluid recovery part 56 (i.e., the recovery port 57) is disposed at the outer side of the first liquid immersion member 31 in the radial directions with respect to the optical path K. In the present embodiment, at least part of the fluid recovery part 56 (i.e., the recovery ports 57) is disposed at the outer side of the liquid recovery part 21 in the radial directions with respect to the optical path K.

In the present embodiment, the lower surface 17 is disposed such that it surrounds the angle at the +X side of the lower surface 14. The lower surface 17 has the angle at the +X side of the lower surface 14 and has two sides h5 and two sides h6, which are substantially parallel to the sides h5, that are connected at that angle. Namely, the lower surface 17 has an external shape that follows the angle at the +X side of the lower surface 14.

Furthermore, the recovery ports 57 may be slit shapes that follow along the sides h6.

The second recovery member 35 comprises a fluid recovery part 58, which is disposed at least partly around the first liquid immersion member 31 and is capable of recovering the fluid. The fluid includes the liquid or the gas, or both. In the present embodiment, the object is capable of opposing the fluid recovery part 58. The fluid recovery part 58 is disposed in at least part of the lower surface 18 of the second recovery member 35 such that it faces a space SP6 between the lower surface 18 and the front surface of the object. In the present embodiment, the fluid recovery part 58 is capable of recovering the liquid LQ or the gas, or both, from the space SP6. In the present embodiment, the fluid recovery part 58 has recovery ports 59, which are disposed in at least part of the lower surface 18 and such that they face the space SP6. The recovery ports 59 are openings that are disposed at least partly around the first liquid immersion member 31 and that face the space SP6. The recovery ports 59 recover the fluid during an exposure of the substrate P. The fluid includes the gas or the liquid LQ, or both. In the present embodiment, a plurality of the recovery ports 59 is disposed in the lower surface 18.

In the present embodiment, at least part of the fluid recovery part 58 (i.e., the recovery ports 59) is disposed at the outer side of the first liquid immersion member 31 in the radial directions with respect to the optical path K. In the present embodiment, at least part of the fluid recovery part 58 (i.e., the recovery ports 59) is disposed at the outer side of the liquid recovery part 21 in the radial directions with respect to the optical path K.

In the present embodiment, the lower surface 18 is disposed such that it surrounds the angle at the −X side of the lower surface 14. The lower surface 18 has the angle at the −X side of the lower surface 14 and has two sides h7 and two sides h8, which are substantially parallel to the sides h7, that are connected at that angle. Namely, the lower surface 18 has an external shape that follows along the angle at the −X side of the lower surface 14.

Furthermore, the recovery ports 59 may be slit shapes that follow along the sides h8.

At least some of the liquid LQ is recovered from the space SP5 via the recovery ports 57. The recovery ports 57 are capable of recovering (or suctioning) the liquid LQ from, for example, the space SP 1 between the first liquid in member 31 and the object. The recovery ports 57 are connected to a liquid recovery apparatus 57C, which is capable of recovering (i.e., by suction) the liquid LQ, via recovery passageways 57R, which are formed inside the first recovery member 34. The liquid recovery apparatus 57C comprises, for example, a vacuum system and is capable of recovering (i.e., by suction) the liquid LQ. In addition, the recovery ports 57 are also capable of recovering the gas from the space SP5.

The first recovery member 34 has no liquid recovery port for forming a liquid immersion space between the lower surface 17 and the opposing object, so that no liquid immersion space is formed between the lower surface 17 and the opposing object and that the liquid LQ from the space SP1 is recovered via the liquid recovery ports 57. In other words, the liquid recovery ports 57 of the first recovery member 34 recover the liquid LQ being from the space SP1 and having been leaked to a space, which is a part of the space around the liquid immersion member 31 and between the second liquid immersion space LS2 and the third liquid immersion space LS3 and in which the second immersion space LS2 and the third immersion space LS3 are not formed.

At least some of the liquid LQ is recovered from the space, SP6 via the recovery ports 59. The recovery ports 59 are capable of recovering (or suctioning) the liquid LQ from, for example, the space SP1 between the first liquid immersion member 31 and the object. The recovery ports 59 are connected to a liquid recovery apparatus 59C, which is capable of recovering (i.e., by suction) the liquid LQ, via recovery passageways 59R, which are formed imide the second recovery member 35. The liquid recovery apparatus 59C comprises, for example, a vacuum system and is capable of recovering (i.e., by suction) the liquid LQ. In addition, the recovery ports 59 are also capable of recovering the gas from the space SP6.

The second recovery member 35 has no liquid recovery port for forming a liquid immersion space between the lower surface 18 and the opposing object, so that no liquid immersion space is formed between the lower surface 18 and the opposing object and that the liquid LQ from the space SP1 is recovered via the liquid recovery ports 59. In other words, the liquid recovery ports 59 of the second recovery member 35 recover the liquid LQ being from the space SP1 and having been leaked to a space, which is a part of the space around the liquid immersion member 31 and between the second liquid immersion space LS2 and the third liquid immersion space LS3 and in which the second immersion space LS2 and the third immersion space LS3 are not formed.

In the present embodiment, at least part of the lower surface 14 is substantially parallel to the XY plane. In addition, in the present embodiment, at least part of the lower surface 15 is substantially parallel to the XY plane. In addition, in the present embodiment, at least part of the lower surface 16 is substantially parallel to the XY plane. In addition, in the present embodiment, at least part of the lower surface 17 is substantially parallel to the XY plane. In addition, in the present embodiment, at least part of the lower surface 18 is substantially parallel to the XY plane.

Furthermore, at least part of the lower surface 14 may be tilted with respect to the XY plane and may include a curved surface. At least part of the lower surface 15 may be tilted with respect to the XY plane and may include a curved surface. At least part of the lower surface 16 may be tilted with respect to the XY plane and may include a curved surface. At least part of the lower surface 17 may be tilted with respect to the XY plane and may include a curved surface. At least part of the lower surface 18 may be tilted with respect to the XY plane and may include a curved surface.

In the present embodiment, the position (i.e., the height) of the lower surface 14 and the position (i.e., the height) of the lower surface 15 in the Z axial directions are substantially equal. In addition, in the present embodiment, the position (i.e., the height) of the lower surface 14 and the position (i.e., the height) of the lower surface 16 in the Z axial directions are substantially equal. In addition, in the present embodiment, the position (i.e., the height) of the lower surface 14 and the position (i.e., the height) of the lower surface 17 in the Z axial directions are substantially equal. In addition, in the present embodiment, the position (i.e., the height) of the lower surface 14 and the position (i.e., the height) of the lower surface 18 in the Z axial directions are substantially equal.

In other words, in the present embodiment, the distance between the lower surface 14 and the front surface of the object, the distance between the lower surface 15 and the front surface of the object, the distance between the lower surface 16 and the front surface of the object, the distance between the lower surface 17 and the front surface of the object, and the distance between the lower surface 18 and the front surface of the object are substantially equal.

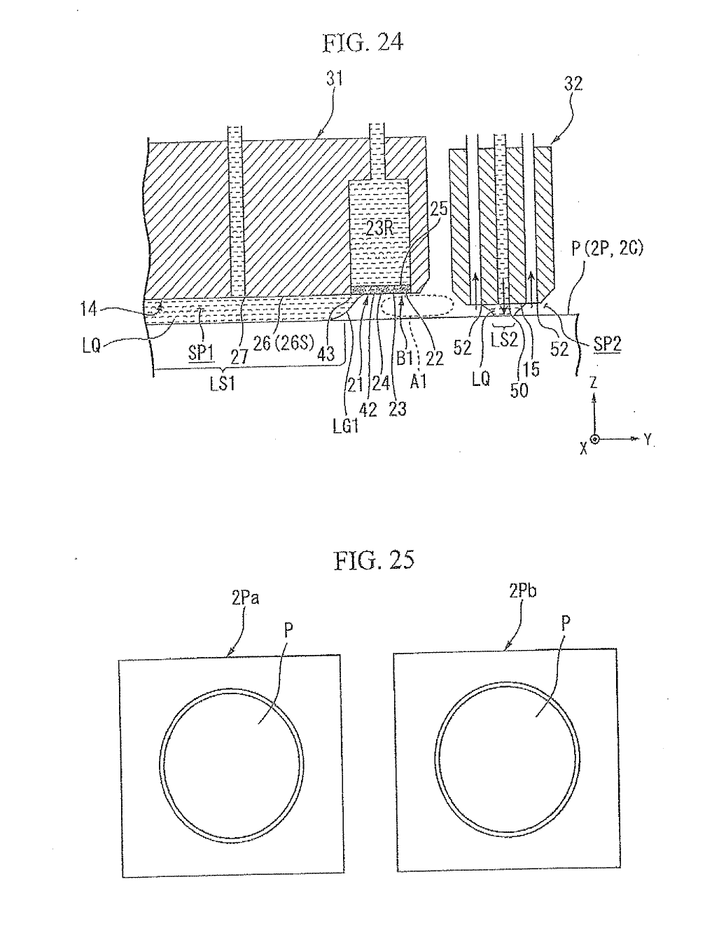

Furthermore, the height of the lower surface 14 and the height of the lower surface 15 may be different. For example, the lower surface 15 may be disposed at a higher position than the lower surface 14 is, or, as shown in FIG. 24, the lower surface 15 may be disposed at a lower position than the lower surface 14 is. Namely, the distance between the lower surface 14 and the front surface of the object may be larger or smaller than the distance between the lower surface 15 and the front surface of the object. In addition, the distance between the lower surface 14 and the front surface of the object may be larger than the distance between the lower surface 16 and the front surface of the object, or smaller than the distance between the lower surface 16 and the front surface of the object. In addition, the distance between the lower surface 14 and the front surface of the object may be larger or smaller than the distance between the lower surface 17 and the front surface of the object. In addition, the distance between the lower surface 14 and the front surface of the object may be larger or smaller than the distance between the lower surface 18 and the front surface of the object.

A method of using the exposure apparatus EX that has the configuration discussed above to expose the substrate P will now be explained.

The control apparatus 4 performs a process that loads the unexposed substrate p onto the substrate holding part 10. To load the unexposed substrate P onto the substrate holding part 10, the control apparatus 4 moves the substrate stage 2P to a substrate exchange position, which is spaced apart from the liquid immersion member 3. Furthermore, for example, if the exposed substrate P is already held by the substrate holding part 10, then the process of loading the unexposed substrate P onto the substrate holding part 10 is performed after the process of unloading the unexposed substrate P from the substrate holding part 10 has been performed.

The substrate exchange position is a position at which the substrate P exchanging process can be performed. The substrate P exchanging process includes at least one of the following processes performed using a transport apparatus: a process that unloads the exposed substrate P, which is held by the substrate holding part 10, from the substrate holding part 10, and a process that loads the unexposed substrate P onto the substrate holding part 10. The control apparatus 4 moves the substrate stage 2P to the substrate exchange position, which is spaced apart from the liquid immersion member 3, and performs the substrate P exchanging process.

During at least part of the interval during which the substrate stage 2P is spaced apart from the liquid immersion member 3, the control apparatus 4 disposes the measurement stage 2C at a prescribed position with respect to the liquid immersion member 3 and forms the first immersion space LS1 by holding the liquid LQ between the last optical element 8 and the first liquid immersion member 31 on one side and the measurement stage 2C on the other side. Namely, the control apparatus 4 forms, using the first liquid immersion member 31, at the emergent surface 7 side of the last optical element 8, the first immersion space LS1 of the liquid LQ in the state wherein the last optical element 8 and the first liquid immersion member 31 on one side and the measurement stage 2C on the other side are opposed to one another.

The control apparatus 4 performs the recovery of the liquid LQ via the recovery port 23 in parallel with the supply of the liquid LQ via the supply ports 28. Thereby, the first immersion space LS1 is formed. In addition, in the present embodiment, the control apparatus 4 performs the supply of the liquid LQ via the supply ports 27 in parallel with the supply of the liquid LQ via the supply ports 28 and the recovery of the liquid LQ via the recovery port 23.

Supplying the liquid LQ via the supply ports 27 adjusts, for example, the shape of the interface LG1. For example, supplying the liquid LQ via the supply ports 27 adjusts the shape of the interface LG1 in the case wherein the object has moved within the XY plane in the state wherein the first immersion space LS1 is formed between the last optical element 8 and the first liquid immersion member 31 on one side and the object on the other side.

Furthermore, in the state wherein the first immersion space LS1 is formed, the amount of the liquid supplied per unit of time via the supply ports 27 may be constant or may vary. Furthermore, the amount of the liquid supplied per unit of time via each of the supply ports 27 of the plurality of supply ports 27 may be the same or different. For example, in the state wherein the first immersion space LS1 is formed, control may be perfumed such that the amount of the liquid supplied per unit of time via each of the supply ports 27 of the plurality of supply ports 27 differs in accordance with the movement direction of the object (i.e., the substrate P) within the XY plane.

Furthermore, in the state wherein the first immersion space LS1 is formed by the supply of the liquid LQ via the supply ports 28 and the recovery of the liquid LQ via the recovery port 23, the supply of the liquid LQ via the supply ports 27 may be stopped. Furthermore, the supply ports 27 may be omitted.

In addition, the control apparatus 4 forms, using the second liquid immersion member 32, the second immersion space LS2 of the liquid LQ partly around the first immersion space LS1. The second immersion space LS2 is formed with the liquid LQ supplied via the supply port 50. In addition, the control apparatus 4 forms, using the third liquid immersion member 33, the third immersion space LS3 of the liquid LQ partly around the first immersion space LS1. The third immersion space LS3 is formed with the liquid LQ supplied via the supply port 53.

In addition, during at least part of the interval during which the substrate stage 2P is spaced apart from the liquid immersion member 3, the measuring process may be performed, as needed, using the measuring member (the measuring instrument) mounted on the measurement stage 2C. When the measuring process using the measuring member (the measuring instrument) is to be performed, the control apparatus 4 causes the last optical element 8 and the first liquid immersion member 31 on one side and the measurement stage 2C on the other side to oppose one another and forms the first immersion space LS1 such that the optical path K between the last optical element 8 and the measuring member is filled with the liquid LQ. The control apparatus 4 performs the measuring process using the measuring member by radiating the exposure light EL to the measuring member through the projection optical system PL and the liquid LQ. The result of that measuring process is reflected in the exposing process to be performed on the substrate P.

After the unexposed substrate P is loaded onto the substrate holding part 10 and the measuring process that uses the measurement member (the measuring instrument) has ended, the control apparatus 4 moves the substrate stage 2P to the projection area PR and forms the first immersion space LS1 of the liquid LQ between the last optical element 8 and the first liquid immersion member 31 on one side and the substrate stage 2P (i.e., the substrate P) on the other side.

Furthermore, during the movement of the substrate stage 2P from the substrate exchange position to the projection area PR (i.e., an exposure position), the position of the substrate P (i.e., the substrate stage 2P) may be detected using a detection system that comprises an encoder system, an alignment system, and a surface position detection system, as disclosed in, for example, U.S. Patent Application Publication No. 2007/0288121.

In the present embodiment, for example, as disclosed in U.S. Patent Application Publication No, 2006/0023186 and U.S. Patent Application Publication No. 2007/0127006, the control apparatus 4 can—in the state wherein the upper surface of the substrate stage 2P and the upper surface of the measurement stage 2C have been brought into close proximity or contact with one another such that the first immersion space LS1 of the liquid LQ continues to be formed between the last optical element 8 and the first liquid immersion member 31 on one side and the substrate stage 2P or the measurement stage 2C, or both, on the other side—move the substrate stage 2P and the measurement stage 2C within the XY plane with respect to the last optical element 8 and the liquid immersion member 3 while causing the last optical element 8 and the first liquid immersion member 31 on one side and the substrate stage 2P or the measurement stage 2C or both, on the other side to oppose one another.

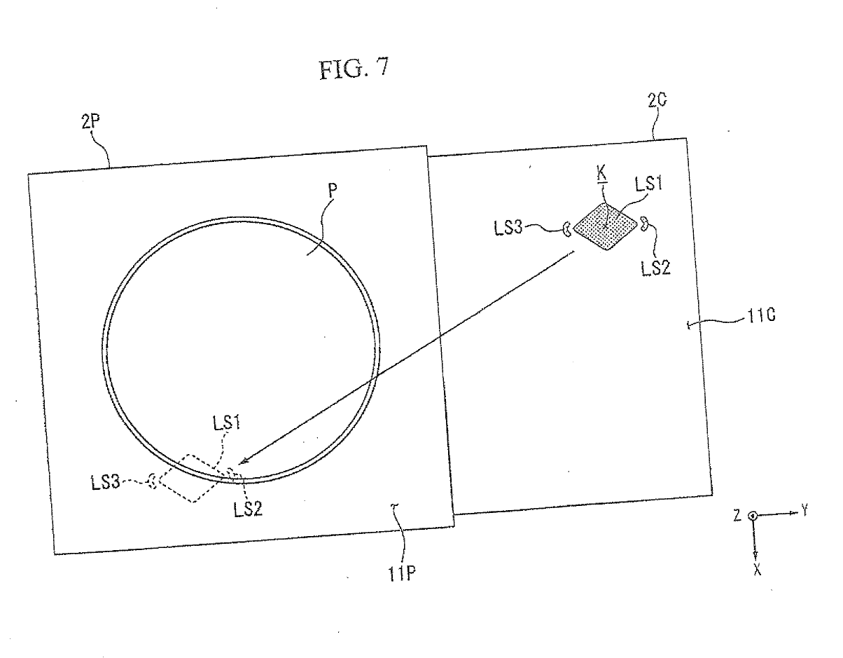

Thereby, as shown in FIG. 7, while the liquid LQ is being prevented from leaking, the first immersion space LS1 transitions from the state wherein the first immersion-space LS1 is fanned between the last optical element 8 and the first liquid immersion member 31 on one side and the measurement stage 2C on the other side to the state wherein the first immersion space LS1 is formed between the last optical element 8 and the first liquid immersion member 31 on one side and the substrate stage 2P on the other side. In addition, the control apparatus 4 can also cause the first immersion space LS1 to transition from the state wherein the first immersion space LS1 is fanned between the last optical element 8 and the first liquid immersion member 31 on one side and the substrate stage 2P on the other side to the state wherein the first immersion space LS1 is formed between the last optical element 8 and the first liquid immersion member 31 on one side and the measurement stage 2C on the other side.

In the explanation below, the operation of synchronously moving the substrate stage 2P and the measurement stage 2C within the XY plane with respect to the last optical element 8 and the liquid immersion member 3 in the state wherein the upper surface 11P of the substrate stage 2P and the upper surface 11C of the measurement stage 2C are brought into close proximity or contact with one another is called a “rugby serum operation” where appropriate.

As shown in FIG. 7, in the rugby scrum operation, the substrate stage 2P and the measurement stage 2C move, in the state wherein the upper surface 11P and the upper surface 11C have been brought into close proximity or contact with one another, in a direction that includes a Y axis directional component. In the movement of the substrate stage 2P and the measurement stage 2C in the direction that includes a Y axis directional component, the upper surface 11P of the substrate stage 2P and the upper surface 11C of the measurement stage 2C traverse the optical path K of the exposure light EL.

Furthermore, the movement in the direction that includes a Y axis directional component includes at least one of the following movements: movement in the +Y direction, movement in the −Y direction, movement in the +Y direction and the +X direction, movement in the +Y direction and the −X direction, movement in the −Y direction and the +X direction, and movement in the −Y direction and the −X direction.

In the present embodiment, the second immersion space LS2 and the third immersion space LS3 also continue to be formed partly around the first immersion space LS1 during the rugby scrum operation.

The control apparatus 4 starts the substrate P exposing process after performing the rugby scrum operation, forming the first immersion space LS1 of the liquid LQ between the last optical element 8 and the first liquid immersion member 31 on one side and the substrate stage 2P (i.e., the substrate P) on the other side, and forming the second immersion space LS2 and the third immersion space LS3 partly around the first immersion space LS1.

When performing the substrate P exposing process, the control apparatus 4 causes the last optical element 8 and the liquid immersion member 3 on one side and tire substrate stage 2P on the other side to oppose one another and forms with the first liquid immersion member 31 the first immersion space LS1 of the liquid LQ at the emergent surface 7 side of the last optical element 8 such that the optical path K between the last optical element 8 and the substrate P is filled with the liquid LQ. The control apparatus 4 causes the exposure light EL to be emitted from the illumination system IL. The illumination system IL illuminates the mask M with the exposure light EL. The exposure light EL that emerges from the mask M is radiated to the substrate P through the projection optical system PL and the liquid LQ. Thereby, the substrate P is exposed with the exposure light EL, which transits the liquid LQ in the first immersion space LS1, and thus the image of the pattern of the mask M is projected to the substrate P.

The exposure apparatus EX of the present embodiment is a scanning type exposure apparatus (i.e., a so-called scanning stepper) that projects the image of the pattern, of the mask M to the substrate P while synchronously moving the mask M and the substrate P in prescribed scanning directions. In the present embodiment, the scanning directions (i.e., the synchronous movement directions) of both the substrate P and the mask M are the Y axial directions. The control apparatus 4 both moves the substrate P in the Y axial direction with respect to the projection area PR of the projection optical system PL and radiates the exposure light EL to the substrate P through the projection optical system PL and the liquid LQ in the first immersion space LS1 on the substrate P while, at the same time, moving the mask M in the Y axial direction with respect to the illumination area IR of the illumination system IL such that this movement is synchronized with the movement of the substrate P.

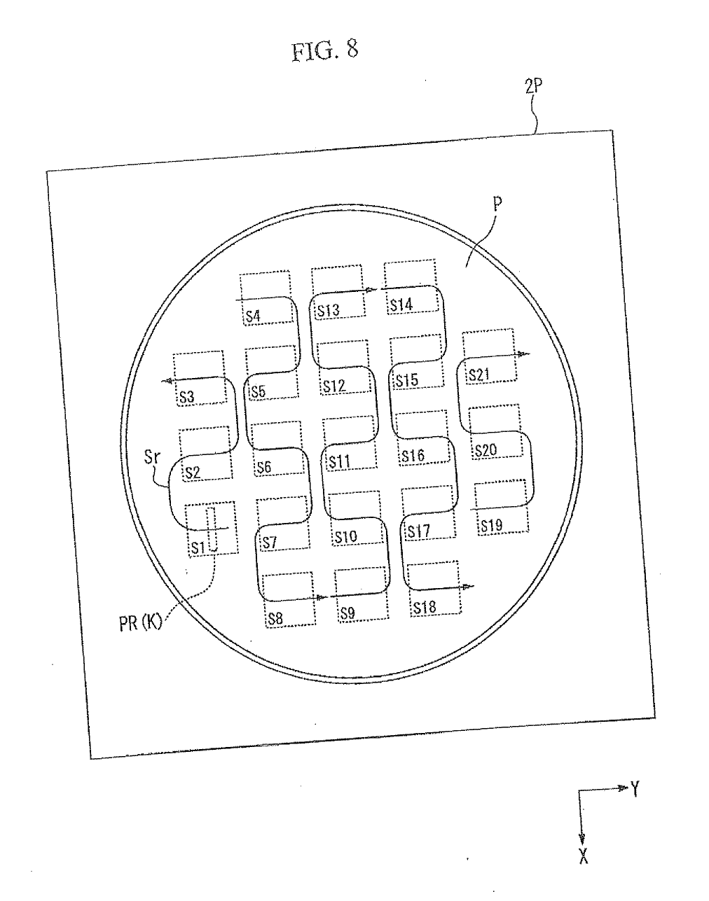

FIG. 8 shows one example of the substrate P held by the substrate stage 2P. In the present embodiment, multiple shot regions S1-S21, which are exposure target areas, are disposed on the substrate P in a matrix. In an exposure of the substrate P, the first immersion space LS1 is formed on the substrate P such that the optical path K of the exposure light EL at the emergent surface 7 side of the last optical element 8 is filled with the liquid LQ. The control apparatus 4 successively exposes the multiple shot regions S1-S21 on the substrate P, which is held by the substrate holding part 10, with the exposure light EL through the liquid LQ of the first immersion space LS1. The shot regions S1-S21 of the substrate P are exposed by the exposure light EL, which passes through the liquid LQ.

To expose, for example, the first shot region S1 of the substrate P, the control apparatus 4 both moves the substrate P (i.e., the first shot region S1) in the Y axial direction with respect to the projection area PR of the projection optical system PL and radiates the exposure light EL to the first shot region S1 through the projection optical system PL and the liquid LQ in the first immersion space LS1 on the substrate P while, at the same time, moving the mask M in the Y axial direction with respect to the illumination area IR of the illumination system IL such that this movement is synchronized with the movement of the substrate P. Thereby, an image of the pattern of the mask M is projected to the first shot region S1 of the substrate P and that first shot region S1 is exposed with the exposure light EL, which emerges from the emergent surface 7. After the exposure of the first shot region S1 has ended, the control apparatus 4, in order to start the exposure of the second shot region S2, which is the next shot region, moves the second shot region S2 to an exposure start position by moving the substrate P in prescribed directions (e.g., the X axial directions or directions tilted with, respect to the X axial directions within the XY plane) within the XY plane in the state wherein the first immersion space LS1 is formed. Subsequently, the control apparatus 4 starts the exposure of the second shot region S2.

The control apparatus 4 sequentially exposes a plurality of shot regions on the substrate P by repetitively performing; air operation that, while moving a shot region in the axial direction with respect to the projection area PR, exposes that shot region; and an operation that, after the exposure of that shot region is complete, moves the next shot region to the exposure start position.

In the explanation below, the operation of moving the substrate P in the Y axial directions with respect to the last optical element 8 in order to expose a shot region is called a scanning operation where appropriate. In addition, to expose the next shot region after the exposure of a certain shot region has ended, the operation of moving the substrate P with respect to the last optical element 8 such that the next shot region is disposed in the exposure start position, is called a stepping operation where appropriate.

In the present embodiment, during the scanning operation, too, the second immersion space LS2 and the third immersion space LS3 continue to be formed partly around the first immersion space LS1. In addition, in the present embodiment, during the stepping operation, too, the second immersion space LS2 and the third immersion space LS3 continue to be formed partly around the first immersion space LS1.

The control apparatus 4 moves the substrate P (i.e., the substrate stage 2P) based on the exposure condition of the shot regions S1-S21 on the substrate P. The exposure condition of the shot regions S1-S21 is defined by, for example, exposure control information, which is called an exposure recipe. The exposure control information is stored in the storage apparatus 5. The control apparatus 4 successively exposes the shot regions S1-S21 while moving the substrate P under a prescribed movement condition based on the exposure condition stored in the storage apparatus 5. The movement condition of the substrate P (i.e., the object) includes at least one of the following: a movement velocity, a movement distance, and a locus of movement with respect to the optical path K (i.e., the first immersion space LS1).

In the present embodiment, the control apparatus 4 successively exposes the shot regions S1-S21 of the substrate P with the exposure light EL through the liquid LQ by radiating the exposure light EL to the projection area PR while moving the substrate stage 2P such that the projection area PR of the projection optical system PL and the substrate P move relative to one another along the locus of movement shown by arrows Sr in FIG. 8.

As shown in FIG. 8, during at least part of the scanning operation and of the stepping operation, the substrate P (i.e., the substrate stage 2P) moves in a direction that includes a Y axis directional component. In the movement of the substrate P (i.e., the substrate stage 2P) in the direction that includes a Y axis directional component, the front surface of the substrate P the upper surface of the substrate stage 2P) traverses the optical path K of the exposure light EL.

Furthermore, the movement in the direction that includes a Y axis directional component includes at least one of the following movements: movement in the +Y direction, movement in the −Y direction, movement in the +Y direction and the +X direction, movement in the +Y direction and the −X direction, movement in the −Y direction and the +X direction, and movement in the −Y direction and the −X direction.

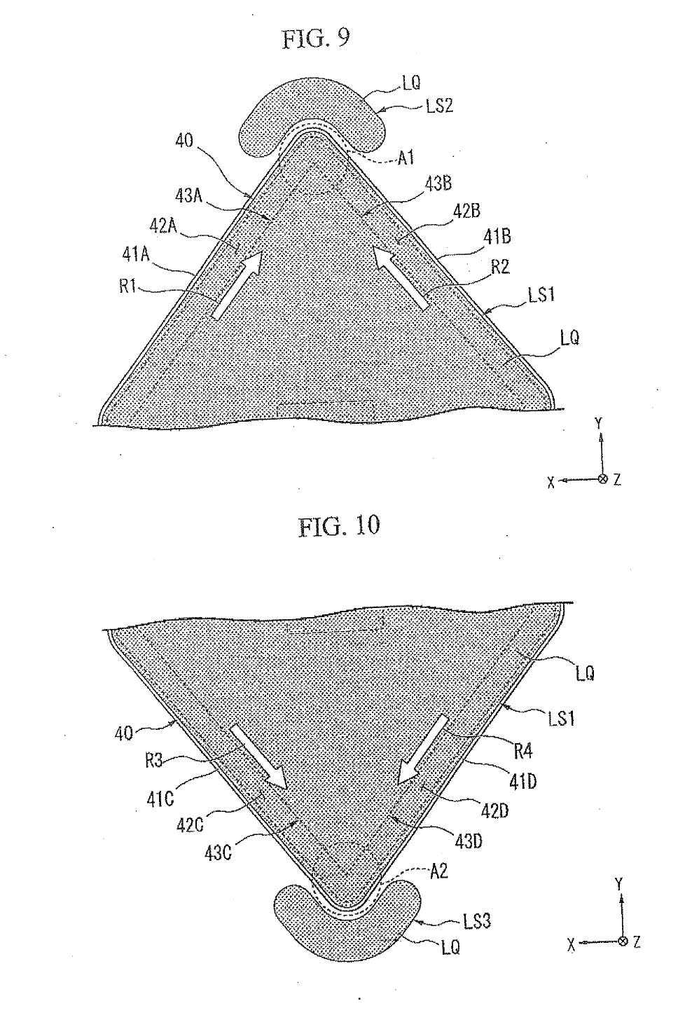

FIG. 9 and FIG. 10 schematically show one example of a state of the liquid LQ that forms the first immersion space LS1 when the object, such as the substrate P, moves in the Y axial directions parallel to the axes J2, J3 in the state wherein the first immersion space LS1 is formed.

In the present embodiment, the guide part 40, which guides at least some of the liquid LQ that forms the first immersion space LS1 to the first guide space A1 or the second guide space A2, or both, is provided.

As shown in FIG. 9, if, for example, the object moves in the +Y direction, that movement causes at least some of the liquid LQ that forms the first immersion space LS1 to flow in the space SP1. At least some of the liquid LQ that forms the first immersion space LS1 and flows by the movement of the object in the +Y direction flows, by virtue of the guide part 40, in, for example, the directions indicated by arrows R1, R2, and is guided to the first guide space A1. For example, at least some of the liquid LQ that forms the first immersion space LS1 flows in the direction indicated by the arrow R1 by virtue of for example, at least part of the portion 41A, the portion 42A, and the portion 43A of the guide part 40, and is guided to the first guide space A1. In addition, at least some of the liquid LQ that forms the first immersion space LS1 flows in the direction indicated by the arrow R2 by virtue of for example, at least part of the portion 41B, the portion 42B, and the portion 43B of the guide part 40, and is guided to the first guide space A1.

Furthermore, even if the object has moved in a direction other than the +Y direction, the guide part 40 can still guide the liquid LQ to the first guide space A1. Namely, if the object moves in a direction that includes +Y directional component, the guide part 40 can guide the liquid LQ to the first guide space A1. For example, if the object moves in the +X direction while moving in the +Y direction, the guide part 40 can guide the liquid LQ to the first guide space A1. In addition, if the object moves in the −X direction while moving in the +Y direction, the guide part 40 can guide the liquid LQ to the first guide space A1. Thus, the guide part 40 can guide to the first guide space A1 at least some of the liquid LQ that forms the first immersion space LS1 and flows by virtue of the movement of the object that includes the +Y direction.

As shown in FIG. 10, if, for example, the object moves in the −Y direction, that movement causes at least some of the liquid LQ that forms the first immersion space LS1 to flow in the space SP1. At least some of the liquid LQ that forms the first immersion space LS1 and flows by the movement of the object in the −Y direction flows, by virtue of the guide part 40, in, for example, the directions indicated by arrows R3, R4, and is guided to the second guide space A2. For example, at least some of the liquid LQ that forms the first immersion space LS1 flows in the direction indicated by the arrow R3 by virtue of, for example, at least part of the portion 41C, the portion 42C, and the portion 43C of the guide part 40, and is guided to the second guide space A2. In addition, at least some of the liquid LQ that forms the first immersion space LS1 flows in the direction indicated by the arrow R4 by virtue of for example, at least part of the portion 41D, the portion 42D, and the portion 43D of the guide part 40, and is guided to the second guide space A2.

Furthermore, even if the object has moved in a direction other than the −Y direction, the guide part 40 can still guide the liquid LQ to the second guide space A2. Namely, if the object moves in a direction that includes a −Y directional component, the guide part 40 can guide the liquid LQ to the second guide space A2. For example, if the object moves in the +X direction while moving in the −Y direction, the guide part 40 can guide the liquid LQ to the second guide space A2. In addition, if the object moves in the −X direction while moving in the −Y direction, the guide part 40 can guide the liquid LQ to the second guide space A2. Thus, the guide part 40 can guide to the second guide space A2 at least some of the liquid LQ that forms the first immersion space LS1 and flows by virtue of the movement of the object that includes the −Y direction.

If in the state wherein the first immersion space LS1 is formed the object has moved under a prescribed movement condition in a prescribed operation of the exposure apparatus EX, then at least some of the liquid LQ in the first immersion space LS1 might adversely flow out of the first immersion space LS1 to the outer side of the space SP1.

For example, in the rugby scram operation of the exposure apparatus EX, at least some of the liquid LQ in the first immersion space LS1 might flow out to the outer side of the space SP1.

In addition, in the scanning operation of the exposure apparatus EX, at least some of the liquid LQ in the first immersion space LS1 might flow out to the outer side of the space SP1.

In addition, in the stepping operation of the exposure apparatus EX, at least some of the liquid LQ in the first immersion space LS1 might flow out to the outer side of the space SP1.

For example, in at least one of the prescribed operations, namely, the rugby serum operation, the scanning operation, or the stepping operation, there is a possibility that the object will move in the Y axial directions under a condition wherein a prescribed permissible condition under which the first immersion space LS1 of the liquid LQ can be maintained between the first liquid immersion member 31 and the object is not satisfied.

Fox example, in the prescribed operation, there is a possibility that the object will move in the Y axial directions over a distance longer than a prescribed permissible distance at which it is possible to maintain the first immersion space LS1 of the liquid LQ between the first liquid immersion member 31 and the object.

In addition, in the prescribed operation, there is a possibility that the object will move in the Y axial directions at a velocity higher than a prescribed permissible velocity at which the first immersion space LS1 of the liquid LQ can be maintained between the first liquid immersion member 31 and the object.

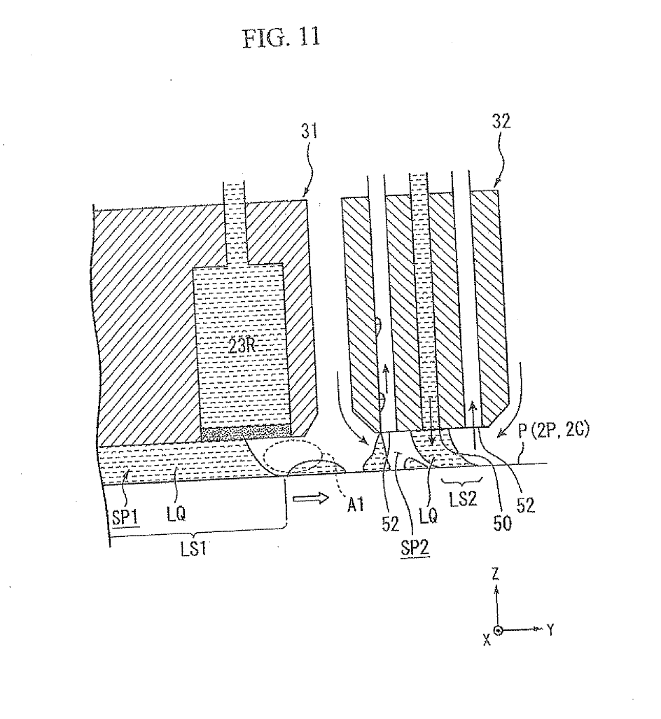

FIG. 11 schematically shows one example of a state wherein the object is moving in the Y axial directions under a condition wherein a prescribed permissible condition under which the first immersion space LS1 of the liquid LQ can be maintained between the first liquid immersion member 31 and the object is not satisfied. As shown in FIG. 11, there is a possibility that, for example, if the object has moved in the Y axial directions under a condition in which the permissible condition is not satisfied, at least some of the liquid LQ in the first immersion space LS1 will flow out of the first immersion space LS1 to the outer side of the space SP1.

In the present embodiment, if the object has moved in the +Y direction, the liquid LQ in the first immersion space LS1 is guided by the guide part 40 to the first guide space A1. Accordingly, if the object has moved in the +Y direction under a condition in which the permissible condition is not satisfied, then there is a strong possibility that the liquid LQ in the first immersion space LS1 will collect in the first guide space A1 and then flow out of the first guide space A1 to the outer side of the space SP1. Namely, if the object has moved in the +Y direction, there is a strong possibility that the liquid LQ in the first immersion space LS1 will collect in the first guide space A1 and then flow out to the +Y side of the first guide space A1.

In the present embodiment, the second immersion space LS2 of the liquid LQ is formed by the second liquid immersion member 32 such that the second immersion space LS2 is adjacent to the first guide space A1. In the present embodiment, the second liquid immersion member 32 is disposed adjacent to the first liquid immersion member 31 in the Y axial directions in which the object moves in the prescribed operation of the exposure apparatus EX. The second immersion space LS2 is disposed such that it is at the +Y side of and adjacent to the first guide space A1.

Accordingly, the liquid LQ that flows out of the first guide space A1 to the outer side of the space SP1 is hindered by the second immersion space LS2 from flowing out to the outer side of the space SP2. Namely, the second immersion space LS2 stops the liquid LQ from flowing out of the first guide space A1. For example, the liquid LQ that flows out of the first guide space A1 to the outer side of the space SP1 combines with the liquid LQ of the second immersion space LS2 in the space SP2. In addition, the liquid LQ that flows out of the first guide space A1 to the outer side of the space SP1 is recovered via the recovery port 52 between the first liquid immersion member 31 and the supply port 50.

In addition, if the object has moved in the −Y direction, the liquid LQ in the first immersion space LS1 is guided by the guide part 40 to the second guide space A2. Accordingly, if the object has moved in the −Y direction under a condition in which the permissible condition is not satisfied, then there is a strong possibility that the liquid LQ in the first immersion space LS1 will collect in the second guide space A2 and then flow out of the second guide space A2 to the outer side of the space SP1. Namely, if the object has moved in the −Y direction, there is a strong possibility that the liquid LQ in the first immersion space LS1 will collect in the second guide space A2 and then flow out to the −Y side of the second guide space A2.

In the present embodiment, the third immersion space LS3 of the liquid LQ is formed by the third liquid immersion member 33 such that the third immersion space LS3 is adjacent to the second guide space A2. In the present embodiment, the third liquid immersion member 33 is disposed adjacent to the first liquid immersion member 31 in the Y axial directions in which the object moves in the prescribed operation of the exposure apparatus X. The third immersion space LS3 is disposed such that it is at the −Y side of and adjacent to the second guide space A2.

Accordingly, the liquid LQ that flows out of the second guide space A2 to the outer side of the space SP1 is hindered by the third immersion space L53 from flowing out to the outer side of the space SP3. Namely, the third immersion space LS3 stops the liquid LQ from flowing out of the second guide space A2. For example, the liquid LQ that flows out of the second guide space A2 to the outer side of the space SP1 combines with the liquid LQ of the third immersion space LS3 in the space SP3. In addition, the liquid LQ that flows out of the second guide space A2 to the outer side of the space SP1 is recovered via the recovery port 55 between the first liquid immersion member 31 and the supply port 53.

In the present embodiment, the second immersion space LS2 is smaller than the first immersion space LS1. Consequently, even if the object has moved in the Y axial directions under a condition wherein the prescribed permissible condition under which the first immersion space LS1 of the liquid LQ can be maintained in the space SP1 is not satisfied, the liquid LQ in the second immersion space LS2 is hindered from flowing out of the space SP2.

In addition, in the present embodiment, the third immersion space LS3 is smaller than the first immersion space LS1. Consequently, even if the object has moved in the Y axial directions under a condition wherein the prescribed permissible condition under which the first immersion space LS1 of the liquid LQ can be maintained in the space SP1 is not satisfied, the liquid LQ in the third immersion space LS3 is hindered from flowing out of the space SP3.

In addition, there is a possibility that the liquid. LQ in the first immersion space LS1 will flow out to the outer side of the space SP1 without transiting the first guide space A1 and the second guide space A2. In the present embodiment, the fluid recovery parts 56, 58 of the first and second recovery members 34, 35, respectively, are provided, and therefore the liquid LQ that flows out is recovered by the liquid recovery parts 56, 58.

In the present embodiment, a fluid recovery operation of the fluid recovery parts 56, 58 is performed in at least part of the interval during which the object moves in the state wherein the first immersion space LS1 is formed. In the present embodiment, the fluid recovery operation of the fluid recovery part 56, 58 is performed at least while the substrate P is being exposed through the liquid LQ of the first immersion space LS1. Furthermore, the fluid recovery operation of the fluid recovery parts 56, 58 may be performed during part of the exposure of the substrate P. For example, when the substrate P moves in the X axial directions or when the substrate P moves at a velocity higher than a prescribed velocity, the fluid recovery operation of the fluid recovery parts 56, 58 may be performed; furthermore, when the substrate P moves in the Y axial directions or when the substrate P moves at a velocity lower than a prescribed velocity, the fluid recovery operation of the fluid recovery parts 56, 58 may be stopped. In addition, after the fluid recovery operation of the fluid recovery parts 56, 58 during an exposure of the substrate P has stopped and the exposure of the substrate P has ended, the operation of recovering the residual liquid LQ on the front surface (i.e., the upper surface) of the object (i.e., the substrate P, the substrate stage 2P, and the like) by the fluid recovery parts 56, 58 may be performed.

Furthermore, the fluid recovery parts 56, 58 (i.e., the first and second recovery members 34, 35, respectively) may be omitted.

After the exposure of the substrate P has ended, the substrate stage 2P is moved to the substrate exchange position. At the substrate exchange position, a substrate exchanging process is performed. Subsequently, a plurality of the substrates P is successively exposed by performing the same processes as discussed above.

In the present embodiment, at least part of the liquid immersion member 3 is cleaned with a prescribed timing. For example, cleaning may be performed when maintenance work is performed on the exposure apparatus EX. In addition, cleaning may be performed after maintenance work ends and immediately before the first immersion space LS1 is formed with the liquid LQ for exposure. In addition, cleaning may be performed at prescribed intervals of time.

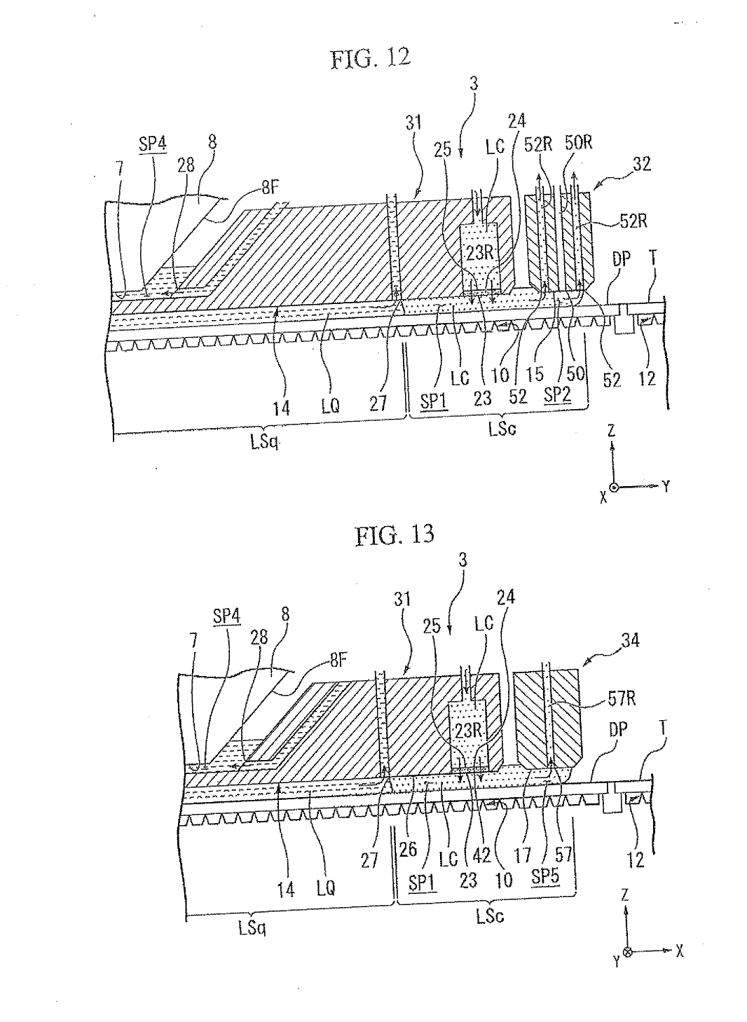

FIG. 12 and FIG. 13 are side cross sectional views that show one example of a state wherein cleaning is performed on at least part of the liquid immersion member 3. FIG. 12 is a side cross sectional view that is parallel to the YZ plane and shows part of the second liquid immersion member 32 and the first liquid immersion member 31, and FIG. 13 is a side cross sectional view that is parallel to the XZ plane and shows part of the first recovery member 34 and the first liquid immersion member 31.

For the sake of simplicity, the explanation below, which references FIG. 12 and FIG. 13, is directed principally to one example of the operation of the first liquid immersion member 31, the second liquid immersion member 32, and the first recovery member 34 during cleaning, but it is understood that the third liquid immersion member 33 operates in the same manner as the second liquid immersion member 32 and that the second recovery member 35 operates in the same manner as the first recovery member 34.

As shown in FIG. 12 and FIG. 13, during cleaning of the liquid immersion member 3 in the present embodiment, a cleaning liquid LC is supplied such that it contacts at least part of the first liquid immersion member 31. In addition, at least some of the cleaning liquid LC is recovered from the first liquid immersion member 31 via an opening belonging to the second liquid immersion member 32. After the cleaning liquid LC has been supplied to and contacts the first liquid immersion member 31, at least some of the cleaning liquid LC is recovered via the opening of the second liquid immersion member 32.

A liquid other than the liquid LQ for exposure (i.e., pure water) may be used as the cleaning liquid LC. An alkaline liquid, for example, may be used as the cleaning liquid LC. For example, the cleaning liquid LC may contain tetramethylammonium hydroxide (TMAH). In addition, a solution of an inorganic alkali, such as sodium hydroxide or potassium hydroxide, a solution of an organic alkaline, such as trimethyl(2-hydroxyethyl) ammonium hydroxide, or the like may be used as the cleaning liquid LC. In addition, an alkaline aqueous solution may be used as the cleaning liquid LC. In addition, aqueous ammonia may be used as the cleaning liquid LC.

In addition, an acidic liquid may be used as the cleaning liquid LC. For example, the cleaning liquid LC may contain hydrogen peroxide. In addition, an acidic aqueous solution may be used as the cleaning liquid LC. In addition, the cleaning liquid LC may be a solution that contains buffered hydrofluoric acid and hydrogen peroxide. Buffered hydrofluoric acid is a mixture of hydrofluoric acid and ammonium fluoride. The mixing ratio may be in the range of 5:1 to 2000:1 as calculated by the volumetric ratio of a 40 wt % solution of ammonium fluoride to 50 wt % of hydrofluoric acid. In addition, the mixing ratio of the buffered hydrofluoric acid to the hydrogen peroxide may be in the range of 0.8:1 to 55:1 as calculated by the weight ratio of the hydrogen peroxide to the hydrofluoric acid. The cleaning liquid LC may even be an ozone liquid that contains ozone. Of course, it may be a solution that contains hydrogen peroxide and ozone.

In addition, the cleaning liquid LC may contain an alcohol. For example, the cleaning liquid LC may contain at least one of the following: ethanol, isopropyl alcohol (IPA), and pentanol.

In the present embodiment, the cleaning liquid LC is supplied to the space SP1, which the lower surface 14 faces, in the state wherein the lower surface 14 of the first liquid immersion member 31 and the object are opposed. In the present embodiment, the object that opposes the lower surface 14 during cleaning includes a dummy substrate DP. The dummy substrate DP is a substrate that has a high degree of cleanliness and, compared with the substrate P for fabricating devices, tends not to emit foreign matter. During denting, the dummy substrate DP is held by the substrate holding part 10. The substrate holding part 10 is capable of holding the dummy substrate DP. In the present embodiment, the external shape of the dummy substrate DP and the external shape of the substrate P are substantially identical. In the present embodiment, the dummy substrate DP may be a semiconductor wafer. The dummy substrate DP may have a configuration obtained by, for example, stripping the photosensitive film from the substrate P.

In addition, in the present embodiment, during cleaning, the dummy substrate DP may be disposed such that it opposes the lower surface 14, the lower surface 15, the lower surface 16, the lower surface 17, and the lower surface 18.

Furthermore, during cleaning, the upper surface 11P of the substrate stage 2P (i.e., the cover member T) may be disposed such that it opposes the liquid immersion member 3 and the lower surfaces 14, 15, 16, 17, 18; the upper surface 11C of the measurement stage 2C may be so disposed; the substrate P may be so disposed; or an object other than the dummy substrate DP, the substrate stage 2P (i.e., the cover member T), the measurement stage 2C, or the substrate P may be so disposed.

In the present embodiment, the cleaning liquid LC is supplied via an opening belonging to the first liquid immersion member 31. In the present embodiment, the cleaning liquid LC is supplied via the opening of the first liquid immersion member 31 that faces the space SP1.

In the present embodiment, the cleaning liquid LC is supplied via the holes of the porous member 24 (i.e., the recovery port 23). Namely, in the present embodiment, the recovery port 23 (i.e., the opening) functions as a supply port that supplies the cleaning liquid LC. In the present embodiment, during cleaning, a cleaning liquid supply apparatus is connected to the recovery passageway 23R of the first liquid immersion member 31. in the explanation below, the recovery passageway 23R, which is fowled inside the first liquid immersion member 31, is called the internal space 23R where appropriate. The internal space 231 is formed inside the first liquid immersion member 31 and functions as a supply passageway wherethrough the cleaning liquid LC supplied to the space SP1 flows.

The cleaning liquid LC delivered from the cleaning liquid supply apparatus is supplied to the internal space 23R. The cleaning liquid LC contacts at least part of the inner surface of the internal space 23R and at least part of the upper surface 25 of the porous member 24. Thereby, the inner surface of the internal space 23R and the upper surface 25 of the porous member 24 are cleaned.

The cleaning liquid LC of the internal space 23R flows through the holes of the porous member 24 toward the space SP1 while contacting the inner surfaces of the holes of the porous member 24. Thereby, the inner surfaces of the holes of the porous member 24 are cleaned. The cleaning liquid LC is supplied to the space SP 1 via the opening 23 at the lower ends of the holes of the porous member 24.

The cleaning liquid LC supplied to the space SP1 contacts at least part of the lower surface 14. Thereby, the lower surface 14 is cleaned. For example, the cleaning liquid LC cleans the lower surface 42 of the porous member 24. At least part of the lower surface 26 is also cleaned by the cleaning liquid LC.

In the present embodiment as shown in FIG. 12, the cleaning liquid LC is supplied to at least part of the second liquid immersion member 32. In the present embodiment, the cleaning liquid LC is supplied such that it contacts at least part of the second liquid immersion member 32. In the present embodiment, at least some of the cleaning liquid LC in the space SP1 flows to the space SP2 between the second liquid immersion member 32 and the object (i.e., the dummy substrate DP). The cleaning liquid LC of the space SP2 contacts the lower surface 15 of the second liquid immersion member 32. Thereby, at least part of the lower surface 15 is cleaned.

In the present embodiment, at least some of the cleaning liquid LC is recovered from the first liquid immersion member 31 via the recovery port 52 of the second liquid immersion member 32. The cleaning liquid LC recovered via the recovery port 52 flows through the recovery passageway 52R. Thereby, the recovery port 52 and the inner surface of the recovery passageway 52R are cleaned.

Furthermore, during cleaning, the cleaning liquid LC may be recovered via the supply port 50 (i.e., the opening) of the second liquid immersion member 32. Namely, the supply port 50 (i.e., the opening) may function as a recovery port that recovers the cleaning liquid LC. The cleaning liquid LC recovered via the opening 50 flows through the supply passageway 50R (i.e., the internal space). Thereby, the opening 50 and the inner surface of the internal space 50R are cleaned.

Furthermore, during cleaning, the cleaning liquid LC may be recovered from the space SP2 via both the opening 52 (i.e., the recovery port) and the opening 50 (i.e., the supply port). The cleaning liquid LC may be recovered from the space SP2 via the opening 52 in the state wherein the operation of recovery via the opening 50 is stopped. The cleaning liquid LC may be recovered from the space SP2 via the opening 50 in the state wherein the operation of recovery via the opening 52 is stopped.

Furthermore, during cleaning, the cleaning liquid LC may be supplied to the space SP2 via the opening 52 (i.e., the recovery port), or the cleaning liquid LC may be supplied via the opening 50 (i.e., the supply port). For example, while the cleaning liquid LC is supplied to the space SP2 via the opening 52, the cleaning liquid LC may be recovered from the space SP2 via the opening 50. While the cleaning liquid LC is being supplied to the space SP2 via the opening 50, the cleaning liquid LC may be recovered from the space S17 via the opening 52.

In addition, the cleaning liquid LC may be supplied also to at least part of the third liquid immersion member 33. In the present embodiment, at least some of the cleaning liquid LC in the space SP1 flows to the space SP3 between the third liquid immersion member 33 and the object (i.e., the dummy substrate DP). The cleaning liquid LC is recovered from the space SP3 via the opening 55 (i.e., the recovery port) or the opening 53 (i.e., the supply port), or both, of the third liquid immersion member 33. Furthermore, the cleaning liquid LC may be supplied to the space SP3 via the opening 55 (i.e., the recovery port) or the opening 53 (i.e., the supply port), or both.

In addition, as shown in FIG. 13, in the present embodiment, the cleaning liquid LC is supplied to at least part of the first recovery member 34. In the present embodiment, the cleaning liquid LC is supplied such that it contacts at least part of the first recovery member 34. In the present embodiment, at least some of the cleaning liquid LC in the space SP1 flows to the space SP5 between the first recovery member 34 and the object (i.e., the dummy substrate DP). The cleaning liquid LC in the space SP5 contacts the lower surface 17 of the first recovery member 34. Thereby, at least some of the lower surface 17 is cleaned.

In the present embodiment, at least some of the cleaning liquid LC is recovered from the first liquid immersion member 31 via the recovery ports 57 of the first recovery member 34. The cleaning liquid LC recovered via the recovery ports 57 flows through the recovery passageways 57R. Thereby, the recovery ports 57 and the inner surfaces of the recovery passageways 57R are cleaned.

Furthermore, during cleaning, the recovery operation via some of the recovery ports 57 (i.e., the openings) of the plurality of recovery ports 57 may be stopped. Furthermore, the cleaning liquid LC may be supplied to the space SP5 via some of the recovery ports 57 (i.e., the openings) of the plurality of recovery ports 57. For example, the supply and the recovery of the cleaning liquid LC via some of the openings 57 may be stopped while the recovery operation via some of the other openings 57 is performed. For example, the cleaning liquid LC may be supplied via some of the openings 57 while the recovery operation via some of the other openings 57 is being performed. Furthermore, the cleaning liquid LC may be supplied via all of the recovery ports 57 of the plurality of recovery ports 57 of the first recovery member 34.

In addition, the cleaning liquid LC may be supplied to at least part of the second recovery member 35. In the present embodiment, at least some of the cleaning liquid LC in the space SP1 flows to the space SP6 between the second recovery member 35 and the object (i.e., the dummy substrate DP). The cleaning liquid LC is recovered from the space SP6 via some or all of the openings 59 (i.e., the recovery ports) of the second recovery member 35. Furthermore, the cleaning liquid LC may be supplied via some or all the openings 59 of the second recovery member 35.

As shown in FIG. 12 and FIG. 13, in the present embodiment, during cleaning, a liquid other than the cleaning liquid LC may be supplied via the supply ports 28. In the present embodiment, during cleaning, the liquid LQ for exposure is supplied via the supply ports 28. Furthermore, the liquid supplied via the supply ports 28 during cleaning does not have to be the liquid LQ for exposure. For example, a liquid that does not largely affect the optical characteristics of the last optical element 8 may be supplied via the supply ports 28. Furthermore, the liquid supplied via the supply ports 28 may be a liquid that is prepared by diluting the cleaning liquid LC with the liquid LQ.

At least some of the liquid LQ supplied to the space SP4 via the supply ports 28 contacts, for example, the emergent surface 7 of the last optical element 8 and part of the side surface 8F. The liquid LQ covers the emergent surface 7 and at least part of the side surface 8F. At least some of the liquid LQ supplied via the supply ports 28 to the space SP4 flows to the space SP1 via the hole 20.

In the present embodiment, at least some of the liquid. LQ supplied via the supply ports 28 is recovered via the supply ports 27 (i.e., the openings). Namely, in the present embodiment, the supply ports 27 (i.e., the openings) function as recovery ports that recover the liquid LQ during cleaning. Furthermore, at least some of the cleaning liquid LC from the opening 23 may be recovered via the openings 27.

As shown in FIG. 12 and FIG. 13, in the present embodiment, the liquid LQ supplied via the supply ports 28 hinders contact between the cleaning liquid LC and the last optical element 8. Thereby, for example, the cleaning liquid LC is hindered from affecting the last optical element 8.

In the present embodiment, the supply of the liquid LQ via the supply ports 28, which face the optical path K of the exposure light EL that emerges from the emergent surface 7 or which face the side surface 8F of the last optical element 8, or both, and the recovery of the liquid LQ via the openings 27, which are disposed at the outer side of the supply ports 28 with respect to the optical path K, forms an immersion space LSq of the liquid LQ such that the emergent surface 7 of the last optical element 8 and at least part of the side surface 8F is covered. In addition, the supply of the cleaning liquid LC via the opening 23, which is disposed at the outer side of the openings 27 with respect to the optical path. K, and the recovery of the cleaning liquid LC via the openings (50, 52, 53, 55, 57, 59), which are disposed at the outer side of the opening 23 with respect to the optical path K, forms an immersion space LSc of the cleaning liquid LC around the immersion space LSq of the liquid LQ.

The supply and the recovery of the cleaning liquid LC are performed for a prescribed time. After the prescribed time has elapsed, the supply and the recovery of the cleaning liquid LC are stopped. Thereby, the cleaning ends.

Alternatively, the cleaning liquid LC can be supplied from via the openings 27, and the liquid LQ can be recovered from via at least a part of openings 23 and the openings (50, 52, 53, 55, 57, 59). Or, the cleaning liquid LC can be supplied from via an opening, which is in place of the openings 27 and/or different from the openings 27 and which is provided between the hole 20 and the openings 23, and the liquid LQ is recovered from via at least a part of the openings 23 and the openings (50, 52, 53, 55, 57, 59).

Furthermore, the cleaning process using the cleaning liquid LC can be executed without supplying the liquid LQ from the supply port 28.

Furthermore, a process (i.e., a so-called rinsing process) may be performed wherein, after cleaning with the cleaning liquid LC, any of the cleaning liquid LC adhering to the liquid immersion member 3 is rinsed with the liquid LQ for exposure. For example, the liquid LQ may be supplied via the supply ports 28 and recovered via the openings 27, the opening 23, and at least some of the openings (50, 52, 53, 55, 57, 59). Furthermore, the liquid LQ may be supplied via the supply ports 28 and the openings 27 and recovered via the opening 23 and at least some of the openings (50, 52, 53, 55, 57, 59).

According to the present embodiment as explained above, it is possible to satisfactorily clean the liquid immersion member 3 inside the exposure apparatus EX using the cleaning liquid LC. Accordingly, it is possible to prevent the occurrence of exposure failures caused by the contamination of the liquid immersion member 3 and thereby to prevent the production of defective devices.

In the present embodiment, because the guide part 40 is provided to the liquid immersion member 3, the liquid LQ in the first immersion space LS1 can be guided to the first guide space A1. Accordingly, even if, for example, the liquid LQ adversely flows out of the first immersion space LS1, it is possible to limit the position of that outflow (i.e., that portion) to the first guide space A1. In addition, because a configuration is adopted wherein the second liquid immersion member 32 forms the second immersion space LS2 adjacent to the first guide space A1, the liquid LQ that flows out of the first guide space A1 is hindered by the second immersion space LS2 from flowing out to the outer side of the space SP2. Likewise, the liquid LQ that flows out of the second guide space A2 is hindered by the third liquid immersion member 33 from flowing out to the outer side of the space SP3. Accordingly, exposure failures are prevented from occurring and defective devices are prevented from being produced.

For example, if the liquid LQ and the gas are recovered together via the recovery port 52 of the second liquid immersion member 32, there is a possibility that heat of vaporization will attend that recovery. Disposing the first liquid immersion member 31 and the second liquid immersion member 32 spaced apart from one another hinders the temperature of the first liquid immersion member 31 from changing even if the temperature of the second liquid immersion member 32 changes attendant with the heat of vaporization produced in the second liquid immersion member 32. Likewise, disposing the first liquid immersion member 31 and the third liquid immersion member 33 spaced apart from one another hinders the temperature of the first liquid immersion member 31 from changing even if the temperature of the third liquid immersion member 33 changes. Furthermore, to hinder a change in the temperature of the second liquid immersion member 32 owing to heat of vaporization and the like, a temperature adjusting apparatus that adjusts the temperature of the second liquid immersion member 32 may be provided. For example, a temperature adjusting apparatus such as a Peltier device may be disposed in the second liquid immersion member 32. Likewise, a temperature adjusting apparatus that adjusts the temperature of the third liquid immersion member 33 may be provided.

Furthermore, the first liquid immersion member 31 and the second liquid immersion member 32 may be integrated. Furthermore, a temperature adjusting apparatus that adjusts the temperature of the integrated first liquid immersion member 31 and second liquid immersion member 32 may be provided. Likewise, the first liquid immersion member 31 and the third liquid immersion member 33 may be integrated, and a temperature adjusting apparatus that adjusts the temperature of the integrated first liquid immersion member 31 and third liquid immersion member 33 may be provided. In other words, the first immersion member 31, the second immersion member 32, and the third immersion member 33 can be connected with each other.

Furthermore, in the present embodiment, the guide part 40 includes the edge 41, the lower surface 42, and the boundary 43; however, the guide part 40 may comprise the edge 41 alone, the lower surface 42 alone, the boundary 43 alone, the edge 41 and the lower surface 42, the edge 41 and the boundary 43, or the lower surface 42 and the boundary 43.

Furthermore, in the present embodiment, the second immersion space LS2 is formed at the +Y side of the first immersion space LS1; of course, the second immersion space LS2 may be formed at a position other than the +Y side. For example, if the first guide space A1 is provided at the +X side with, respect to the optical path K, then the second immersion space LS2 may be formed at the +X side of the first immersion space LS1. Likewise, in the present embodiment, the third immersion space LS3 is formed at the −Y side of the first immersion space LS1, but may be formed at a position other than the −Y side, for example, at the −X side.

Furthermore, in the present embodiment, the guide part 40 is provided; however, the guide part 40 can be omitted. If, for example, in a prescribed operation of the exposure apparatus EX the object is moved in a first direction under a condition wherein the prescribed permissible condition under which the first immersion space LS1 can be maintained is not satisfied, then, instead of providing the guide part 40, the second liquid immersion member 32 that forms the second immersion space LS2 may be disposed at a position adjacent to the first liquid immersion member 31 in the first direction in which the object moves. For example, if the liquid LQ in the first immersion space LS1 tends to collect in a known space owing to a prescribed operation (e.g., the object movement condition) of the exposure apparatus EX, then the second immersion space LS2 may be formed at a position adjacent to that space.

Furthermore, in the present embodiment, the liquid recovery part 21 includes the porous member 24, but the porous member 24 may be omitted. For example, the liquid LQ may be recovered from the space SP1 via, for example, the opening 22, wherein the porous member 24 is not disposed.

Furthermore, in the present embodiment, a porous member may be disposed in the recovery port 52. A porous member may be disposed in the recovery port 55.

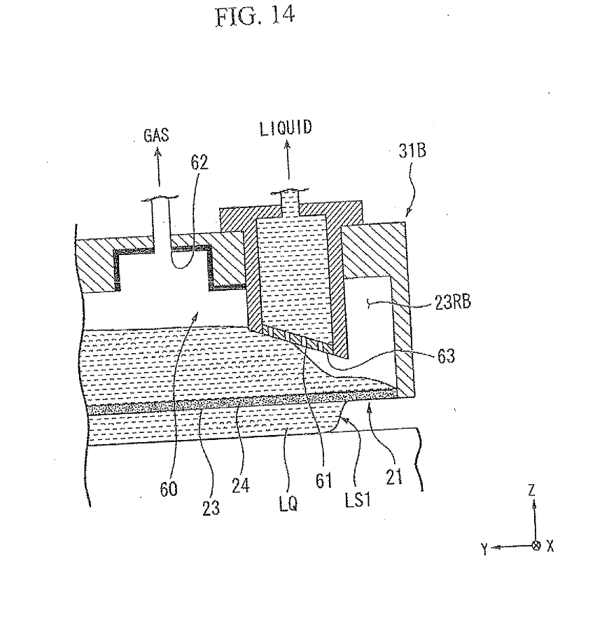

Furthermore, in the present embodiment, as shown in, for example, FIG. 14, a first liquid immersion member 31B may comprise a discharge part 60, which separately discharges the liquid LQ and the gas from a recovery passageway 23RB. For example, if the liquid recovery part 21 recovers the liquid LQ and the gas together, then the liquid LQ and the gas flow from the space SP1 into the recovery passageway 23RB. The discharge part 60 separately discharges the liquid LQ and the gas from the recovery passageway 23RB.

In FIG. 14, the discharge part 60 has first discharge ports 61, which face the recovery passageway 23RB and are for discharging the liquid LQ from the recovery passageway 23RB, and a second discharge part 62, which faces the recovery passageway 23RB and is for discharging the gas from the recovery passageway 23RB. The first discharge ports 61 and the second discharge port 62 each face downward. The first discharge ports 61 are disposed at the outer side of the second discharge port 62 in the radial directions with respect to the optical path K. The first discharge ports 61 are disposed below the second discharge port 62. The first discharge ports 61 hinder the inflow of the gas more than the second discharge port 62 does. The second discharge port 62 hinders the inflow of the liquid LQ more than the first discharge ports 61 do. Namely, the percentage of the liquid LQ in the fluid discharged via the first discharge ports 61 is greater than the percentage of the liquid LQ in the fluid discharged via the second discharge port 62. The first discharge-ports 61 discharge substantially only the liquid LQ from the recovery passageway 23RB. The second discharge port 62 discharges substantially only the gas from the recovery passageway 23RB. In the example shown in FIG. 14, the first liquid immersion member 31B comprises a porous member 63, which has the first discharge ports 61. The porous member 63 has a plurality of holes capable of discharging the liquid LQ. The holes of the porous member 63 function as the first discharge ports 61. By adjusting the difference between the pressure at the lower surface side of the first discharge ports 61 and the pressure on the upper surface side of the first discharge ports 61, substantially only the liquid LQ is discharged via the first discharge ports 61.

Furthermore, in the present embodiment, at least part of the guide part 40 may be curved.

Furthermore, if the lower surface 14 of the first liquid immersion member 31 includes a first area which is disposed such that the object opposes it, and a second area, which is disposed such that the object opposes it and wherein the contact angle of the liquid LQ with respect to the second area 82 is smaller than the contact angle of the liquid LQ with respect to the first area, then the guide part 40 may comprise the second area, or may comprise the boundary between the first area and the second area.

Furthermore, if the lower surface 14 of the first liquid immersion member 31 includes a first area, which is disposed such that the object opposes it, and a second area, which is disposed such that the object opposes it and whose height is different from that of the first area, and, for example, if the lower surface 14 has a recessed part (i.e., a groove), the second area is defined as the inner surface of the recessed part, and the first area is defined as the area extending around the recessed part, then the guide part 40 may comprise the boundary between the first area and the second area. Furthermore, if a protruding part is provided to the lower surface 14, the second area is defined as the surface of the protruding part opposing the object, and the first area 84 is defined as the area extending around the protruding part, then the guide part 40 may comprise the boundary between the first area and the second area.

### Second Embodiment

A second embodiment will now be explained. In the explanation below, constituent parts that are identical or equivalent to those in the embodiment discussed above are assigned identical symbols, and the explanations thereof are therefore abbreviated or omitted.

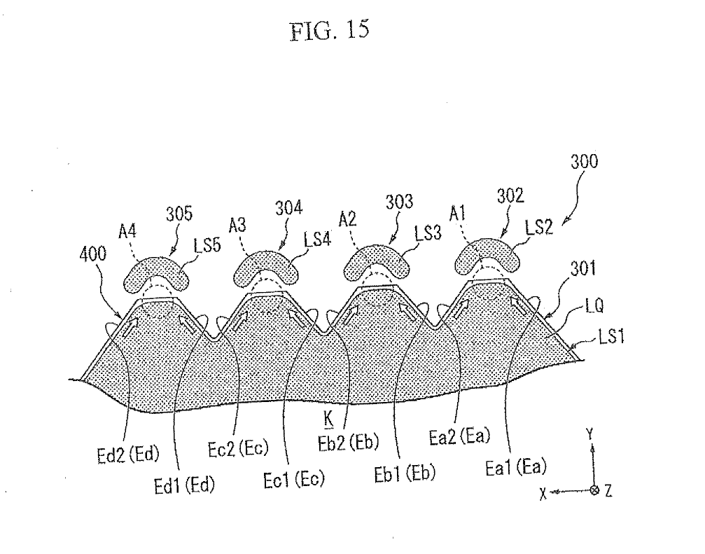

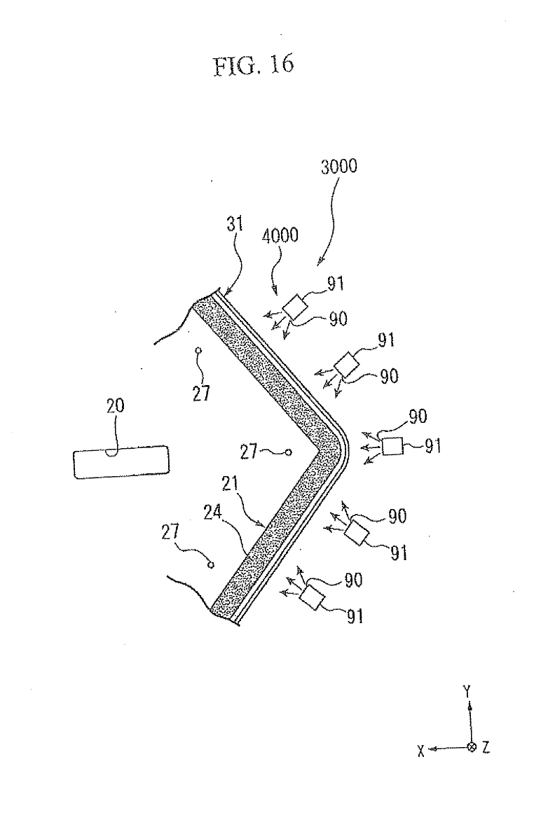

FIG. 15 shows one example of a liquid immersion member 300 according to the present embodiment. Here, FIG. 15 schematically shows a liquid immersion member. For example, the liquid recovery part 21 and the lower surface 26 (the flat part 268) are not shown in FIG. 15.

In FIG. 15, the liquid immersion member 300 comprises: a first liquid immersion member 301, which forms the first immersion space LS1; a guide part 400, which guides at least some of the liquid LQ in the first immersion space LS1 to the first guide space A1, which extends partly around the optical path K; a second liquid immersion member 302, which is disposed at the outer side of the first liquid immersion member 301 with respect to the optical path K, that forms the second immersion space LS2 of the liquid LQ partly around the first immersion space LS1 and adjacent to the first guide space A1; and a third liquid immersion member 303, which is disposed at the outer side of the first liquid immersion member 301 with respect to the optical path K, that forms the third immersion space LS3 of the liquid LQ, which is different from the second immersion space LS2, partly around the first immersion space LS1 and adjacent to the second guide space A2. In the present embodiment, the third immersion space LS3 is formed at the same side as the second immersion space LS2 with respect to the optical path K. The guide part 400 guides at least some of the liquid LQ in the first immersion space LS1 to the second guide space A2.

In addition, in the present embodiment, the liquid immersion member 300 comprises: a fourth liquid immersion member 304, which is disposed at the outer side of the first liquid immersion member 301 with, respect to the optical path K, that forms a fourth immersion space LS4 of the liquid LQ partly around the first immersion space LS1 and adjacent to a third guide space A3; and a fifth liquid immersion member 305, which is disposed at the outer side of the first liquid immersion member 301 with respect to the optical path K, that forms a fifth immersion space LS5 of the liquid LQ partly around the first immersion space LS1 and adjacent to a fourth guide space A4. In the present embodiment, the third immersion space LS3, the fourth immersion space LS4, and the fifth immersion space LS5 are formed at the same side as the second immersion space LS2 with respect to the optical path K. The guide part 400 guides at least some of the liquid LQ of the first immersion space LS1 to the third guide space A3 and the fourth guide space A4.

The guide part 400 includes: a portion Ea1 and a portion Ea2 of an edge Ea, which extend toward the first guide space A1; a portion Eb1 and a portion Eb2 of an edge Eb, which extend toward the second guide space A2; a portion Ec1 and a portion Ec2 of an edge Ec, which extend toward the third guide space A3; and a portion Ed1 and a portion Ed2 of an edge Ed, which extend toward the fourth guide space A4.

In the present embodiment, for example, at least part of the liquid immersion member 300 may be cleaned by supplying the cleaning liquid LC via an opening of the first liquid immersion member 301 and recovering the cleaning liquid LC from the first liquid immersion member 301 via the openings of the second through fifth liquid immersion members 302-305.

### Third Embodiment

A third embodiment will now be explained. In the explanation below, constituent parts that are identical or equivalent to those in the embodiments discussed above are assigned identical symbols, and the explanations thereof are therefore abbreviated or omitted.

FIG. 16 is a view that shows one example of a liquid immersion member 3000 according to the third embodiment. The present embodiment explains an exemplary case wherein a guide part 4000 includes gas supply ports 90, which, supply the gas from the outer side of the first immersion space LS1 toward the first immersion space LS1.

As shown in FIG. 16, the liquid immersion member 3000 comprises gas supply members 91, each of which has one of the gas supply ports 90 that supply the gas from the outer side of the first immersion space LS1 toward the first immersion space LS1. In the present embodiment, the gas supply ports 90 function as the guide part 4000. In the example shown in FIG. 16, the plurality of the gas supply ports 90 gas supply members 91) is disposed at the outer side of the first liquid immersion member 31. The gas supply ports 90 are capable of supplying the gas from the outer side of the space SP1 toward the space SP1. The gas supply ports 90 are disposed such that they face the space SP1. The gas supply ports 90 are capable of supplying the gas to the interface LG1 of the liquid LQ in the first immersion space LS1.

The force of the gas supplied via the gas supply ports 90 to the first immersion space LS1 hinders the outflow of the liquid LQ from the first immersion space LS1 to the outer side of the space SP1. In addition, the gas supplied via the gas supply ports 90 causes at least some of the liquid LQ in the first immersion space LS1 to flow and to be guided to the first guide space A1. In addition, the gas supplied via the gas supply ports 90 causes at least some of the liquid LQ in the first immersion space LS1 to flow and to be guided to the second guide space A1.

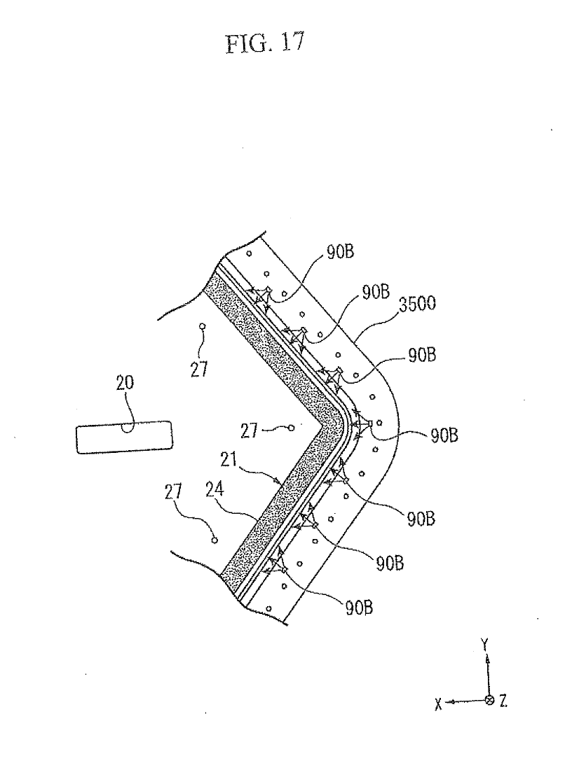

Furthermore, as shown in FIG. 17, gas supply ports 90B may be disposed in at least part of a second recovery member 3500. In addition, the gas supply ports 90B may be disposed in at least part of the first recovery member.

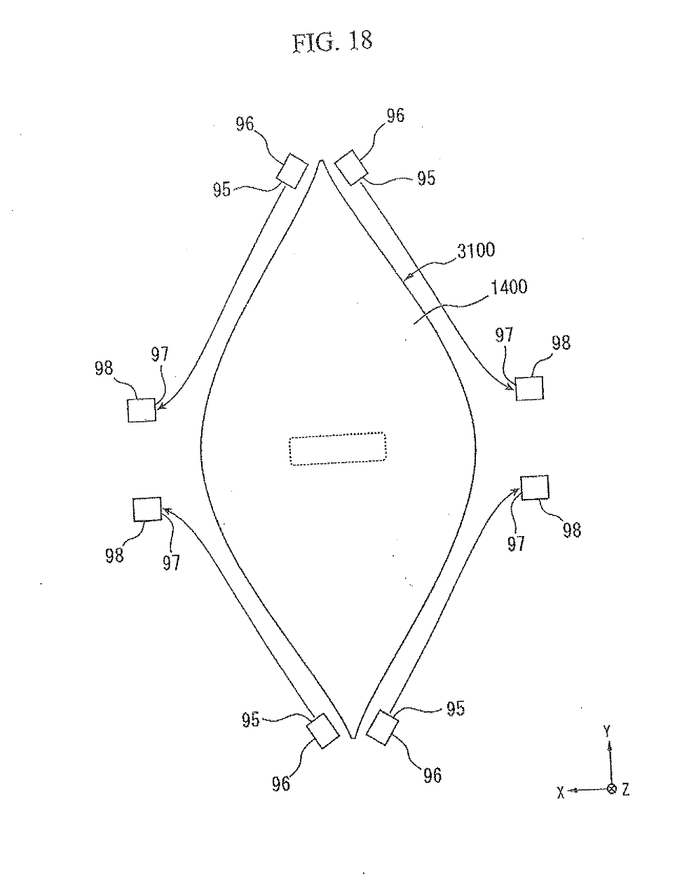

Furthermore, a lower surface 1400 of a first liquid immersion member 3100 may have a shape as shown in FIG. 18. In addition, as shown in FIG. 18, gas supply members 96, each of which has a gas supply port 95 that is capable of generating a gas current around the space SP1 (i.e., the first immersion space LS1), and suction members 98, each of which has a suction port 97 that sucks at least some of the gas from the corresponding gas supply port 95, may be disposed. Generating gas currents around the space SP1 hinders the outflow of the liquid LQ from the first immersion space LS1 to the outer side of the space SP1. Here, FIG. 18 schematically shows a liquid immersion member. For example, the liquid recovery part 21 and the lower surface 26 (the flat part 26S) are not shown in FIG. 18.

By supplying the cleaning liquid LC such that it contacts at least part of each of the liquid immersion members shown in FIG. 16 through FIG. 18, those liquid immersion members can be cleaned.

### Fourth Embodiment

A fourth embodiment will now be explained. In the explanation below, constituent parts that are identical or equivalent to those in the embodiments discussed above are assigned identical symbols, and the explanations thereof are therefore abbreviated or omitted.

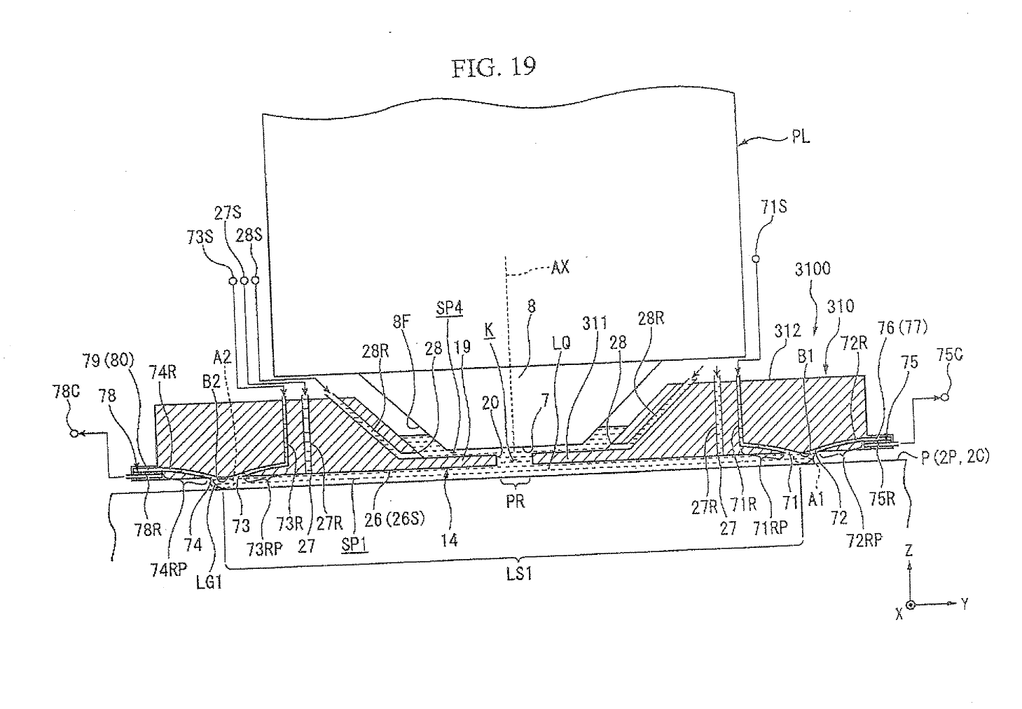

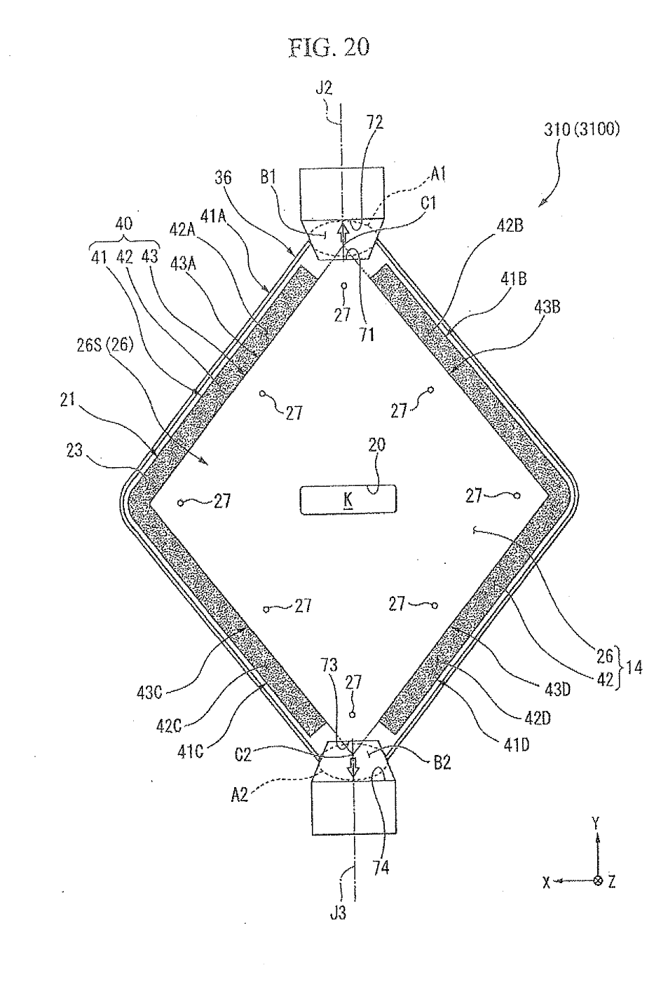

FIG. 19 is a side cross sectional view that is parallel to the XZ plane and shows one example of a liquid immersion member 3100 according to the fourth embodiment, FIG. 20 is a diagram of the liquid immersion member 3100, viewed from the lower side (i.e., the −Z side), and FIG. 21 is a partial enlarged view of FIG. 19.

In the fourth embodiment, the liquid immersion member 3100 comprises a first liquid immersion member 310, which is for forming the first immersion space LS1.

In the present embodiment, the first liquid immersion member 310 has: a first opening 72, which is disposed such that it faces the first guide space A1 in the direction of the optical path K and into which the liquid LQ is capable of flowing from the first guide space A1; and a first supply port 71, which supplies the liquid LQ such that the liquid LQ flows toward the first opening 72.

In addition, in the present embodiment, the first liquid immersion member 310 has: a second opening 74, which is disposed such that it faces the second guide space A2 in the direction of the optical path K and into which the liquid LQ is capable of flowing from the second guide space A2; and a second supply port 71, which supplies the liquid LQ such, that the liquid LQ flows toward the second opening 74.

In the same manner as the first through third embodiments discussed above, the first liquid immersion member 310 comprises the guide part 40, which guides at least some of the liquid LQ in the first immersion space LS1 to the first guide space A1 or the second guide space A2, or both. The guide part 40 includes the edge 41, the lower surface 42, and at least part of the boundary 43.

The portions 41A, 42A, 43A are disposed such that they extend from the +X side of the axis J2 toward the first guide space A1. The portions 41B, 42B, 4313 are disposed such that they extend from the −X side of the axis J2 toward the first guide space A1.

The portions 41C, 42C, 43C are disposed such that they extend from the +X side of the axis J3 toward the second guide space A2. The portions 41D, 42D, 43D are disposed such that they extend from the −X side of the axis J3 toward the second guide space A2.

In the present embodiment, the axis J2 includes, for example, a virtual axis (i.e., a virtual line) that passes through the first supply port 71 and the first opening 72. The axis J3 includes a virtual axis (i.e., a virtual line) that passes through the second supply port 73 and the second opening 74.

As shown in FIG. 20, in the present embodiment, the first portion B1 (i.e., the first guide space A1) includes an intersection point C1 between a virtual line (i.e., an extension line) that extends beyond a tip of the portion 43A and a virtual line (i.e., an extension line) that extends beyond a tip of the portion 43B. In other words, the position of the first portion 81 (i.e., the first guide space A1) is set such that it includes the intersection point C1. In the present embodiment, the intersection point C1 is disposed between the fast supply port 71 and the first opening 72.

Furthermore, the first portion B1 (i.e., the first guide space A1) may include an intersection point between a virtual line (i.e., an extension line) that extends beyond a tip of the portion 42A and a virtual line (i.e., an extension line) that extends beyond a tip of the portion 42B. Furthermore, the first portion B1 (i.e., the first guide space A1) may include an intersection point between a virtual line (i.e., an extension line) that extends beyond a tip of the portion 41A and a virtual line (i.e., an extension line) that extends beyond a tip of the portion 41B.

In the present embodiment, the second portion B2 (i.e., the second guide space A2) includes an intersection point C2 between a virtual line (i.e., an extension line) that extends beyond a tip of the portion 43C and a virtual line (i.e., an extension line) that extends beyond a tip of the portion 43D. In other words, the position of the second portion B2 (i.e., the second guide space A2) is set such that it includes the intersection point C2. In the present embodiment, the intersection point C2 is disposed between the second supply port 73 and the second opening 74.

Furthermore, the second portion B2 (i.e., the second guide space A2) may include an intersection point between a virtual line (i.e., an extension line) that extends beyond a tip of the portion 42C and a virtual line (i.e., an extension line) that extends beyond a tip of the portion 42D. Furthermore, the second portion B2 (i.e., the second guide space A2) may include an intersection point between a virtual line (i.e., an extension line) that extends beyond a tip of the portion 41C and a virtual line (i.e., an extension line) that extends beyond a tip of the portion 41D.

The first supply port 71 is disposed in the liquid immersion member 310 such that it faces the first guide space A1. The first supply port 71 is disposed such that it faces the outer side in the radial directions with respect to the optical path K. In the present embodiment, the first supply port 71 is disposed at the +Y side of the optical path K. The first supply port 71 faces the +Y side.

The first opening 72 is disposed in the liquid immersion member 310 such that it faces the first guide space A1. The first opening 72 is disposed such that it faces inward in the radial directions with respect to the optical path K. In the present embodiment, the first opening 72 is disposed at the +Y side of the optical path K. The first opening 72 faces the −Y side.

In the present embodiment, the first supply port 71 is disposed between the optical path K and the first opening 72. The first opening 72 is disposed such that it opposes the first supply port 71. The axis J2 passes through the optical path. K, the first supply port 71, and the first opening 72. The first supply port 71 and the first opening 72 are disposed in the Y axial directions.

In the present embodiment, the size of the first supply port 71 in the X axial directions is smaller than that of the first opening 72. Furthermore, the size of the first supply port 71 in the X axial directions may be larger than or equal to that of the first opening 72.

The first supply port 71 supplies the liquid LQ such that the liquid LQ flows toward the first opening 72. In the present embodiment, the first supply port 71 supplies the liquid LQ such that it is directed toward the first opening 72. In addition, in the present embodiment, the first supply port 71 supplies the liquid LQ such that it is directed toward the first guide space A1 (i.e., the first portion B1). In the present embodiment, at least some of the liquid LQ supplied via the first supply port 71 flows toward the first opening 72 along part of the area (in the present embodiment, the first portion B1) of the lower surface 14 between the first supply port 71 and the first opening 72. For example, at least some of the liquid LQ supplied via the first supply port 71 may flow toward the first opening 72 while contacting part of the area (in the present embodiment, the first portion B1) of the lower surface 14 between the first supply port 71 and the first opening 72.

The liquid immersion member 310 has a supply passageway 71R, one end of which has the first supply port 71. The supply passageway 71R is formed inside the liquid immersion member 310. A portion 71RP, which has the first supply port 71 at the lower end of the supply passageway 71R, is tilted downward in the direction that leads away from the optical path K.

An other end of the supply passageway 71R is connected to a liquid supply apparatus 71S, which is capable of supplying the liquid LQ. The liquid supply apparatus 71S is capable of supplying the liquid LQ, which is clean and temperature adjusted. The liquid supply apparatus 71S is controlled by the control apparatus 4. The first supply port 71 supplies the liquid LQ from the liquid supply apparatus 71S to the space SP1.

In the present embodiment, the liquid LQ is supplied via the first supply port 71 in the state wherein the immersion space LS1 is formed. In the present embodiment, the liquid LQ is supplied via the first supply port 71 in the state wherein the first supply port 71 is disposed in the immersion space LS1. In other words, the first supply port 71 supplies the liquid LQ to the space SP1 (i.e., the immersion space LS1) in the state wherein the first supply port 71 is immersed in the liquid LQ of the immersion space LS1.

The first opening 72 is disposed at a position at which the liquid LQ is capable of flowing in from the first guide space A1. At least some of the liquid LQ supplied via the supply ports 28 and guided to the first guide space A1 can flow into the first opening 72. At least some of the liquid LQ supplied via the supply ports 27 and guided to the first guide space A1 can flow into the first opening 72. At least some of the liquid LQ supplied via the first supply port 71 and supplied to the first guide space A1 can flow into the first opening 72.

The liquid immersion member 310 has a recovery passageway 72R, one end of which has the first opening 72. The recovery passageway 72R is formed inside the liquid immersion member 310. A portion 72RP, which has the first opening 72 at the lower end of the recovery passageway 72R, is tilted upward in a direction that leads away from the optical path K. The liquid LQ that flows into the first opening 72 flows through the recovery passageway 72R.

The liquid immersion member 310 comprises a liquid recovery part 75, which recovers the liquid LQ that flows in from the first opening 72. The liquid recovery part 75 is formed inside the liquid immersion member 310. The liquid recovery part 75 includes a porous member 76, which is disposed at a position at which the liquid LQ that flows in from the first opening 72 and flows through the recovery passageway 72R can contact the porous member 76. The porous member 76 is a plate shaped member that has an upper surface, a lower surface that faces the opposite direction to that faced by the upper surface, and a plurality of holes that connects the upper surface and the lower surface. The porous member 76 is disposed such that its upper surface faces the recovery passageway 72R and its lower surface faces an internal space 75R (i.e., a recovery passageway) formed inside the liquid immersion member 310. In the present embodiment, the liquid recovery part 75 includes an upper surface of the porous member 76, which the liquid LQ in the recovery passageway 72R can contact.

At least some of the liquid LQ in the recovery passageway 72R is recovered via the holes of the porous member 76. In the present embodiment, the holes of the porous member 76 function as a recovery port 77, which is capable of recovering the liquid LQ from the recovery passageway 72R. The recovery port 77 is connected to a liquid recovery apparatus 75C, which is capable of recovering (i.e., by suction) the liquid LQ, via the recovery passageway 75R. The liquid recovery apparatus 75C comprises, for example, a vacuum system and is capable of recovering (i.e., by suction) the liquid LQ. The liquid recovery apparatus 75C is controlled by the control apparatus 4.

The pressure of the recovery passageway 75K and the pressure of the recovery passageway 72K decrease by the operation of the liquid recovery apparatus 75C. The liquid LQ supplied via the supply ports 28, the liquid LQ supplied via the supply ports 27, and at least some of the liquid LQ supplied via the first supply port 71 flow into the first opening 72. At least some of the liquid LQ that flows into the first opening 72 and through the recovery passageway 72R flows into the recovery passageway 75R via the holes the recovery port 77) of the porous member 76 and is recovered by the liquid recovery apparatus 75C.

Furthermore, in the present embodiment, substantially only the liquid LQ may be recovered via the porous member 76. Namely, the difference between the pressure at the upper surface side of the porous member 76 (i.e., the pressure in the recovery passageway 72K) and the pressure at the lower surface side of the porous member 76 (i.e., the pressure in the recovery passageway 75R) may be adjusted such that the liquid LQ the recovery passageway 72K passes through the holes of the porous member 76 and flows into the recovery passageway 75R, while the gas does not. Furthermore, the liquid LQ and the gas may be recovered via the porous member 76.

Furthermore, the porous member 76 may be omitted.

The second supply port 73 is disposed in the liquid immersion member 310 such that it faces the second guide space A2. The second supply port 73 is disposed such that it faces outward in the radial directions with respect to the optical path K. In the present embodiment, the second supply port 73 is disposed at the side of the optical path K. The second supply port 73 faces the −Y side.

The second opening 74 is disposed in the liquid immersion member 310 such that it faces the second guide space A2. The second opening 74 is disposed such that it faces inward in the radial directions with respect to the optical path K. In the present embodiment, the second opening 74 is disposed at the −Y side of the optical path K. The second opening 74 faces the +Y side.

In the present embodiment, the second supply port 73 is disposed between the optical path K and the second opening 74. The second opening 74 is disposed such that it opposes the second supply port 73. The axis J3 passes through the optical path K, the second supply port 73, and the second opening 74. The second supply port 73 and the second opening 74 are disposed in the Y axial directions.

In the present embodiment, the size of the second supply port 73 in the X axial directions is smaller than that of the second opening 74. Furthermore, the size of the second supply port 73 in the X axial directions is larger than or equal to that of the second opening 74.

The second supply port 73 and the second opening 74 supply the liquid LQ such that the liquid LQ flows toward the second opening 74. In the present embodiment, the second supply port 73 supplies the liquid LQ such that it is directed toward the second opening 74. In addition, in the present embodiment, the second supply port 73 supplies the liquid LQ such that it is directed toward the second guide space A2 (i.e., the second portion B2). In the present embodiment, at least some of the liquid LQ supplied via the second supply port 73 flows toward the second opening 74 along part of the area (in the present embodiment, the second portion B2) of the lower surface 14 between the second supply port 73 and the second opening 74. For example, at least some of the liquid LQ supplied via the second supply port 73 flows toward the second opening 74 while contacting part of the area (in the present embodiment, the second portion B2) of the lower surface 14 between the second supply port 73 and the second opening 74.

The liquid immersion member 310 has a supply passageway 73R, one end of which has the second supply port 73. The supply passageway 73R is formed inside the liquid immersion member 310. A portion 73RD, which has the second supply port 73 at the lower end of the supply passageway 73R, is tilted downward in the direction leading away from the optical path K.

An other end of the supply passageway 73R is connected to a liquid supply apparatus 73S, which is capable of supplying the liquid LQ. The liquid supply apparatus 73S is capable of supplying the liquid LQ, which is clean and temperature adjusted. The liquid supply apparatus 73S is controlled by the control apparatus 4. The second supply port 73 supplies the liquid LQ from the liquid supply apparatus 73S to the space SP1.

In the present embodiment, the liquid LQ is supplied via the second supply port 73 in the state wherein the immersion space LS1 is formed. In the present embodiment, the liquid LQ is supplied via the second supply port 73 in the state wherein the second supply port 73 is disposed in the immersion space LS1. In other words, the second supply port 73 supplies the liquid LQ to the space SP1 (i.e., the immersion space L1) in the state wherein the second supply port 73 is immersed in the liquid LQ of the immersion space LS1.

The second opening 74 is disposed at a position at which the liquid LQ can flow in from the second guide space A2. At least some of the liquid LQ that is supplied via the supply ports 28 and guided to the second guide space A2 is capable of flowing into the second opening 74. At least some of the liquid LQ that is supplied via the supply ports 27 and guided to the second guide space A2 is capable of flowing into the second opening 74. At least some of the liquid LQ that is supplied via the second supply port 73 to the second guide space A2 can flow into the second opening 74.

The liquid immersion member 310 has a recovery passageway 74R, one end of which has the second opening 74. The recovery passageway 74R is formed inside the liquid immersion member 310. A portion 74RP, which has the second opening 74 at the lower end of the recovery passageway 74R, is tilted upward in the direction leading away from the optical path K. The liquid LQ that flows into the second opening 74 flows through the recovery passageway 74R.

The liquid immersion member 310 comprises a liquid recovery part 78, which recovers the liquid LQ that flows in from the second opening 74. The liquid recovery part 78 is formed inside the liquid immersion member 310. The liquid recovery part 78 comprises a porous member 79, which is disposed at a position at which the liquid LQ that flows in from the second opening 74 and through the recovery passageway 74R can contact the porous member 79. At least some of the liquid LQ in the recovery passageway 74R is recovered via the holes of the porous member 79. The holes of the porous member 79 function as a recovery port 80, which is capable of recovering the liquid LQ from the recovery passageway 74R. The recovery port 80 is connected to a liquid recovery apparatus 78C, which is capable of recovering (i.e., by suction) the liquid LQ via a recovery passageway 78R. The liquid recovery apparatus 78C is controlled by the control apparatus 4. The liquid recovery part 78 is configured identically to the liquid recovery part 75. The explanation, of the liquid recovery part 78 is omitted.

A method of using the exposure apparatus EX that has the configuration discussed above to expose the substrate P will now be explained.

To load the unexposed substrate P onto the substrate holding part 10, the control apparatus 4 performs the substrate P exchanging process by moving the substrate stage 2P to a substrate exchange position. In addition, the control apparatus 4 forms, using the liquid immersion member 310, at the emergent surface 7 side of the last optical element 8, the first immersion space LS1 of the liquid LQ in the state wherein the last optical element 8 and the first liquid immersion member 310 on one side and the measurement stage 2C on the other side are opposed to one another. The control apparatus 4 performs the recovery of the liquid LQ via the recovery port 23 in parallel with the supply of the liquid LQ via the supply ports 28. Thereby, the first immersion space LS1 is formed. In addition, the control apparatus 4 performs the supply of the liquid LQ via the supply ports 27 in parallel with the supply of the liquid LQ via the supply ports 28 and the recovery of the liquid LQ via the recovery port 23.

Furthermore, in the state wherein the immersion space LS1 is formed by the supply of the liquid LQ via the supply ports 28 and the recovery of the liquid LQ via the recovery port 23, the supply of the liquid LQ via the supply ports 27 may be stopped. Furthermore, the supply ports 27 may be omitted.

In the present embodiment, the size (i.e., the dimensions within the XY plane) of the first immersion space LS1 is adjusted such that the first and second supply ports 71, 73 are disposed in the first immersion space LS1. Namely, the supply of the liquid LQ via the supply ports 28 (and the supply ports 27) and the recovery of the liquid LQ via the recovery port 23 may be performed such that the supply ports 71, 73 are disposed in the first immersion space LS1. For example, in the state wherein the object is substantially stationary and the supply of the liquid LQ via the first and second supply ports 71, 73 is stopped, the supply of the liquid LQ via the supply ports 28 (and the supply ports 27) and the recovery of the liquid LQ via the recovery port 23 may be performed such that the first and second supply ports 71, 73 are disposed in the first immersion space LS1.

Furthermore, for example, in the state wherein the object is substantially stationary and the supply of the liquid LQ via the first and second supply ports 71, 73 is stopped, the supply of the liquid LQ via the supply ports 28 (and the supply ports 27) and the recovery of the liquid LQ via the recovery port 23 may be performed such that the first and second supply ports 71, 73 and the first and second openings 72, 74 are disposed in the first immersion space LS1.

Furthermore, for example, in the state wherein the object is substantially stationary and the supply of the liquid LQ via the first and second supply ports 71, 73 is stopped, the supply of the liquid. LQ via the supply ports 28 (and the supply ports 27) and the recovery of the liquid LQ via the recovery port 23 may be performed such that the first and second supply ports 71, 73 and the first and second openings 72, 74 are not disposed in the first immersion space LS1.

Furthermore, the state wherein the first and second supply ports 71, 73 are disposed in the first immersion space LS1 includes the state wherein the interface LG1 is disposed at the outer side of the first and second supply ports 71, 73 in the radial directions with respect to the optical path K. In addition, the state wherein the first and second supply ports 71, 73 are disposed in the first immersion space LS1 includes the state wherein the first and second supply ports 71, 73 are immersed in the liquid LQ of the first immersion space LS1. Likewise, the state wherein the first and second openings 72, 74 are disposed in the first immersion space LS1 includes the state wherein the interface LG1 is disposed at the outer side of the first and second openings 72, 74 in the radial directions with respect to the optical path K.

Furthermore, the state wherein the first and second supply ports 71, 73 are not disposed in the first immersion space LS1 includes the state wherein the interface LG1 is disposed at the inner side of the first and second supply ports 71, 73 in the radial directions with respect to the optical path K. In addition, the state wherein the first and second supply ports 71, 73 are not disposed in the first immersion space LS1 includes the state wherein the first and second supply ports 71, 73 are not immersed (i.e., not in contact with) the liquid LQ of the first immersion space LS1. Likewise, the state wherein the first and second openings 72, 74 are not disposed in the first immersion space LS1 includes the state wherein the interface LG1 is disposed at the inner side of the first and second openings 72, 74 in the radial directions with respect to the optical path K.

After the supply of the liquid LQ via the supply ports 28 (and the supply ports 27) and the recovery of the liquid LQ via the recovery port 23 have been performed and the first immersion space LS1 has been formed, the control apparatus 4 starts the supply of the liquid LQ via the first supply port 71 and the supply of the liquid LQ via the second supply port 73.

In the present embodiment, at least when the object is moving in the state wherein the supply of the liquid LQ via the supply ports 28 (and the supply ports 27) and the recovery of the liquid LQ via the recovery port 23 are being performed (i.e., in the state wherein the immersion space LS1 is formed), the supply of the liquid LQ via the first supply port 71 or the supply of the liquid LQ via the second supply port 73, or both, is performed.

At least some of the liquid LQ supplied via the first supply port 71 flows into the first opening 72. In addition, at least some of the liquid LQ that is supplied via the supply ports 28 (and the supply ports 27) and that exists in the first guide space A1 also flows into the first opening 72. In addition, at least some of the liquid LQ supplied via the second supply port 73 flows into the second opening 74. In addition, at least some of the liquid. LQ that is supplied via the supply ports 28 (and the supply ports 27) and that exists in the second guide space A2 also flows into the second opening 74.

Furthermore, the supply of the liquid LQ via the first supply port 71 and the supply of the liquid LQ via the second supply port 73, or both, may be started before the supply of the liquid LQ via the supply ports 28 (and the supply ports 27) is started. Furthermore, the supply of the liquid LQ via the first supply port 71 and the supply of the liquid LQ via the second supply port 73, or both, may be started simultaneously with the supply of the liquid LQ via the supply ports 28 (and the supply ports 27).

Furthermore, the supply of the liquid LQ via the first supply port 71 and the supply of the liquid LQ via the second supply port 73 may be started simultaneously. Furthermore, the supply of the liquid LQ via the second supply port 73 may be started after the supply of the liquid LQ via the first supply port 71 has been started. Furthermore, the supply of the liquid LQ via the first supply port 71 may be started after the supply of the liquid LQ via the second supply port 73 has been started.

During at least part of the interval during which the substrate stage 2P is spaced apart from the liquid immersion member 3, the measuring process may be performed, as needed, using the measuring member (the measuring instrument) mounted on the measurement stage 2C. The result of that measuring process is reflected in the exposing process to be performed on the substrate P.

After the unexposed substrate P has been loaded onto the substrate holding part 10 and the measurement process using the measuring member (the measuring instrument) has ended, the control apparatus 4 performs the rugby scrum operation and causes the first immersion space LS1 to transition from the state wherein the first immersion space LS1 is formed between the last optical element 8 and the liquid immersion member 310 on one side and the measurement stage 2C on the other side to the state wherein the first immersion space LS1 is formed between the last optical element 8 and the liquid immersion member 310 on one side and the substrate stage 2P on the other side.

In the present embodiment, at least during the rugby scrum operation, the supply of the liquid LQ via the first and second supply ports 71, 73 is performed.

After the rugby scrum operation has been performed and the immersion space LS1 of the liquid LQ has been formed between the last optical element 8 and the liquid immersion member 310 on one side and the substrate stage 2P (i.e., the substrate P) on the other side, the control apparatus 4 starts the substrate P exposing process. The control apparatus 4 successively exposes the plurality of the shot regions S1-S21 on the substrate P by performing the scanning operation and the stepping operation multiple times.

In the present embodiment, at least during the scanning operation and the stepping operation, the supply of the liquid LQ via the first and second supply ports 71, 73 is performed. In the present embodiment, at least during the exposure of the substrate P, the supply of the liquid LQ via the first and second supply ports 71, 73 is performed. In the present embodiment, the supply of the liquid LQ via the first and second supply ports 71, 73 is performed at least in the state wherein the first immersion space LS1 is formed at the substrate P and the substrate stage 2P.

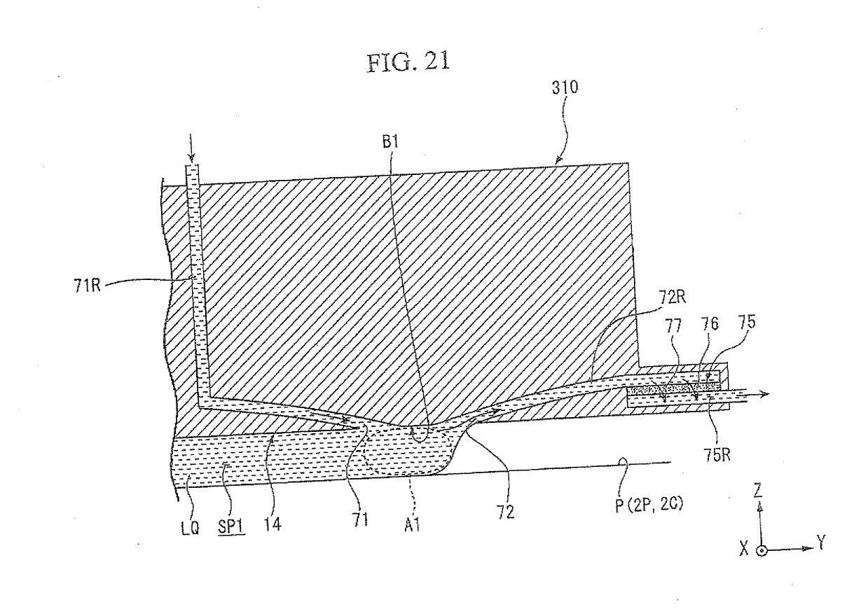

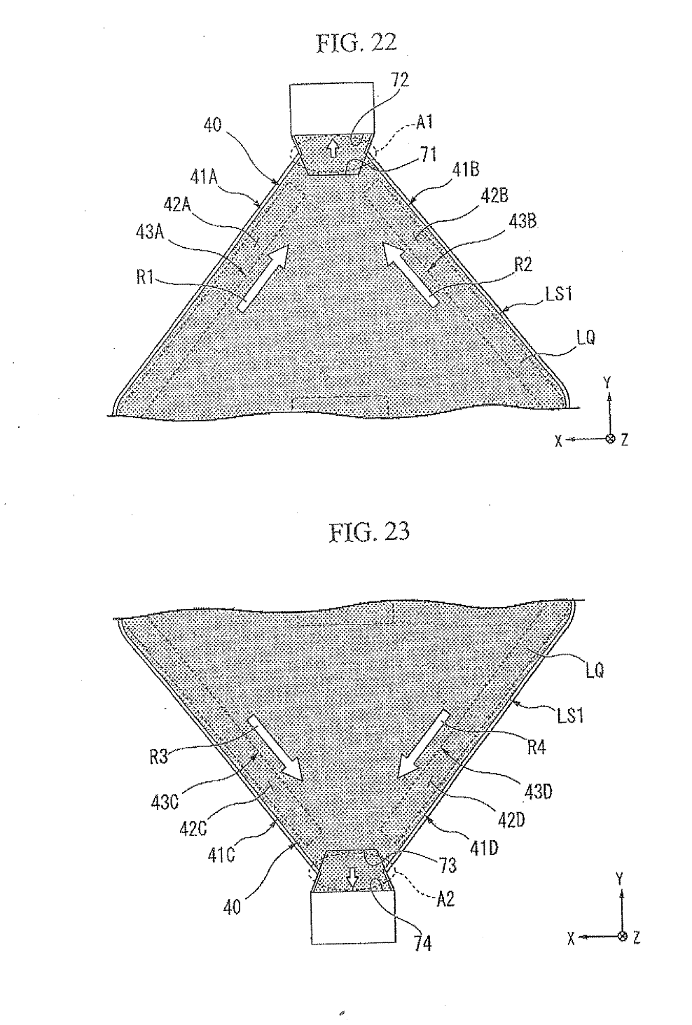

FIG. 22 and FIG. 23 schematically show one example of a state of the liquid LQ that forms the first immersion space LS1 when the object, such as the substrate P, moves in the Y axial directions parallel to the axes 32, 73 in the state wherein the first immersion space LS1 is formed.

In the present embodiment, the guide part 40, which guides at least some of the liquid. LQ that forms the first immersion space LS1 to the first guide space A1 or the second guide space A2, or both, is provided.

As shown in FIG. 22, if, for example, the object moves in the +Y direction, that movement causes at least some of the liquid LQ that forms the first immersion space LS1 to flow in the space SP1. At least some of the liquid LQ that forms the first immersion space LS1 and flows by the movement of the object in the +Y direction flows, by virtue of the guide part 40 that includes the portions 41A, 42A, 43A and the portions 41B, 42B, 43B, in, for example, the directions indicated by arrows R1, R2, and is guided to the first guide space A1.

In the present embodiment, the first opening 72 is disposed such that it faces the first guide space A1. The liquid LQ guided to the first guide space A1 by the guide part 40 flows into the first opening 72. Thereby, the liquid LQ guided to the first guide space A1 by the guide part 40 is recovered by the liquid recovery part 75.

In addition, in the present embodiment, the liquid LQ is supplied via the first supply port 71 such that the liquid LQ flows toward the first opening 72. The liquid. LQ supplied via the first supply port 71 flows toward the first opening 72 via the first guide space A1. The flow of the liquid LQ from the first supply port 71 to the first opening 72 causes the liquid LQ of the first immersion space LS1 (i.e., the liquid LQ supplied via the supply ports 28, 27) to flow from the first guide space A1 into the first opening 72 together with the liquid LQ supplied via the first supply port 71. In the present embodiment, the liquid LQ supplied via the first supply port 71 causes the liquid LQ supplied via the supply ports 28, 27 and guided to the first guide space A1 to flow smoothly toward the fast opening 72.

Namely, in the present embodiment, the liquid LQ is supplied via the first supply port 71 such that the liquid LQ flows from the first guide space A1 toward the first opening 72, which promotes or assists the flow (i.e., movement) of the liquid LQ of the first guide space A1 into the first opening 72.

In the present embodiment, the liquid LQ of the first immersion space LS1 is collected in the first guide space A1 by the guide part 40 and flows into the first opening 72, which is disposed adjacent to the first guide space A1. Thereby, the liquid LQ in the first immersion space LS1 is hindered from flowing out to the outer side of the space SP1.

As shown in FIG. 23, for example, the object moves in the −Y direction, that movement causes at least some of the liquid LQ that forms the immersion space LS1 to flow in the space SP1. At least some of the liquid LQ that forms the first immersion space LS1 and flows by the movement of the object in the −Y direction flows, by virtue of the guide part 40 that includes the portions 41C, 42C, 43C and the portions 41D, 42D, 43D, in, for example, the directions indicated by arrows R3, R4, and is guided to the second guide space A2.

In the present embodiment, the second opening 74 is disposed such that it faces the second guide space A2. The liquid LQ guided to the second guide space A2 by the guide part 40 flows into the second opening 74. Thereby, the liquid LQ guided to the second guide space A2 by the guide part 40 is recovered by the liquid recovery part 78.

In addition, in the present embodiment, the liquid LQ is supplied via the second supply port 73 such that the liquid LQ flows toward the second opening 74. The liquid LQ supplied via the second supply port 73 flows toward the second opening 74 via the second guide space A2. The flaw of the liquid LQ to the second opening 74 via the second supply port 73 causes the liquid LQ in the immersion space LS1 (i.e., the liquid LQ supplied via the supply ports 28, 27) to flow from the second guide space A2 into the second opening 74 together with the liquid LQ supplied via the second supply port 73. In the present embodiment, the liquid LQ supplied via the second supply port 73 causes the liquid LQ supplied via the supply ports 28, 27 and guided to the second guide space A2 to flow smoothly toward the second opening 74.

Namely, in the present embodiment, by supplying the liquid LQ such that the liquid LQ flows from the second guide space A2 toward the second opening 74, the second supply port 73 promotes or assists the flow (i.e., movement) of the liquid LQ in the second guide space A2 into the second opening 74.

In the present embodiment, the liquid LQ in the immersion space LS1 is collected in the second guide space A2 by the guide part 40, and flows into the second opening 74, which is disposed such that it is adjacent to the second guide space A2. Thereby, the liquid LQ in the first immersion space LS1 is hindered from flowing out to the outer side of the space SP1.

After the exposure of the substrate P has ended, the substrate stage 2P is moved to the substrate exchange position. At the substrate exchange position, the substrate exchanging process is performed. Subsequently; a plurality of the substrates P is successively exposed by performing the same processes as discussed above.

The liquid immersion member 3100 (i.e., the first liquid immersion member 310) according to the present embodiment is provided with the first supply port 71, which supplies the liquid LQ such that the liquid LQ flows toward the first opening 72, thereby enabling the liquid LQ in the first guide space A1 to flow smoothly into the first opening 72. Likewise, the liquid LQ in the second guide space A2 flows smoothly into the second opening 74. Accordingly, exposure failures are prevented from occurring and defective devices are prevented from being produced.

Furthermore, in the present embodiment, the liquid. LQ may be supplied such that the liquid LQ flows toward the supply port 71 (i.e., the opening) from the first opening 72 and thereby the liquid LQ may be caused to flow from the first guide space A1 into the opening 71. Furthermore, in the present embodiment, the liquid LQ may be supplied such that the liquid LQ flows from the second opening 74 toward the supply port 73 (i.e., the opening), and thereby the liquid LQ may be caused to flow from the second guide space A2 into the opening 73.

Next, one example of a method of cleaning the first liquid immersion member 310 will be explained.

During cleaning, the cleaning liquid LC is supplied such that it contacts the first liquid immersion member 310. During cleaning, the cleaning liquid LC may be supplied via, for example, the recovery port 23 (i.e., the opening). In addition, during cleaning, the cleaning liquid LC may be supplied via the first supply port 71. In addition, during cleaning, the cleaning liquid LC may be supplied via the second supply port 73. In addition, during cleaning, the cleaning liquid LC may be supplied via the opening 23, the first supply port 71, or the second supply port 73, or via two or all of them. Thereby, at least part of the lower surface 14 may be cleaned by the cleaning liquid LC.

In addition, at least some of the cleaning liquid LC supplied to the lower surface 14 may flow into the first opening 72 or the second opening 74, or both. Thereby, the cleaning liquid LC is recovered by the liquid recovery part 75 or the liquid recovery part 78, or both. In addition, the inner surfaces of the recovery passageways 72R, 74R, the upper surfaces of the porous members 76, 79, the inner surfaces of the holes of the porous members 76, 79, the lower surfaces of the porous members 76, 79, and the inner surfaces of the recovery passageways 75R, 78R are cleaned by the cleaning liquid LC.

In addition, in the present embodiment, during cleaning, the liquid LQ may be supplied via the supply ports 28. In addition, at least some of the liquid LQ supplied via the supply ports 28 may be recovered via the openings 27. Thereby, the liquid LQ hinders contact between the cleaning liquid LC and the last optical element 8.

In addition, during cleaning, the cleaning liquid LC may be supplied such that the cleaning liquid LC flows from the first opening 72 toward the supply port 71 (i.e., the opening), and thereby the cleaning liquid LC may be caused to flow from the first guide space A1 into the opening 71. In addition, during cleaning, the cleaning liquid LC may be supplied such that the cleaning liquid LC flows from the second opening 74 toward the supply port 73 (i.e., the opening), and thereby the cleaning liquid LC may be caused to flow from the second guide space A2 into the opening 73.

The supply and the recovery of the cleaning liquid LC are performed for a prescribed time. After the prescribed time has elapsed, the supply and the recovery of the cleaning liquid LC are stopped. Thereby, the cleaning ends.

Furthermore, during cleaning, for example, a supply condition of the cleaning liquid LC may be changed. In addition, during cleaning, for example, a recovery condition of the cleaning liquid LC may be changed. In addition, during cleaning, a supply condition or a recovery condition, or both, of the cleaning liquid LC may be changed.

For example, the amount of the cleaning liquid LC supplied per unit of time to the lower surface 14 may be changed, or the flow velocity with which the cleaning liquid LC is supplied to the lower surface 14 may be changed. For example, the amount of the cleaning liquid LC supplied may be increased, or the flow velocity of the cleaning liquid LC may be decreased. In addition, the amount supplied may be decreased, or the flow velocity may be increased. In addition, the amount of the cleaning liquid LC contacting the lower surface 14 recovered per unit of time may be changed. For example, the amount recovered may be increased. Furthermore, the amount recovered may be decreased.

Furthermore, the process (i.e., the so-called rinsing process) of rinsing, with the liquid LQ for exposure, the cleaning liquid LC adhering to the first liquid immersion member 310 after the cleaning wherein the cleaning liquid LC is used may be performed. For example, the liquid LQ may be supplied via the supply ports 28 and the first and second supply ports 71, 73, and the liquid LQ may be recovered via the openings 27, the opening 23, and at least part of the first and second openings 72, 74. Furthermore, the liquid LQ may be supplied via the supply ports 28, the first and second supply ports 71, 73, and the openings 27, and the liquid LQ may be recovered via the opening 23 and at least part of the first and second openings 72, 74.

According to the present embodiment as explained above, it is possible to satisfactorily clean the first liquid immersion member 310 inside the exposure apparatus EX using the cleaning liquid LC. Accordingly, it is possible to prevent the occurrence of exposure failures owing to the contamination of the first liquid immersion member 310 and thereby to prevent the production of defective devices.

Furthermore, in the present embodiment, as explained in the first embodiment discussed above, the liquid immersion member 3100 is comprises the second liquid immersion member 32, which is for forming the second immersion space LS2, and the third liquid immersion member 33, which is for forming the third immersion space LS3. For example, the second immersion space LS2 may be formed partly around the first immersion space LS1 by the second liquid immersion member 32 such that the second immersion space LS2 is adjacent to the first guide space A1. In addition, the third immersion space LS3 may be formed partly around the first immersion space LS1 by the third liquid immersion member 33 such that the third immersion space LS3 is adjacent to the second guide space A2. Thereby, for example, during an exposure of the substrate P, even if the liquid LQ that has not flowed into the first opening 72 flows out to the outer side of the first guide space A1, that liquid LQ is trapped by the second immersion space LS2. In addition, even if the liquid LQ that has not flowed into the second opening 74 flows out to the outer side of the second guide space A2, that liquid LQ is trapped by the third immersion space LS3.

In addition, during cleaning, for example, the cleaning liquid LC may be supplied via the opening 23 (i.e., the recovery port) and the first supply port 71 to the space SP1 between the first liquid immersion member 310 and the object (e.g., the dummy substrate DP) and at least some of the cleaning liquid LC that flows from the space SP1 to the space SP2 between the second liquid immersion member 32 and the object may be recovered via the openings (50, 52) belonging to the second liquid immersion member 32. In addition, during cleaning, for example, the cleaning liquid LC may be supplied via the opening 23 (i.e., the recovery port) and the second supply port 73 to the space SP1 and at least some of the cleaning liquid LC that flows from the space SP1 to the space SP3 between the third liquid immersion member 33 and the object may be recovered via the openings (53, 55) belonging to the third liquid immersion member 33.

Furthermore, in the present embodiment, the liquid immersion member 3100 may comprise the first recovery member 34 and the second recovery member 35, as explained in the first embodiment discussed above. During cleaning, for example, the cleaning liquid LC may be supplied via the opening 23 (i.e., the recovery port) and the first and second supply ports 71, 73 to the space SP1, and at least some of the cleaning liquid LC that flows from the space SP1 to the space SP5 between the first recovery member 34 and the object may be recovered via the openings 57 belonging to the first recovery member 34. In addition, at least some of the cleaning liquid LC that flows from the space SP1 to the space SP6 between the second recovery member 35 and the object may be recovered via the openings 59 belonging to the second recovery member 35.

Furthermore, in the first through fourth embodiments discussed above, the second immersion space LS2 is formed partly around the first immersion space LS1, but may be formed substantially entirely around the first liquid immersion space LS1. In other words, the second immersion space LS2 may be formed in a ring such that it surrounds the first immersion space LS1. Thereby, the liquid LQ from the guide part 40 can be trapped by the second immersion space LS2.

Furthermore, in the fourth embodiment, it is given that during an exposure of the substrate P, the liquid LQ that forms the first immersion, space LS1 (i.e., the liquid LQ supplied via the supply ports 28, 27) and the liquid LQ supplied via the first and second supply ports 71, 73 are the same liquid (i.e., pure water), but they may be different liquids. Namely, the liquid supplied via the supply ports 28, 27 and the liquid supplied via the first and second supply ports 71, 73 may be different types of liquid. In addition, the liquid supplied via the supply ports 28, 27 and the liquid supplied via the first and second supply ports 71, 73 may be of different cleanliness levels, different temperatures, or different viscosities.

Furthermore, in the first through fourth embodiments discussed above, at least one of the liquid supply apparatus 27S, the liquid supply apparatus 28S, the liquid supply apparatus 50S, and the liquid supply apparatus 53S can be shared. In one example, the liquid LQ from the liquid supply apparatus 28S can be supplied to the supply ports 27, 28, 50, and 53. Or, the liquid LQ from the liquid supply apparatus 288 can be supplied to the supply ports 27 and 28, and the liquid LQ from the liquid supply apparatus 50S can be supplied to the supply ports 50 and 53.

Furthermore, in the first through fourth embodiments discussed above, the liquid LQ that forms the first immersion space LS1 and the liquid LQ that forms the second immersion space L82 are the same liquid (i.e., pure water), but they may be different liquids. Namely, the liquid supplied via the supply ports 28 (27) and the liquid supplied via the supply port 50 may be different types of liquid. In addition, the liquid supplied via the supply ports 28 (27) and the liquid supplied via the supply port 50 may be of different cleanliness levels, different temperatures, or different viscosities. In addition, the liquid LQ that forms the first immersion space LS1 and the liquid LQ that forms the third immersion space LS3 may be the same liquid (i.e., pure water) or different liquids. Namely, the liquid supplied via the supply ports 28 (27) and the liquid supplied via the supply port 53 may be the same liquid or different types of liquid. In addition, the liquid LQ that forms the second immersion space LS2 and the liquid LQ that forms the third immersion space LS3 may be the same liquid (i.e., pure water) or different liquids.

Furthermore, in the first through fourth embodiments discussed above, a gas supply port may be provided at the outer side of the recovery port 52 of the second liquid immersion member (i.e., 32 and the like) with respect to the optical path K. The gas supply port supplies the gas from the outer side of the recovery port 52 (i.e., the second liquid immersion member 32 and the like) toward the space SP2 (i.e., the second immersion space LS2). The gas supplied via the gas supply port binders the outflow of the liquid LQ from the space SP2 to the outer side of the space SP2. Likewise, a gas supply port may be provided at the outer side of the recovery port 55 of the third liquid immersion member (i.e., 33 and the like) with respect to the optical path K.

Furthermore, in the first through fourth embodiments discussed above, at least part of the liquid immersion member is cleaned using the cleaning liquid LC, which is different from the liquid LQ, but may be cleaned using the liquid LQ. For example, the liquid supplied via the opening 23 during cleaning may be the liquid LQ for exposure.

Furthermore, in the above-described embodiments, the second immersion space LS2 is formed partly around the first immersion space LS1, but can be formed substantially entirely around the first liquid immersion space LS1. In other words, the second immersion space LS2 can be formed in a shaped annular such that it surrounds the first immersion space LS1. Thereby, the liquid LQ from the space SP1 can be trapped by the second immersion space LS2. The liquid LQ from the first liquid immersion space LS1 can be recovered by the second immersion space LS2 without providing a guide part (e.g., the guide part 40).

Furthermore, in each, of the embodiments discussed above, the “radial directions with respect to the optical path K” ratty be regarded as the radial directions with respect to the optical axis AX of the projection optical system PL in the vicinity of the projection area PR.

Furthermore, as discussed above, the control apparatus 4 comprises a computer system, which comprises a CPU and the like. In addition, the control apparatus 4 comprises an interface, which is capable of conducting communication between the computer system and an external apparatus. The storage apparatus 5 comprises a storage medium such as memory (e.g., RAM), a hard disk, a CD-ROM, and the like. In the storage apparatus 5, an operating system (OS) that controls a computer system is installed and a program for controlling the exposure apparatus EX is stored.

Furthermore, the control apparatus 4 may be connected to an input apparatus that is capable of inputting an input signal. The input apparatus comprises input equipment, such as a keyboard and a mouse, or a communication apparatus, which is capable of inputting data from the external apparatus. In addition, a display apparatus, such as a liquid crystal display, may be provided.

Various information, including the program stored in the storage apparatus 5, can be read by the control apparatus 4 (i.e., the computer system). In the storage apparatus 5, a program is stored that causes the control apparatus 4 to control the exposure apparatus EX such that the substrate P is exposed with the exposure light EL, which transits the liquid LQ.

The program stored in the storage apparatus 5 may cause the control apparatus 4 to perform the following processes in accordance with the embodiments discussed above: a process that supplies the cleaning liquid LC such that it contacts at least part of the first liquid immersion member (i.e., 31 and the like); and a process that recovers at least some of the cleaning liquid LC from the first liquid immersion member (i.e., 31 and the like) via an opening belonging to the second liquid immersion member (i.e., 32 and the like).

The program stored in the storage apparatus 5 is read by the control apparatus 4, and thereby the various processes, such as the immersion exposure of the substrate P in the state wherein the first immersion space LS1 is formed, are executed in cooperation with the various apparatuses of the exposure apparatus EX, such as the substrate stage 2P, the measurement stage 2C, and the liquid immersion member 3.

Furthermore, in the each of the embodiments discussed above, the optical path K at the emergent surface 7 (i.e., the image plane) side of the last optical element 8 of the projection optical system PL is filled with the liquid LQ; however, the projection optical system PL may be a projection optical system wherein the optical path at the incident (i.e., the object plane) side of the last optical element 8 is also filled with the liquid LQ, as disclosed in, for example, PCT International Publication No. WO2004/019128.

Furthermore, in each of the embodiments discussed above, the liquid. LQ is water but may be a liquid other than water. Preferably, the liquid LQ is a liquid that is transparent with respect to the exposure light EL, has a high refractive index with respect to the exposure light EL, and is stable with respect to the projection optical system PL or the film of for example, the photosensitive material (i.e., the photoresist) that forms the front surface of the substrate P. For example, the liquid LQ may be a fluorine-based liquid such as hydro-fluoro-ether (HFE), perfluorinated polyether (PEPE), or Fomblin® oil. In addition, the liquid LQ may be any of various fluids, for example, a supercritical fluid.

Furthermore, the substrate P in each of the embodiments discussed above is a semiconductor wafer for fabricating semiconductor devices, but it may be, for example, a glass substrate for display devices, a ceramic wafer for thin film magnetic heads, or the original plate of a mask or a reticle (e.g., synthetic quartz or a silicon wafer) used by an exposure apparatus.

Furthermore, the exposure apparatus EX in each of the embodiments discussed above is a step-and-scan type scanning exposure apparatus (i.e., a scanning stepper), which scans and exposes the pattern of the mask M by synchronously moving the mask M and the substrate P, but the exposure-apparatus EX may be, for example, a step-and-repeat type projection exposure apparatus (i.e., a stepper), which performs a full field exposure of the pattern of the mask M—with the mask M and the substrate P in a stationary state and then sequentially steps the substrate P.

In addition, the exposure apparatus EX may be a full-field exposure apparatus (i.e., a stitching type full-field exposure apparatus), which performs a full-field exposure of the substrate P; in this case, a step-and-repeat type exposure is performed using the projection optical system to transfer a reduced image of a first pattern onto the substrate P in a state wherein the first pattern and the substrate P are substantially stationary, after which the projection optical system is used to partially superpose a reduced image of a second pattern onto the transferred first pattern in the state wherein the second pattern and the substrate P are substantially stationary. In addition, the stitching type exposure apparatus may be a step-and-stitch type exposure apparatus that successively transfers at least two patterns onto the substrate P such that they are partially superposed and steps the substrate P.

In addition, the exposure apparatus EX may be an exposure apparatus that combines on the substrate the patterns of two masks through a projection optical system and double exposes, substantially simultaneously, a single shot region on the substrate using a single scanning exposure, as disclosed in, for example, U.S. Pat. No. 6,611,316. In addition, the exposure apparatus EX may be a proximity type exposure apparatus, a mirror projection aligner, or the like.

In addition, the exposure apparatus EX may be a twin stage type exposure apparatus, which comprises a plurality of substrate stages, as disclosed in, for example, U.S. Pat. Nos. 6,341,007, 6,208,407, and 6,262,796. For example, as shown in FIG. 25, if the exposure apparatus EX comprises two of the substrate stages 2Pa and 2Pb, then the object that is capable of being disposed such that it opposes the emergent surface 7 is one of the substrate stages, a substrate held by a substrate holding part on that substrate stage, the other of the substrate stages, the substrate held by a substrate holding part on that other substrate stage, or combinations thereof.

In addition, the exposure apparatus EX may be an exposure apparatus that comprises a plurality of the substrate stages and the measurement stages.

The exposure apparatus EX may be a semiconductor device fabrication exposure apparatus that exposes the substrate P with, the pattern, of a semiconductor device, an exposure apparatus used for fabricating, for example, liquid crystal devices or displays, or an exposure apparatus for fabricating thin film magnetic heads, image capturing devices (e.g., CCDs), micromachines, MEMS, DNA chips, or reticles and masks.

Furthermore, in each of the embodiments discussed above, the position of each of the stages is measured using the interferometer system 13, but the present invention is not limited thereto; for example, an encoder system that detects a scale (i.e., a diffraction grating) provided to each of the stages may be used, or the interferometer system may be used in parallel with the encoder system.

Furthermore, in the embodiments discussed above, the optically transmissive mask wherein a prescribed shielding pattern (or phase pattern or dimming pattern) is formed on an optically transmissive substrate is used; however, instead of such a mask, a variable shaped mask (also called an electronic mask, an active mask, or an image generator), wherein a transmissive pattern, a reflective pattern, or a light emitting pattern is formed based on electronic data of the pattern to be exposed, as disclosed in, for example, U.S. Pat. No. 6,778,257, may be used. In addition, instead of a variable shaped mask that comprises a non-emissive type image display device, a pattern forming apparatus that comprises a self-luminous type image display device may be provided.

In each of the embodiments discussed above, the exposure apparatus EX comprises the projection optical system PL; however, the constituent elements explained in each of the embodiments discussed above may be adapted to an exposure apparatus and an exposing method that does not use the projection optical system PL. For example, the constituent elements explained hr each of the embodiments discussed above may be adapted to an exposure apparatus and an exposing method wherein an immersion space is formed between the substrate and an optical member such as a lens, and the exposure light is radiated to the substrate via that optical member.

In addition, the exposure apparatus EX may be an exposure apparatus (i.e., a lithographic system) that exposes the substrate P with a line-and-space pattern by forming interference fringes on the substrate P, as disclosed in, for example, PCT International Publication No. WO2001/035168.

The exposure apparatus EX according to the embodiments discussed above is manufactured by assembling various subsystems, including each constituent element discussed above, so that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus from the various subsystems includes, for example, the connection of mechanical components, the wiring and connection of electrical circuits, and the piping and connection of the pneumatic circuits among the various subsystems. Naturally, prior to performing the process of assembling the exposure apparatus from these various subsystems, there are also the processes of assembling each individual subsystem. After the process of assembling the exposure apparatus from the various subsystems is complete, a comprehensive adjustment is performed to ensure the various accuracies of the exposure apparatus as a whole. Furthermore, it is preferable to manufacture the exposure apparatus in a clean room, wherein the temperature, the cleanliness level, and the like are controlled.

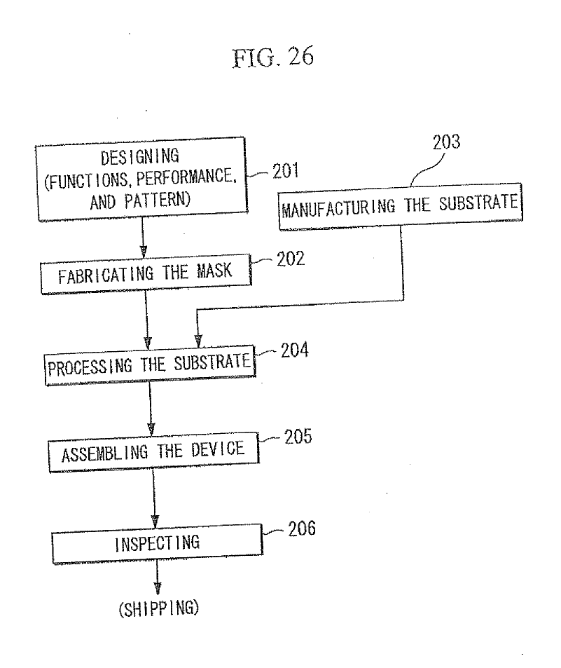

As shown in FIG. 26, a microdevice, such as a semiconductor device, is manufactured by: a step 201 that designs the functions and performance of the microdevice; a step 202 that fabricates the mask (i.e., the reticle) based on this designing step; a step 203 that manufactures the substrate, which is the base material of the device; a substrate processing step 204 that comprises a substrate process (i.e., an exposure process) that includes, in accordance with the embodiments discussed above, exposing the substrate with the exposure light that emerges from the pattern of the mask and developing the exposed substrate; a device assembling step 205 (which includes fabrication processes such as dicing, bonding, and packaging processes); an inspecting step 206; and the like.

Furthermore, the features of each of the embodiments discussed above can be combined as appropriate. In addition, there are also cases wherein some of the constituent elements are not used. In addition, each disclosure of every Japanese published patent application and U.S. patent related to the exposure apparatus recited in each of the embodiments discussed above, the modified examples, and the like is hereby incorporated by reference in its entirety to the extent permitted by the national laws and regulations.

1. A method of cleaning a liquid immersion member inside an immersion exposure apparatus that exposes a substrate with exposure light through a first liquid, the liquid immersion member being disposed at least partly around an optical member and an optical path of the exposure light, which passes through the first liquid between the optical member and the substrate, wherein
the liquid immersion member comprises:
a first liquid immersion member, which is disposed at least partly around the optical path, that forms a first immersion space of the first liquid at an emergent surface side of the optical member such that the optical path of the exposure light between the optical member and the substrate is filled with the first liquid during an exposure of the substrate;
a guide part, which guides at least some of the first liquid in the first immersion space to a first guide space, which extends partly around the optical path; and
a second liquid immersion member, which is disposed at the outer side of the first liquid immersion member with respect to the optical path, that forms a second immersion space of a second liquid partly around the first immersion space and adjacent to the first guide space; and
the method comprising:
supplying a cleaning liquid such that it contacts at least part of the first liquid immersion member; and
recovering at least some of the cleaning liquid from the first liquid immersion member via an opening belonging to the second liquid immersion member.

2. The cleaning method according to claim 1, further comprising:
supplying the cleaning liquid to a space that a lower surface of the first liquid immersion member faces in a state wherein the lower surface of the first liquid immersion member, which the substrate is capable of opposing, and an object are opposed.

3. The cleaning method according to claim 2, further comprising:
supplying the cleaning liquid via a first opening belonging to the first liquid immersion member.

4. The cleaning method according to claim 3, wherein
the first opening faces the space.

5. The cleaning method according to claim 3, wherein
the first liquid immersion member comprises a liquid recovery part, which is disposed such that the substrate opposes it, that is capable of recovering the first liquid during the exposure of the substrate; and
the liquid recovery part has the first opening.

6. The cleaning method according to claim 5, wherein
the liquid recovery part comprises a porous member; and
the first opening has a hole of the porous member.

7. The cleaning method according to claim 3, wherein
the first liquid immersion member has a second opening, which is disposed such that it faces a selected one from the group consisting of a side surface of the optical member or the optical path, or both; and
the method further comprising:
supplying a third liquid, which is different from the cleaning liquid, via the second opening during cleaning.

8. The cleaning method according to claim 7, wherein
at least some of the third liquid supplied via the second opening is recovered via a third opening, which is disposed at a position that is closer to the optical path than the first opening is.

9. The cleaning method according to claim 7, wherein
the third liquid hinders contact between the cleaning liquid and the optical member.

10. The cleaning method according to claim 7, wherein
the third liquid includes the first liquid.

11. The cleaning method according to claim 8, wherein
the first liquid is supplied via the third opening during the exposure of the substrate.

12. The cleaning method according to claim 7, wherein
the first liquid is supplied via the second opening during the exposure of the substrate.

13. The cleaning method according to claim 1, wherein
the opening belonging to the second liquid immersion member recovers a fluid during at least part of the exposure of the substrate.

14. The cleaning method according to claim 13, wherein
the opening belonging to the second liquid immersion member includes a recovery port, which recovers at least some of the second liquid from the second immersion space during the exposure of the substrate.

15. The cleaning method according to claim 13, wherein
the opening belonging to the second liquid immersion member includes a supply port, which supplies the second liquid for forming the second immersion space during the exposure of the substrate.

16. The cleaning method according to claim 1, further comprising:
supplying the cleaning liquid to at least part of the second liquid immersion member.

17. The cleaning method according to claim 1, wherein
the liquid immersion member has a fourth opening, which is disposed at least partly around the first liquid immersion member and is different from the opening belonging to the second liquid immersion member; and
the method further comprising:
recovering some of the cleaning liquid from the first liquid immersion member via the fourth opening.

18. The cleaning method according to claim 17, wherein
the fourth opening recovers the fluid during at least part of the exposure of the substrate.

19. The cleaning method according to claim 1, wherein
the liquid immersion member has a fifth opening, which is disposed at least partly around the first liquid immersion member and is different from the opening belonging to the second liquid immersion member; and
the method further comprising:
supplying the cleaning liquid via the fifth opening.

20. The cleaning method according to claim 1, wherein
the guide part guides at least some of the first liquid in the first immersion space to a second guide space, which extends partly around the optical path and is different from the first guide space.

21. The cleaning method according to claim 20, wherein
the liquid immersion member further comprises a third liquid immersion member, which is disposed at the outer side of the first liquid immersion member with respect to the optical path and which forms a third immersion space of a fourth liquid partly around the first immersion space and adjacent to the second guide space; and
the method further comprising:
supplying the cleaning liquid to at least part of the third liquid immersion member.

22. The cleaning method according to claim 1, wherein
the guide part has a gas supply port, which supplies a gas from the outer side of the first immersion space toward the first immersion space.

23. The cleaning method according to claim 1, wherein
at least part of the guide part is disposed in the first liquid immersion member.

24. The cleaning method according to claim 1, wherein
the liquid immersion member has:
an opening, which is disposed such that it faces the first guide space with respect to the optical path and into which the first liquid can flow from the first guide space; and
a liquid supply port, which supplies a fifth liquid such that the fifth liquid flows toward the opening; and
the method further comprising:
supplying the cleaning liquid via the liquid supply port.

25. A device fabricating method, comprising:
cleaning at least some of the liquid immersion member using a cleaning method according to claim 1;
exposing the substrate through the exposure liquid; and
developing the exposed substrate.

26. A liquid immersion member inside an immersion exposure apparatus that exposes a substrate with exposure light through a first liquid, the liquid immersion member being disposed at least partly around an optical member and an optical path of the exposure light, which passes through the first liquid between the optical member and the substrate, the liquid immersion member comprising:
a first liquid immersion member, which is disposed at least partly around the optical path, that forms a first immersion space of the first liquid at an emergent surface side of the optical member such that the optical path of the exposure light between the optical member and the substrate is filled with the first liquid during an exposure of the substrate;
a guide part, which guides at least some of the first liquid in the first immersion space to a first guide space, which extends partly around the optical path;
a second liquid immersion member, which is disposed at the outer side of the first liquid immersion member with respect to the optical path, that forms a second immersion space of a second liquid partly around the first immersion space and adjacent to the first guide space;
a supply port that supplies a cleaning liquid such that it contacts at least part of the first liquid immersion member during cleaning; and
a recovery port, which is disposed in the second liquid immersion member, that recovers at least some of the cleaning liquid from the first liquid immersion member.

27. An immersion exposure apparatus that exposes a substrate with exposure light through a first liquid, comprising:
a liquid immersion member according to claim 26.

28. A device fabricating method, comprising:
exposing a substrate using an immersion exposure apparatus according to claim 27; and
developing the exposed substrate.

29. A program that causes a computer to control an immersion exposure apparatus, which exposes a substrate with exposure light through a first liquid filled in an optical path of the exposure light between the substrate and an optical member wherefrom the exposure light can emerge, wherein
the immersion exposure apparatus comprises a liquid immersion member, which is disposed at least partly around the optical member and the optical path of the exposure light that passes through the first liquid between the optical member and the substrate; and
the liquid immersion member comprises:
a first liquid immersion member, which is disposed at least partly around the optical path, that forms a first immersion space of the first liquid at an emergent surface side of the optical member such that the optical path of the exposure light between the optical member and the substrate is filled with the first liquid during an exposure of the substrate;
a guide part, which guides at least some of the first liquid in the first immersion space to a first guide space, which extends partly around the optical path; and
a second liquid immersion member, which is disposed at the outer side of the first liquid immersion member with respect to the optical path, that forms a second immersion space of a second liquid that extends partly around the first immersion space and is adjacent to the first guide space; and
comprising the steps of:
supplying the cleaning liquid such that it contacts at least some of the first liquid immersion member; and
recovering at least some of the cleaning liquid from the first liquid immersion member via an opening belonging to the second liquid immersion member.

30. A computer readable storage medium whereon a program according to claim 29 is stored.
